(19) United States
(12) Patent Application Publication
(10) Pub. No.: US 2024/0348304 A1
(43) Pub. Date: Oct. 17, 2024

(54) DETERMINING TRANSMISSION CONFIGURATION INDICATION STATES FOR CHANNEL STATE INFORMATION REFERENCE SIGNALS

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/622,487

(22) Filed: Mar. 29, 2024

Related U.S. Application Data
(60) Provisional application No. 63/459,115, filed on Apr. 13, 2023.
(60) Provisional application No. 63/460,534, filed on Apr. 19, 2023.
(60) Provisional application No. 63/465,160, filed on May 9, 2023.
(60) Provisional application No. 63/532,304, filed on Aug. 11, 2023.
(60) Provisional application No. 63/546,692, filed on Oct. 31, 2023.
(60) Provisional application No. 63/569,535, filed on Mar. 25, 2024.

(51) Int. Cl. H04B 7/06; H04W 76/20

(52) U.S. Cl. CPC H04B 7/0626; H04B 7/06968; H04W 76/20

(57) ABSTRACT

Methods and apparatuses for determining transmission configuration indication (TCI) states for channel state information reference signals (CSI-RSs). A method performed by a user equipment (UE) includes receiving, first information about receiving an aperiodic CSI-RS when a triggering offset is less than a threshold; receiving, second information including an indicator to indicate whether to apply a first TCI state or a second TCI state for the aperiodic CSI-RS; and receiving the aperiodic CSI-RS. The method further includes identifying whether another downlink (DL) signal is present in a same symbol as the aperiodic CSI-RS and determining, based on the identification, the first information, or the indicator, to apply the first or second TCI state for the aperiodic CSI-RS.

### CROSS-REFERENCE TO RELATED AND CLAIM OF PRIORITY

The present application claims priority under 35 U.S.C. § 119(e) to U.S. Provisional Patent Application No. 63/459,115 filed on Apr. 13, 2023; U.S. Provisional Patent Application No. 63/460,534 filed on Apr. 19, 2023; U.S. Provisional Patent Application No. 63/465,160 filed on May 9, 2023; U.S. Provisional Patent Application No. 63/532,304 filed on Aug. 11, 2023; U.S. Provisional Patent Application No. 63/546,692 filed on Oct. 31, 2023, and U.S. Provisional Patent Application No. 63/569,535 filed on Mar. 25, 2024, which are hereby incorporated by reference in their entirety.

### TECHNICAL FIELD

The present disclosure relates generally to wireless communication systems and, more specifically, the present disclosure relates to methods and apparatuses for determining transmission configuration indication (TCI) states for channel state information reference signals (CSI-RSs).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to determining TCI states for CSI-RSs.

In one embodiment, a user equipment (UE) is provided. The UE includes a transceiver configured to receive, first information about receiving an aperiodic CSI-RS when a triggering offset is less than a threshold; receive, via downlink control information (DCI) format, the aperiodic CSI-RS; and receive, second information including an indicator to indicate whether to apply a first transmission configuration (TCI) state or a second TCI state for the aperiodic CSI-RS. The UE further includes a processor operably coupled with the transceiver. The processor is configured to identify whether another downlink (DL) signal is present in a same symbol as the aperiodic CSI-RS and determine, based on the identification, the first information, or the indicator, to apply the first or second TCI state for the aperiodic CSI-RS.

In another embodiment, a base station (BS) is provided. The BS includes a transceiver configured to transmit, first information about an aperiodic CSI-RS when a triggering offset is less than a threshold; transmit, via DCI format, the aperiodic CSI-RS; and transmit, second information including an indicator to indicate whether to apply a first transmission TCI state or a second TCI state for the aperiodic CSI-RS. The BS further includes a processor operably coupled with the transceiver. The processor is configured to identify whether another DL signal is present in a same symbol as the aperiodic CSI-RS and determine, based on the identification, the first information, or the indicator, to apply the first or second TCI state for the aperiodic CSI-RS.

In yet another embodiment, a method performed by a UE is provided. The method includes receiving, first information about receiving an aperiodic CSI-RS when a triggering offset is less than a threshold; receiving, via DCI format, the aperiodic CSI-RS; and receiving, second information including an indicator to indicate whether to apply a first TCI state or a second TCI state for the aperiodic CSI-RS. The method further includes identifying whether another DL signal is present in a same symbol as the aperiodic CSI-RS and determining, based on the identification, the first information, or the indicator, to apply the first or second TCI state for the aperiodic CSI-RS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example multiple transmission and reception point (TRP) system according to embodiments of the present disclosure; and

FIG. 8 illustrates an example method performed by a UE in a wireless communication system according to embodiments of the present disclosure.

### DETAILED DESCRIPTION

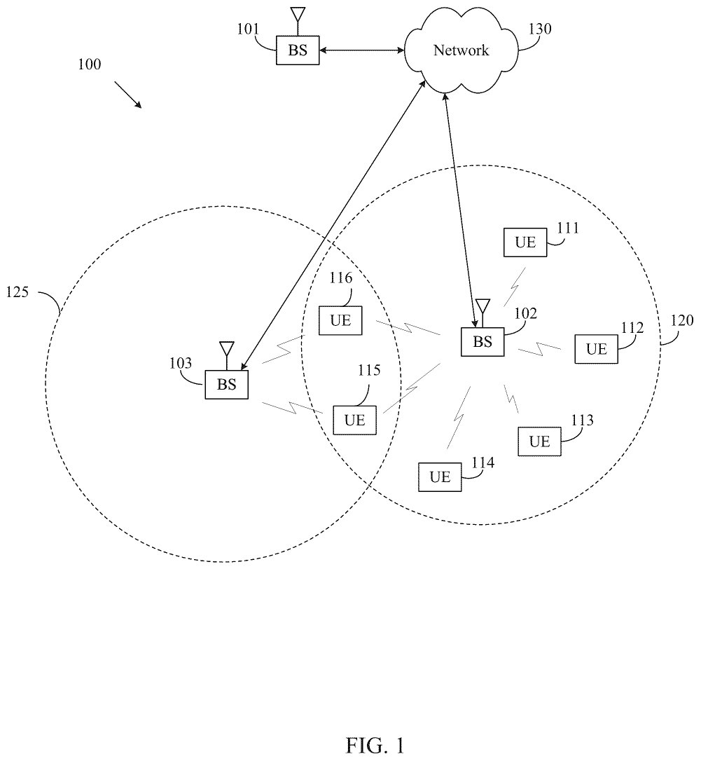

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3]3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing a configuration of CSI-RSs. In certain embodiments, one or more of the BSs 101-103 include circuitry, programing, or a combination thereof to support configuring CSI-RSs.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

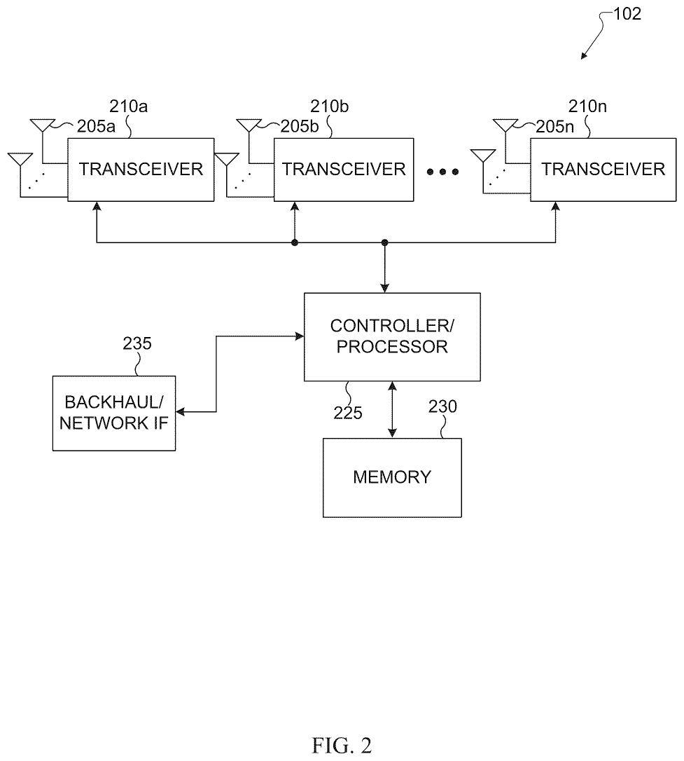

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting the configuration of CSI-RSs. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

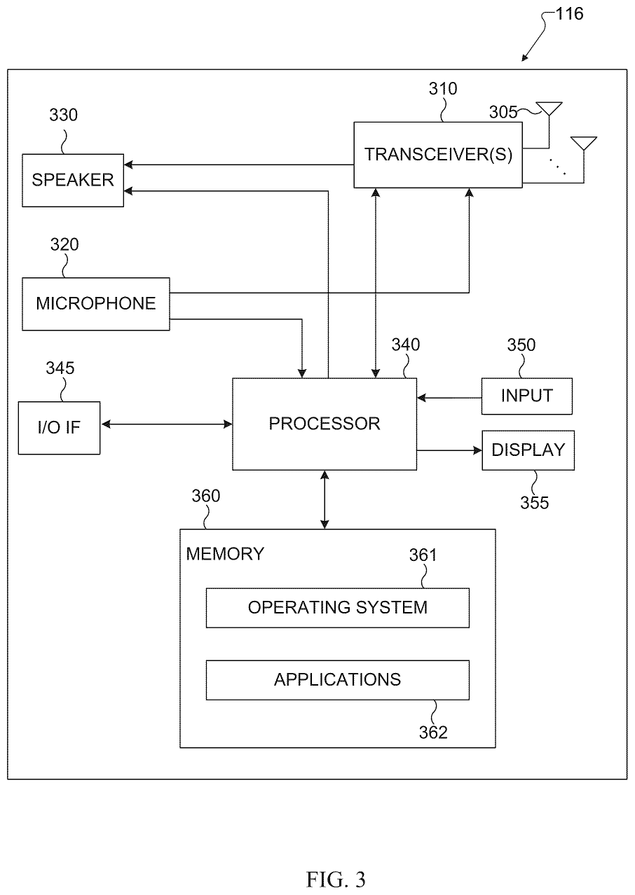

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify configurations of CSI-RSs as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

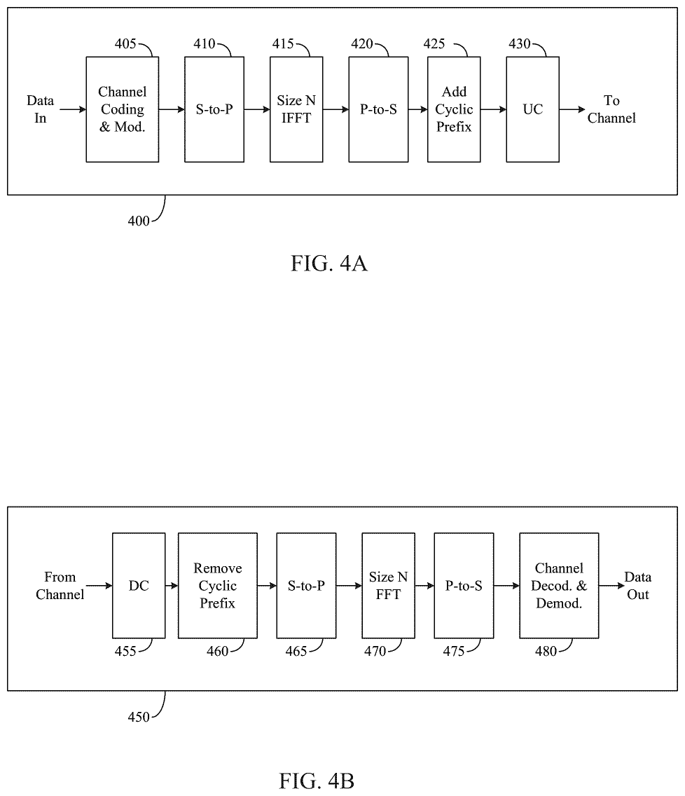

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support configuring of CSI-RS as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

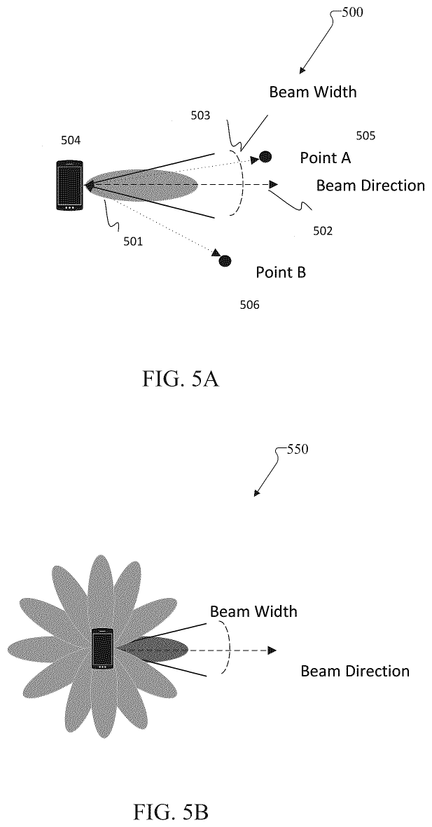

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

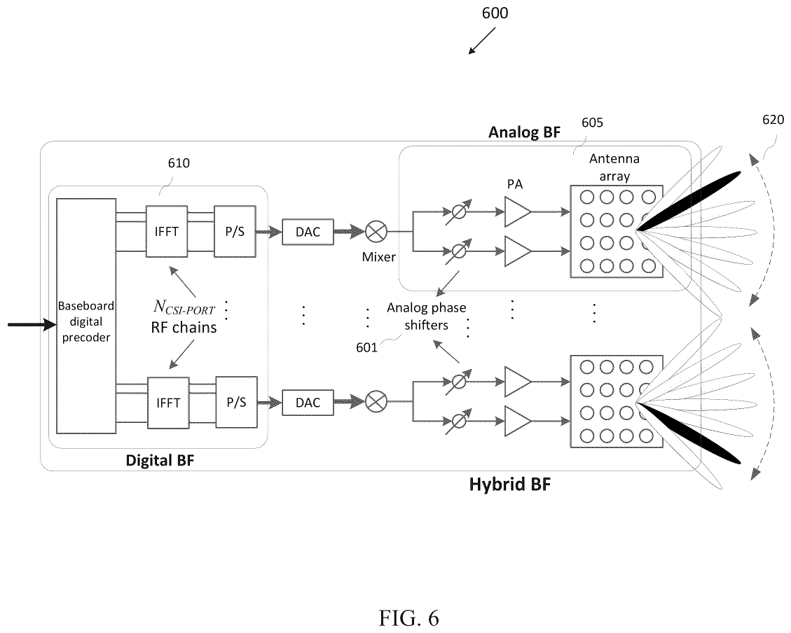

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or SRS. In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

In this disclosure, a beam is determined by either of:
A TCI state that establishes a quasi-colocation (QCL) relationship between a source reference signal (e.g., SSB and/or CSI-RS) and a target reference signal.
A spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

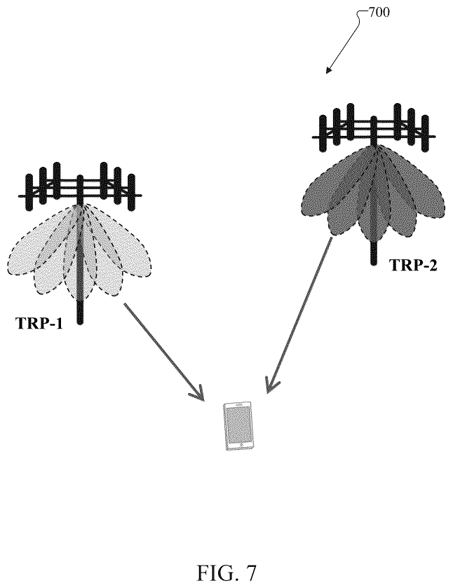

FIG. 7 illustrates an example system 700 for a multi-TRP according to embodiments of the present disclosure. For example, the system 700 may operate within the wireless network 100 in FIG. 1. This example is for illustration only and other embodiments can be used without departing from the scope of the present disclosure.

With reference to FIG. 7, a UE could simultaneously receive from multiple physically non-co-located TRPs various channels/RSs such as physical downlink control channels (PDCCHs) and/or physical downlink shared channels (PDSCHs) using either a single receive (RX) panel or multiple RX panels. In this disclosure, a RX panel could correspond to a set of RX antenna elements/ports at the UE 116, a set of measurement RS resources such as SRS resources, a spatial domain RX filter or etc. Furthermore, a TRP in the multi-TRP system can represent a collection of measurement antenna ports, measurement RS resources and/or control resource sets (CORESETs). For example, a TRP could be associated with one or more of:
A plurality of CSI-RS resources
A plurality of CRIs (CSI-RS resource indices/indicators)
A measurement RS resource set, for example, a CSI-RS resource set along with its indicator
A plurality of CORESETs associated with a CORESETPoolIndex
A plurality of CORESETs associated with a TRP-specific index/indicator/identity

A cell/TRP could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, for the inter-cell operation evaluated in the present disclosure, different cells/TRPs could broadcast different PCIs and/or one or more cells/TRPs (referred to/defined as non-serving cells/TRPs in the present disclosure) could broadcast different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI, or a different PCI (with respect to the serving cell PCI).

Embodiments of the present disclosure evaluate various design aspects related to TCI state(s) association to aperiodic (AP) CSI-RS resource(s). In particular, different association methods can be configured/determined depending on different reporting formats/contents. Furthermore, this disclosure also evaluates determining (default) TCI state(s) for aperiodic CSI-RS reception(s) in a single-downlink control information (DCI) (SDCI) or multi-DCI (MDCI) based multi-TRP system, wherein when inter-cell multi-TRP (MTRP) operation is enabled/configured, the indicated TCI state(s) could also be associated with a PCI.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE 116 a beam (i.e., a TCI state) for the transmission/reception of a PDCCH or a PDSCH. As described in the 3GPP Rel-17:
In one example, a MAC CE could be used to indicate to the UE 116 a beam (i.e., a TCI state and/or a TCI state ID) for the transmission/reception of a PDCCH or a PDSCH.
In another example, a DCI could be used to indicate to the UE 116 a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE 116 a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 01, DCI format 0_2) could be used to indicate to the UE 116 a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE 116 a beam (i.e., a TCI state and/or a TCI state ID) for the transmission/reception of a PDCCH or a PDSCH.

Rel-17 introduced the unified TCI framework, where a unified or master or main TCI state is signaled to the UE 116. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based physical uplink shared channel (PUSCH) and all of dedicated physical uplink control channel (PUCCH) resources.

In a (single-DCI based) multi-TRP system, a UE could be indicated/provided/configured by the network 130, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network 130 via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s). ‘11’ indicates that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PDSCH reception in a (single-DCI based) multi-TRP system, a UE could be configured/provided/indicated by the network 130 via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUCCH transmission in a (single-DCI based) multi-TRP system, a UE could be configured/provided/indicated by the network 130 via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s).

For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource. ‘11’ indicates that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUSCH transmission in a (single-DCI based) multi-TRP system, a UE could be configured/provided/indicated by the network 130 via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

In a (multi-DCI based) multi-TRP system, a UE could be indicated/provided/configured by the network 130, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network 130, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value. A pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

As specified herein in the present disclosure, a UE could apply/use a first TCI state(s) and a second TCI state(s) for at least UE-dedicated reception(s) of PDCCH/PDSCH and configured-grant/dynamic-grant PUSCH and all of dedicated PUCCH transmissions in a multi-TRP system. The first TCI state(s) could be associated to value 0 (or 1) of CORESETPoolIndex (if configured), and the second TCI state(s) could be associated to value 1 (or 0) of CORESETPoolIndex (if configured). Alternatively, the first TCI state(s) could be associated to a first PCI (e.g., the serving cell PCI)—if configured/activated, and the second TCI state(s) could be associated to a second PCI (e.g., a PCI other than the serving cell PCI)—if configured/activated. Optionally, the first TCI state(s) and/or the second TCI state(s) could be updated by one or more TCI states of a same TCI codepoint activated/indicated by a beam indication/activation MAC CE or DCI. The first TCI state(s) and/or the second TCI state(s) could be a joint DL and UL TCI state provided by DLorJointTCI-State, a separate DL TCI state provided by DLorJointTCI-State, a separate UL TCI state provided by UL-TCIState, or a pair of separate DL and UL TCI states.

The UE 116 could be indicated/provided/configured by the network 130, e.g., via higher layer RRC signaling/parameter (e.g., by setting/configuring higher layer parameter groupBasedBeamReporting-r17 in the higher layer parameter CSI-ReportConfig that configures the corresponding CSI reporting setting) and/or MAC CE command and/or dynamic DCI based L1 signaling, that the group based beam reporting for MTRP operation is enabled/configured. When/if the group based beam reporting for MTRP operation is enabled/configured, the UE 116 could report, in a single CSI reporting instance/CSI report, one or more groups of resource indicators including SSB resource indicators (SSBRIs) and/or CRIs (and therefore, the corresponding beam metrics including L1-reference signal received powers (RSRPs) and/or L1-signal to interference and noise ratios (SINRs)), wherein the resource indicators reported in each group could be determined/selected from different SSB resource sets and/or non zero power (NZP) CSI-RS resource sets.

For aperiodic CSI, and for periodic and semi-persistent CSI resource settings, each trigger state configured using the higher layer parameter CSI-AperiodicTriggerState is associated with one or multiple CSI-ReportConfig where the CSI-ReportConfig configured with groupBasedBeamReporting-r17 is linked to periodic or semi-persistent, setting(s). When one Resource Setting is configured, the Resource setting is given by resourcesForChannelMeasurement for L1-RSRP measurement. In such a case, the number of configured CSI Resource Sets in the Resource Setting is S=2, which correspond to first and second aperiodic CSI resource sets (e.g., configured/provided in the corresponding/associated CSI-ResourceConfig), respectively, for L1-RSRP measurement for group based beam reporting for MTRP operation.

For aperiodic CSI, and for aperiodic CSI resource settings, each trigger state configured using the higher layer parameter CSI-AperiodicTriggerState is associated with one or multiple CSI-ReportConfig where the CSI-ReportConfig configured with groupBasedBeamReporting-r17 is associated with resourcesForChannel and resourcesForChannel2, which correspond to first and second aperiodic CSI resource sets (e.g., configured/provided in the corresponding/associated CSI-ResourceConfig), respectively, for L1-RSRP measurement for group based beam reporting for MTRP operation.

The first and/or second TCI state(s) as specified herein in the present disclosure could be associated to the first and/or second aperiodic CSI resource sets, or equivalently, the UE 116 could apply/use the first and/or second TCI state(s) for the first and/or second aperiodic CSI resource sets, according to one or more of the following.
In one example, the first TCI state(s) as specified herein in the present disclosure could be associated to the first (or second) aperiodic CSI resource set for the L1 measurements for the group based beam reporting for the MTRP operation, and the second TCI state(s) as specified herein in the present disclosure could be associated to the second (or first) aperiodic CSI resource set for the L1 measurements for the group based beam reporting for the MTRP operation. Or equivalently, the UE 116 could use/apply the first TCI state(s) as specified herein in the present disclosure for the first (or second) aperiodic CSI resource set, and the second TCI state(s) as specified herein in the present disclosure for the second (or first) aperiodic CSI resource set.
In another example, an indicator—denoted by a first (or second) indicator—could be associated to the first (or second) aperiodic CSI resource set as specified herein in the present disclosure (e.g., the indicator could be provided in nzp-CSI-RS-ResourceSet or CSI-SSB-ResourceSet or CSI-AssociatedReportConfigInfo of CSI-AperiodicTriggerState or CSI-ResourceConfig or CSI-ReportConfig that configures or is associated to the corresponding aperiodic CSI resource set). When the indicator, e.g., the first (or second) indicator, is a one-bit indicator and set to ‘0’ (or ‘1’), the UE 116 could use/apply the first TCI state(s) as specified herein in the present disclosure for the aperiodic CSI resource set, e.g., the first (or second) aperiodic CSI resource set, that is associated to the indicator. When the indicator, e.g., the first (or second) indicator, is a one-bit indicator and set to ‘1’ (or ‘0’), the UE 116 could use/apply the second TCI state(s) as specified herein in the present disclosure for the aperiodic CSI resource set, e.g., the first (or second) aperiodic CSI resource set, that is associated to the indicator.
In yet another example, an entity ID—denoted by a first (or second) entity ID—could be associated to the first (or second) aperiodic CSI resource set as specified herein in the present disclosure (e.g., the entity ID could be provided in nzp-CSI-RS-ResourceSet or CSI-SSB-ResourceSet or CSI-AssociatedReportConfigInfo of CSI-AperiodicTriggerState or CSI-ResourceConfig or CSI-ReportConfig that configures or is associated to the corresponding aperiodic CSI resource set). When the entity ID, e.g., the first (or second) entity ID, is associated to the first TCI state(s) as specified herein in the present disclosure, the UE 116 could use/apply the first TCI state(s) for the aperiodic CSI resource set, e.g., the first (or second) aperiodic CSI resource set, that is associated to the entity ID. When the entity ID, e.g., the first (or second) entity ID, is associated to the second TCI state(s) as specified herein in the present disclosure, the UE 116 could use/apply the second TCI state(s) for the aperiodic CSI resource set, e.g., the first (or second) aperiodic CSI resource set, that is associated to the entity ID. In the present disclosure, the entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
In yet another example, a bitmap of length two could be provided/configured/indicated in CSI-ResourceConfig or CSI-AssociatedReportConfigInfo of CSI-AperiodicTriggerState or CSI-ResourceConfig or CSI-ReportConfig that configures or is associated to the first and second aperiodic CSI resource sets as specified herein in the present disclosure, wherein the first entry/bit position of the bitmap could be associated to the first aperiodic CSI resource set and the second entry/bit position of the bitmap could be associated to the second aperiodic CSI resource set (or the value of the first entry/bit position of the bitmap could be provided/indicated in the higher layer parameter that configures or is associated to the first aperiodic CSI resource set configured by/associated to CSI-ResourceConfig or CSI-AssociatedReportConfigInfo of CSI-AperiodicTriggerState or CSI-ResourceConfig or CSI-ReportConfig, and the value of the second entry/bit position of the bitmap could be provided/indicated in the higher layer parameter that configures or is associated to the second aperiodic CSI resource set configured by/associated to CSI-ResourceConfig or CSI-AssociatedReportConfigInfo of CSI-AperiodicTriggerState or CSI-ResourceConfig or CSI-ReportConfig). When the first entry/bit position of the bitmap is set to ‘0’ (or ‘1’), the UE 116 could use/apply the first TCI state(s) as specified herein in the present disclosure for the first aperiodic CSI resource set. When the first entry/bit position of the bitmap is set to ‘1’ (or ‘0’), the UE 116 could use/apply the second TCI state(s) as specified herein in the present disclosure for the first aperiodic CSI resource set. When the second entry/bit position of the bitmap is set to ‘0’ (or ‘1’), the UE 116 could use/apply the first TCI state(s) as specified herein in the present disclosure for the second aperiodic CSI resource set. When the second entry/bit position of the bitmap is set to ‘1’ (or ‘0’), the UE 116 could use/apply the second TCI state(s) as specified herein in the present disclosure for the second aperiodic CSI resource set.
In yet another example, a set including two entity IDs—denoted by first and second entity IDs—could be provided/configured/indicated in CSI-ResourceConfig or CSI-AssociatedReportConfigInfo of CSI-AperiodicTriggerState or CSI-ResourceConfig or CSI-ReportConfig that configures or is associated to the first and second aperiodic CSI resource sets as specified herein in the present disclosure, wherein the first entity ID could be associated to the first aperiodic CSI resource set and the second entity ID could be associated to the second aperiodic CSI resource set (or the first entity ID could be provided/indicated in the higher layer parameter that configures or is associated to the first aperiodic CSI resource set configured by/associated to CSI-ResourceConfig or CSI-AssociatedReportConfigInfo of CSI-AperiodicTriggerState or CSI-ResourceConfig or CSI-ReportConfig, and the second entity ID could be provided/indicated in the higher layer parameter that configures or is associated to the second aperiodic CSI resource set configured by/associated to CSI-ResourceConfig or CSI-AssociatedReportConfigInfo of CSI-AperiodicTriggerState or CSI-ResourceConfig or CSI-ReportConfig). When the first entity ID is associated to the first TCI state(s) as specified herein in the present disclosure, the UE 116 could use/apply the first TCI state(s) for the first aperiodic CSI resource set. When the first entity ID is associated to the second TCI state(s) as specified herein in the present disclosure, the UE 116 could use/apply the second TCI state(s) for the first aperiodic CSI resource set. When the second entity ID is associated to the first TCI state(s) as specified herein in the present disclosure, the UE 116 could use/apply the first TCI state(s) for the second aperiodic CSI resource set. When the second entity ID is associated to the second TCI state(s) as specified herein in the present disclosure, the UE 116 could use/apply the second TCI state(s) for the second aperiodic CSI resource set. In the present disclosure, the first (or second) entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
In yet another example, a bitmap of length two could be provided/configured/indicated in CSI-AssociatedReportConfigInfo of CSI-AperiodicTriggerState or CSI-ResourceConfig or CSI-ReportConfig that configures or is associated to the first and second aperiodic CSI resource sets as specified herein in the present disclosure, wherein the first entry/bit position of the bitmap could be associated to the first aperiodic CSI resource set and the second entry/bit position of the bitmap could be associated to the second aperiodic CSI resource set (or the value of the first entry/bit position of the bitmap could be provided/indicated in the higher layer parameter that configures or is associated to the first aperiodic CSI resource set configured by/associated to CSI-AssociatedReportConfigInfo or CSI-ResourceConfig or CSI-ReportConfig, and the value of the second entry/bit position of the bitmap could be provided/indicated in the higher layer parameter that configures or is associated to the second aperiodic CSI resource set configured by/associated to CSI-AssociatedReportConfigInfo or CSI-ResourceConfig or CSI-ReportConfig). When the first entry/bit position of the bitmap is set to ‘0’ (or ‘1’), the UE 116 could use/apply the first TCI state(s) as specified herein in the present disclosure for the first aperiodic CSI resource set. When the first entry/bit position of the bitmap is set to ‘1’ (or ‘0’), the UE 116 could use/apply the second TCI state(s) as specified herein in the present disclosure for the first aperiodic CSI resource set. When the second entry/bit position of the bitmap is set to ‘0’ (or ‘1’), the UE 116 could use/apply the first TCI state(s) as specified herein in the present disclosure for the second aperiodic CSI resource set, and when the second entry/bit position of the bitmap is set to ‘1’ (or ‘0’), the UE 116 could use/apply the second TCI state(s) as specified herein in the present disclosure for the second aperiodic CSI resource set.
In yet another example, a set including two entity IDs—denoted by first and second entity IDs—could be provided/configured/indicated in CSI-AssociatedReportConfigInfo of CSI-AperiodicTriggerState or CSI-ResourceConfig or CSI-ReportConfig that configures or is associated to the first and second aperiodic CSI resource sets as specified herein in the present disclosure, wherein the first entity ID could be associated to the first aperiodic CSI resource set and the second entity ID could be associated to the second aperiodic CSI resource set (or the first entity ID could be provided/indicated in the higher layer parameter that configures or is associated to the first aperiodic CSI resource set configured by/associated to CSI-AssociatedReportConfigInfo or CSI-ResourceConfig or CSI-ReportConfig, and the second entity ID could be provided/indicated in the higher layer parameter that configures or is associated to the second aperiodic CSI resource set configured by/associated to CSI-AssociatedReportConfigInfo or CSI-ResourceConfig or CSI-ReportConfig). When the first entity ID is associated to the first TCI state(s) as specified herein in the present disclosure, the UE 116 could use/apply the first TCI state(s) for the first aperiodic CSI resource set, and when the first entity ID is associated to the second TCI state(s) as specified herein in the present disclosure, the UE 116 could use/apply the second TCI state(s) for the first aperiodic CSI resource set. When the second entity ID is associated to the first TCI state(s) as specified herein in the present disclosure, the UE 116 could use/apply the first TCI state(s) for the second aperiodic CSI resource set. When the second entity ID is associated to the second TCI state(s) as specified herein in the present disclosure, the UE 116 could use/apply the second TCI state(s) for the second aperiodic CSI resource set. In the present disclosure, the first (or second) entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
In yet another example, one or more CSI-RS resources configured/provided in the first and/or second aperiodic CSI resource set(s) as specified herein in the present disclosure could be associated with an indicator or entity ID (e.g., by providing/indicating the indicator/entity ID in the higher layer parameter(s) that configures or is associated to the one or more CSI-RS resources—e.g., NZP-CSI-RS-Resource, CSI-AssociatedReportConfigInfo of CSI-AperiodicTriggerState or CSI-ResourceConfig or CSI-ReportConfig or etc.), wherein the indicator or the entity ID could indicate or could be associated to the first and/or second TCI state(s) as specified herein in the present disclosure. For instance, when the indicator or the entity ID indicates or is associated to the first TCI state (e.g., by setting the indicator to ‘0’ (or ‘1’)), the UE 116 could use/apply the first TCI state for receiving the one or more CSI-RS resources in the first and/or second aperiodic CSI resource set(s), and when the indicator or the entity ID indicates or is associated to the second TCI state (e.g., by setting the indicator to ‘1’ (or ‘0’)), the UE 116 could use/apply the second TCI state for receiving the one or more CSI-RS resources in the first and/or second aperiodic CSI resource set(s).
   In one example, for the first (or second) aperiodic CSI resource set that comprises/provides/configures Ncsi≥1 CSI-RS resources, a bitmap of length Ncsi could be provided/indicated/configured in the higher layer parameter(s) that configures or is associated to the first (or second) aperiodic CSI resource set, with each entry/bit position of the bitmap corresponding to a CSI-RS resource in the first (or second) aperiodic CSI resource set in an descending (or ascending) order in terms of the positions of the CSI-RS resources in the first (or second) aperiodic CSI resource set and/or the positions of the entries/bit positions in the bitmap and/or the resource IDs of the CSI-RS resources in the first (or second) aperiodic CSI resource set. When an entry/bit position of the bitmap is set to ‘0’ (or ‘1’), the UE 116 could use/apply the first TCI state for receiving the CSI-RS resource—in the first (or second) aperiodic CSI resource set—that is associated to the entry/bit position, and when an entry/bit position of the bitmap is set to ‘1’ (or ‘0’), the UE 116 could use/apply the second TCI state for receiving the CSI-RS resource—in the first (or second) aperiodic CSI resource set—that is associated to the entry/bit position.
   In another example, for the first (or second) aperiodic CSI resource set that comprises/provides/configures Ncsi≥1 CSI-RS resources, a set of Ncsi entity IDs could be provided/indicated/configured in the higher layer parameter(s) that configures or is associated to the first (or second) aperiodic CSI resource set, with each entity ID in the set corresponding to a CSI-RS resource in the first (or second) aperiodic CSI resource set in an descending (or ascending) order in terms of the positions of the CSI-RS resources in the first (or second) aperiodic CSI resource set and/or the positions of the entity IDs in the set and/or the values of the entity IDs in the set and/or the resource IDs of the CSI-RS resources in the first (or second) aperiodic CSI resource set. When an entity ID is associated to the first TCI state(s) as specified herein in the present disclosure, the UE 116 could use/apply the first TCI state(s) for receiving the CSI-RS resource—in the first (or second) aperiodic CSI resource set—that is associated to the entity ID. When an entity ID in the set is associated to the second TCI state(s) as specified herein in the present disclosure, the UE 116 could use/apply the second TCI state(s) for receiving the CSI-RS resource—in the first (or second) aperiodic CSI resource set—that is associated to the entity ID. In the present disclosure, an entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
   In yet another example, an indicator could be provided/indicated/configured in the higher layer parameter(s) that configures or is associated to a/each CSI-RS resource configured/provided in the first (or second) aperiodic CSI resource set. When an indicator configured/associated to a CSI-RS resource in the first (or second) aperiodic CSI resource set is set to ‘0’ (or ‘1’), the UE 116 could use/apply the first TCI state for receiving the CSI-RS resource—in the first (or second) aperiodic CSI resource set—that is configured/associated with the indicator. When an indicator configured/associated to a CSI-RS resource in the first (or second) aperiodic CSI resource set is set to ‘1’ (or ‘0’), the UE 116 could use/apply the second TCI state for receiving the CSI-RS resource—in the first (or second) aperiodic CSI resource set—that is configured/associated with the indicator.
   In yet another example, an entity ID could be provided/indicated/configured in the higher layer parameter(s) that configures or is associated to a/each CSI-RS resource configured/provided in the first (or second) aperiodic CSI resource set. When an entity ID configured/associated to a CSI-RS resource in the first (or second) aperiodic CSI resource set is associated to the first TCI state(s), the UE 116 could use/apply the first TCI state(s) for receiving the CSI-RS resource—in the first (or second) aperiodic CSI resource set—that is configured/associated with the entity ID. When an entity ID configured/associated to a CSI-RS resource in the first (or second) aperiodic CSI resource set is associated to the second TCI state(s), the UE 116 could use/apply the second TCI state(s) for receiving the CSI-RS resource—in the first (or second) aperiodic CSI resource set—that is configured/associated with the entity ID. In the present disclosure, an entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.

The indicator(s) and/or entity ID(s) associated to each of the CSI-RS resources in the same aperiodic CSI resource set—e.g., the first or second aperiodic CSI resource set—as specified herein in the present disclosure could be the same or identical such that the UE 116 could use/apply the same TCI state(s)—e.g., the first or second TCI state(s)—to receive all the CSI-RS resources in the same aperiodic CSI resource set—e.g., the first or second aperiodic CSI resource set. Furthermore, the value(s) of the indicator(s) and/or entity ID(s) associated to each of the CSI-RS resources in the first aperiodic CSI resource set as specified herein in the present disclosure could be different from the value(s) of the indicator(s) and/or entity ID(s) associated to each of the CSI-RS resources in the second aperiodic CSI resource set as specified herein in the present disclosure such that the UE 116 could use/apply a TCI state(s)—e.g., the first (or second) TCI state(s)—to receive all the CSI-RS resources in the first aperiodic CSI resource set, and a different TCI state(s)—e.g., the second (or first) TCI state(s)—to receive all the CSI-RS resources in the second aperiodic CSI resource set.

For aperiodic CSI, each trigger state configured using the higher layer parameter CSI-AperiodicTriggerState is associated with one or multiple CSI-ReportConfig where the CSI-ReportConfig not configured with groupBasedBeamReporting-r17 is linked to periodic, or semi-persistent, or aperiodic resource setting(s). When one Resource Setting is configured, the Resource Setting (given by higher layer parameter resourcesForChannelMeasurement) is for channel measurement for L1-RSRP or for channel and interference measurement for L1-SINR computation. For this case, an NZP CSI-RS Resource Set for channel measurement—denoted by third aperiodic CSI resource set for non-coherent joint transmission (NCJT) CSI measurement in the present disclosure—with 2≤Ks≤8 resources can be configured with two Resource Groups, with K1≥1 resources in first aperiodic CSI resource group, and K2≥1 resources in second aperiodic CSI resource group, such that K1+K2=Ks, and with N∈{1,2} Resource Pairs. Each Resource Pair includes one resource from the first aperiodic CSI resource group—denoted by first CSI-RS resource in the pair, and one resource from the second aperiodic CSI resource group—denoted by second CSI-RS resource in the pair. The first and/or second TCI state(s) as specified herein in the present disclosure could be associated to the first and/or second aperiodic CSI resource groups in the third aperiodic CSI resource set, or equivalently, the UE 116 could apply/use the first and/or second TCI state(s) for the first and/or second aperiodic CSI resource groups in the third aperiodic CSI resource set, according to one or more of the following.
In one example, the first TCI state(s) as specified herein in the present disclosure could be associated to the first (or second) aperiodic CSI resource group for the NCJT CSI measurement, and the second TCI state(s) as specified herein in the present disclosure could be associated to the second (or first) aperiodic CSI resource group for the NCJT CSI measurement. Or equivalently, the UE 116 could use/apply the first TCI state(s) as specified herein in the present disclosure for the first (or second) aperiodic CSI resource group, and the second TCI state(s) as specified herein in the present disclosure for the second (or first) aperiodic CSI resource group.
In another example, an indicator—denoted by a first (or second) indicator—could be associated to the first (or second) aperiodic CSI resource group as specified herein in the present disclosure (e.g., the indicator could be provided in CSI-ResourceConfig or CSI-AssociatedReportConfigInfo of CSI-AperiodicTriggerState or NZP-CSI-RS-ResourceSet or CSI-SSB-ResourceSet or CMRGroupingAndPairing-r17 or CSI-ResourceConfig or CSI-ReportConfig that configures or is associated to the corresponding aperiodic CSI resource group(s)). When the indicator, e.g., the first (or second) indicator, is a one-bit indicator and set to ‘0’ (or ‘1’), the UE 116 could use/apply the first TCI state(s) as specified herein in the present disclosure for the aperiodic CSI resource group, e.g., the first (or second) aperiodic CSI resource group, that is associated to the indicator, and the second TCI state(s) as specified herein in the present disclosure for the other aperiodic CSI resource group, e.g., the second (or first) aperiodic CSI resource group, in the third aperiodic CSI resource set as specified herein in the present disclosure for the NCJT CSI measurement. When the indicator, e.g., the first (or second) indicator, is a one-bit indicator and set to ‘1’ (or ‘0’), the UE 116 could use/apply the second TCI state(s) as specified herein in the present disclosure for the aperiodic CSI resource group, e.g., the first (or second) aperiodic CSI resource group, that is associated to the indicator, and the first TCI state(s) as specified herein in the present disclosure for the other aperiodic CSI resource group, e.g., the second (or first) aperiodic CSI resource group, in the third aperiodic CSI resource set as specified herein in the present disclosure for the NCJT CSI measurement.
In yet another example, an indicator could be associated to the third aperiodic CSI resource set as specified herein in the present disclosure (e.g., the indicator could be provided in nzp-CSI-RS-ResourceSet or CSI-SSB-ResourceSet or CSI-AssociatedReportConfigInfo of CSI-AperiodicTriggerState or CSI-ResourceConfig or CSI-ReportConfig that configures or is associated to the corresponding third aperiodic CSI resource set). When the indicator is a one-bit indicator and set to ‘0’ (or ‘1’), the UE 116 could use/apply the first TCI state(s) as specified herein in the present disclosure for the first (or second) aperiodic CSI resource group, and the second TCI state(s) as specified herein in the present disclosure for the other aperiodic CSI resource group, i.e., the second (or first) aperiodic CSI resource group, in the third aperiodic CSI resource set as specified herein in the present disclosure for the NCJT CSI measurement. When the indicator is set to ‘1’ (or ‘0’), the UE 116 could use/apply the second TCI state(s) as specified herein in the present disclosure for the first (or second) aperiodic CSI resource group, and the first TCI state(s) as specified herein in the present disclosure for the other aperiodic CSI resource group, i.e., the second (or first) aperiodic CSI resource group, in the third aperiodic CSI resource set as specified herein in the present disclosure for the NCJT CSI measurement.
In yet another example, an entity ID—denoted by a first (or second) entity ID—could be associated to the first (or second) aperiodic CSI resource group as specified herein in the present disclosure (e.g., the entity ID could be provided in CSI-ResourceConfig or CSI-AssociatedReportConfigInfo of CSI-AperiodicTriggerState or NZP-CSI-RS-ResourceSet or CSI-SSB-ResourceSet or CMRGroupingAndPairing-r17 or CSI-ResourceConfig or CSI-ReportConfig that configures or is associated to the corresponding aperiodic CSI resource group(s)). When the entity ID, e.g., the first (or second) entity ID, is associated to the first TCI state(s) as specified herein in the present disclosure, the UE 116 could use/apply the first TCI state(s) for the aperiodic CSI resource group, e.g., the first (or second) aperiodic CSI resource group, that is associated to the entity ID, and the second TCI state(s) as specified herein in the present disclosure for the other aperiodic CSI resource group, e.g., the second (or first) aperiodic CSI resource group, in the third aperiodic CSI resource set as specified herein in the present disclosure for the NCJT CSI measurement. When the entity ID, e.g., the first (or second) entity ID, is associated to the second TCI state(s) as specified herein in the present disclosure, the UE 116 could use/apply the second TCI state(s) for the aperiodic CSI resource group, e.g., the first (or second) aperiodic CSI resource group, that is associated to the entity ID, and the first TCI state(s) as specified herein in the present disclosure for the other aperiodic CSI resource group, e.g., the second (or first) aperiodic CSI resource group, in the third aperiodic CSI resource set as specified herein in the present disclosure for the NCJT CSI measurement. In the present disclosure, the entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
In yet another example, a bitmap of length two could be provided/configured/indicated in CSI-ResourceConfig or CSI-AssociatedReportConfigInfo of CSI-AperiodicTriggerState or NZP-CSI-RS-ResourceSet or CSI-SSB-ResourceSet or CMRGroupingAndPairing-r17 or CSI-ResourceConfig or CSI-ReportConfig that configures or is associated to the first and second aperiodic CSI resource groups as specified herein in the present disclosure, wherein the first entry/bit position of the bitmap could be associated to the first aperiodic CSI resource group and the second entry/bit position of the bitmap could be associated to the second aperiodic CSI resource group (or the value of the first entry/bit position of the bitmap could be provided/indicated in the higher layer parameter that configures or is associated to the first aperiodic CSI resource group configured by/associated to CSI-ResourceConfig or CSI-AssociatedReportConfigInfo of CSI-AperiodicTriggerState or NZP-CSI-RS-ResourceSet or CSI-SSB-ResourceSet or CMRGroupingAndPairing-r17 or CSI-ResourceConfig or CSI-ReportConfig, and the value of the second entry/bit position of the bitmap could be provided/indicated in the higher layer parameter that configures or is associated to the second aperiodic CSI resource group configured by/associated to CSI-ResourceConfig or CSI-AssociatedReportConfigInfo of CSI-AperiodicTriggerState or NZP-CSI-RS-ResourceSet or CSI-SSB-ResourceSet or CMRGroupingAndPairing-r17 or CSI-ResourceConfig or CSI-ReportConfig). When the first entry/bit position of the bitmap is set to ‘0’ (or ‘1’), the UE 116 could use/apply the first TCI state(s) as specified herein in the present disclosure for the first aperiodic CSI resource group, and when the first entry/bit position of the bitmap is set to ‘1’ (or ‘0’), the UE 116 could use/apply the second TCI state(s) as specified herein in the present disclosure for the first aperiodic CSI resource group. When the second entry/bit position of the bitmap is set to ‘0’ (or ‘1’), the UE 116 could use/apply the first TCI state(s) as specified herein in the present disclosure for the second aperiodic CSI resource group, and when the second entry/bit position of the bitmap is set to ‘1’ (or ‘0’), the UE 116 could use/apply the second TCI state(s) as specified herein in the present disclosure for the second aperiodic CSI resource group.
In yet another example, a set including two entity IDs—denoted by first and second entity IDs—could be provided/configured/indicated in CSI-ResourceConfig or CSI-AssociatedReportConfigInfo of CSI-AperiodicTriggerState or NZP-CSI-RS-ResourceSet or CSI-SSB-ResourceSet or CMRGroupingAndPairing-r17 or CSI-ResourceConfig or CSI-ReportConfig that configures or is associated to the first and second aperiodic CSI resource groups as specified herein in the present disclosure, wherein the first entity ID could be associated to the first aperiodic CSI resource group and the second entity ID could be associated to the second aperiodic CSI resource group (or the first entity ID could be provided/indicated in the higher layer parameter that configures or is associated to the first aperiodic CSI resource group configured by/associated to CSI-ResourceConfig or CSI-AssociatedReportConfigInfo of CSI-AperiodicTriggerState or NZP-CSI-RS-ResourceSet or CSI-SSB-ResourceSet or CMRGroupingAndPairing-r17 or CSI-ResourceConfig or CSI-ReportConfig. The second entity ID could be provided/indicated in the higher layer parameter that configures or is associated to the second aperiodic CSI resource group configured by/associated to CSI-ResourceConfig or CSI-AssociatedReportConfigInfo of CSI-AperiodicTriggerState or NZP-CSI-RS-ResourceSet or CSI-SSB-ResourceSet or CMRGroupingAndPairing-r17 or CSI-ResourceConfig or CSI-ReportConfig). When the first entity ID is associated to the first TCI state(s) as specified herein in the present disclosure, the UE 116 could use/apply the first TCI state(s) for the first aperiodic CSI resource group. When the first entity ID is associated to the second TCI state(s) as specified herein in the present disclosure, the UE 116 could use/apply the second TCI state(s) as specified herein in the present disclosure for the first aperiodic CSI resource group. When the second entity ID is associated to the first TCI state(s) as specified herein in the present disclosure, the UE 116 could use/apply the first TCI state(s) for the second aperiodic CSI resource group. When the second entity ID is associated to the second TCI state(s) as specified herein in the present disclosure, the UE 116 could use/apply the second TCI state(s) as specified herein in the present disclosure for the second aperiodic CSI resource group. In the present disclosure, the first (or second) entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
In yet another example, a bitmap of length two could be provided/configured/indicated in NZP-CSI-RS-Pairing-r17 or CSI-AssociatedReportConfigInfo of CSI-AperiodicTriggerState or CSI-ResourceConfig or CSI-ReportConfig that configures or is associated to the first and second CSI-RS resources in a pair as specified herein in the present disclosure, wherein the first entry/bit position of the bitmap could be associated to the first CSI-RS resource in the pair and the second entry/bit position of the bitmap could be associated to the second CSI-RS resource in the pair (or the value of the first entry/bit position of the bitmap could be provided/indicated in the higher layer parameter that configures or is associated to the first CSI-RS resource in the pair configured by/associated to NZP-CSI-RS-Pairing-r17 or CSI-AssociatedReportConfigInfo of CSI-AperiodicTriggerState or CSI-ResourceConfig or CSI-ReportConfig, and the value of the second entry/bit position of the bitmap could be provided/indicated in the higher layer parameter that configures or is associated to the second CSI-RS resource in the pair configured by/associated to NZP-CSI-RS-Pairing-r17 or CSI-AssociatedReportConfigInfo of CSI-AperiodicTriggerState or CSI-ResourceConfig or CSI-ReportConfig). When the first entry/bit position of the bitmap is set to ‘0’ (or ‘1’), the UE 116 could use/apply the first TCI state(s) as specified herein in the present disclosure for the first CSI-RS resource in the pair, and when the first entry/bit position of the bitmap is set to ‘1’ (or ‘0’), the UE 116 could use/apply the second TCI state(s) as specified herein in the present disclosure for the first CSI-RS resource in the pair. When the second entry/bit position of the bitmap is set to ‘0’ (or ‘1’), the UE 116 could use/apply the first TCI state(s) as specified herein in the present disclosure for the second CSI-RS resource in the pair. When the second entry/bit position of the bitmap is set to ‘1’ (or ‘0’), the UE 116 could use/apply the second TCI state(s) as specified herein in the present disclosure for the second CSI-RS resource in the pair.
In yet another example, a set including two entity IDs—denoted by first and second entity IDs—could be provided/configured/indicated in NZP-CSI-RS-Pairing-r17 or CSI-AssociatedReportConfigInfo of CSI-AperiodicTriggerState or CSI-ResourceConfig or CSI-ReportConfig that configures or is associated to the first and second CSI-RS resources in a pair as specified herein in the present disclosure, wherein the first entity ID could be associated to the first CSI-RS resource in the pair and the second entity ID could be associated to the second CSI-RS resource in the pair (or the first entity ID could be provided/indicated in the higher layer parameter that configures or is associated to the first CSI-RS resource in the pair configured by/associated to NZP-CSI-RS-Pairing-r17 or CSI-AssociatedReportConfigInfo of CSI-AperiodicTriggerState or CSI-ResourceConfig or CSI-ReportConfig. The second entity ID could be provided/indicated in the higher layer parameter that configures or is associated to the second CSI-RS resource in the pair configured by/associated to NZP-CSI-RS-Pairing-r17 or CSI-AssociatedReportConfigInfo of CSI-AperiodicTriggerState or CSI-ResourceConfig or CSI-ReportConfig). When the first entity ID is associated to the first TCI state(s) as specified herein in the present disclosure, the UE 116 could use/apply the first TCI state(s) for the first CSI-RS resource in the pair. When the first entity ID is associated to the second TCI state(s) as specified herein in the present disclosure, the UE 116 could use/apply the second TCI state(s) for the first CSI-RS resource in the pair. When the second entity ID is associated to the first TCI state(s) as specified herein in the present disclosure, the UE 116 could use/apply the first TCI state(s) for the second CSI-RS resource in the pair. When the second entity ID is associated to the second TCI state(s) as specified herein in the present disclosure, the UE 116 could use/apply the second TCI state(s) for the second CSI-RS resource in the pair. In the present disclosure, the first (or second) entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
In yet another example, one or more CSI-RS resources configured/provided in the third aperiodic CSI resource set as specified herein in the present disclosure could be associated with an indicator or entity ID (e.g., by providing/indicating the indicator/entity ID in the higher layer parameter(s) that configures or is associated to the one or more CSI-RS resources—e.g., NZP-CSI-RS-Resource, CSI-AssociatedReportConfigInfo of CSI-AperiodicTriggerState or CSI-ResourceConfig or CSI-ReportConfig or etc.), wherein the indicator or the entity ID could indicate or could be associated to the first and/or second TCI state(s) as specified herein in the present disclosure. For instance, when the indicator or the entity ID indicates or is associated to the first TCI state (e.g., by setting the indicator to ‘0’ (or ‘1’)), the UE 116 could use/apply the first TCI state for receiving the one or more CSI-RS resources in the third aperiodic CSI resource set, and when the indicator or the entity ID indicates or is associated to the second TCI state (e.g., by setting the indicator to ‘1’ (or ‘0’)), the UE 116 could use/apply the second TCI state for receiving the one or more CSI-RS resources in the third aperiodic CSI resource set.
   In one example, for the third aperiodic CSI resource set that comprises/provides/configures Ncsi≥1 CSI-RS resources, a bitmap of length Ncsi could be provided/indicated/configured in the higher layer parameter(s) that configures or is associated to the third aperiodic CSI resource set, with each entry/bit position of the bitmap corresponding to a CSI-RS resource in the third aperiodic CSI resource set in an descending (or ascending) order in terms of the positions of the CSI-RS resources in the third aperiodic CSI resource set and/or the positions of the entries/bit positions in the bitmap and/or the resource IDs of the CSI-RS resources in the third aperiodic CSI resource set. When an entry/bit position of the bitmap is set to ‘0’ (or ‘1’), the UE 116 could use/apply the first TCI state for receiving the CSI-RS resource—in the third aperiodic CSI resource set—that is associated to the entry/bit position. When an entry/bit position of the bitmap is set to ‘1’ (or ‘0’), the UE 116 could use/apply the second TCI state for receiving the CSI-RS resource—in the third aperiodic CSI resource set—that is associated to the entry/bit position.
   In another example, for the third aperiodic CSI resource set that comprises/provides/configures Ncsi≥1 CSI-RS resources, a set of Ncsi entity IDs could be provided/indicated/configured in the higher layer parameter(s) that configures or is associated to the third aperiodic CSI resource set, with each entity ID in the set corresponding to a CSI-RS resource in the third aperiodic CSI resource set in an descending (or ascending) order in terms of the positions of the CSI-RS resources in the third aperiodic CSI resource set and/or the positions of the entity IDs in the set and/or the values of the entity IDs in the set and/or the resource IDs of the CSI-RS resources in the third aperiodic CSI resource set. When an entity ID is associated to the first TCI state(s) as specified herein in the present disclosure, the UE 116 could use/apply the first TCI state(s) for receiving the CSI-RS resource—in the third aperiodic CSI resource set—that is associated to the entity ID. When an entity ID in the set is associated to the second TCI state(s) as specified herein in the present disclosure, the UE 116 could use/apply the second TCI state(s) for receiving the CSI-RS resource—in the third aperiodic CSI resource set—that is associated to the entity ID. In the present disclosure, an entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
   In yet another example, an indicator could be provided/indicated/configured in the higher layer parameter(s) that configures or is associated to a/each CSI-RS resource configured/provided in the third aperiodic CSI resource set. When an indicator configured/associated to a CSI-RS resource in the third aperiodic CSI resource set is set to ‘0’ (or ‘1’), the UE 116 could use/apply the first TCI state for receiving the CSI-RS resource—in the third aperiodic CSI resource set—that is configured/associated with the indicator. When an indicator configured/associated to a CSI-RS resource in the third aperiodic CSI resource set is set to ‘1’ (or ‘0’), the UE 116 could use/apply the second TCI state for receiving the CSI-RS resource—in the third aperiodic CSI resource set—that is configured/associated with the indicator.
   In yet another example, an entity ID could be provided/indicated/configured in the higher layer parameter(s) that configures or is associated to a/each CSI-RS resource configured/provided in the third aperiodic CSI resource set. When an entity ID configured/associated to a CSI-RS resource in the third aperiodic CSI resource set is associated to the first TCI state(s), the UE 116 could use/apply the first TCI state(s) for receiving the CSI-RS resource—in the third aperiodic CSI resource set—that is configured/associated with the entity ID. When an entity ID configured/associated to a CSI-RS resource in the third aperiodic CSI resource set is associated to the second TCI state(s), the UE 116 could use/apply the second TCI state(s) for receiving the CSI-RS resource—in the third aperiodic CSI resource set—that is configured/associated with the entity ID. In the present disclosure, an entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.

The indicator(s) and/or entity ID(s) associated to each of the CSI-RS resources in the same aperiodic CSI resource group in the third aperiodic CSI resource set—e.g., the first or second aperiodic CSI resource group in the third aperiodic CSI resource set—as specified herein in the present disclosure could be the same or identical such that the UE 116 could use/apply the same TCI state(s)—e.g., the first or second TCI state(s)—to receive all the CSI-RS resources in the same aperiodic CSI resource group in the third aperiodic CSI resource set—e.g., the first or second aperiodic CSI resource group in the third aperiodic CSI resource set. Furthermore, the value(s) of the indicator(s) and/or entity ID(s) associated to each of the CSI-RS resources in the first aperiodic CSI resource group in the third aperiodic CSI resource set as specified herein in the present disclosure could be different from the value(s) of the indicator(s) and/or entity ID(s) associated to each of the CSI-RS resources in the second aperiodic CSI resource group in the third aperiodic CSI resource set as specified herein in the present disclosure such that the UE 116 could use/apply a TCI state(s)—e.g., the first (or second) TCI state(s)—to receive all the CSI-RS resources in the first aperiodic CSI resource group in the third aperiodic CSI resource set, and a different TCI state(s)—e.g., the second (or first) TCI state(s)—to receive all the CSI-RS resources in the second aperiodic CSI resource group in the third aperiodic CSI resource set. Or equivalently, the value(s) of the indicator(s) and/or entity ID(s) associated to the first CSI-RS resource in the pair as specified herein in the present disclosure could be different from the value(s) of the indicator(s) and/or entity ID(s) associated to the second CSI-RS resource in the pair as specified herein in the present disclosure such that the UE 116 could use/apply a TCI state(s)—e.g., the first (or second) TCI state(s)—to receive the first CSI-RS resource in the pair, and a different TCI state(s)—e.g., the second (or first) TCI state(s)—to receive the second CSI-RS resource in the pair.

For aperiodic CSI, each trigger state configured using the higher layer parameter CSI-AperiodicTriggerState is associated with one or multiple CSI-ReportConfig where the CSI-ReportConfig is linked to periodic, or semi-persistent, or aperiodic resource setting(s). When one Resource Setting is configured, the Resource Setting (given by higher layer parameter resourcesForChannelMeasurement and denoted by fourth aperiodic CSI resource set in the present disclosure) is for channel measurement for L1-RSRP or for channel and interference measurement for L1-SINR computation. The first or second TCI state as specified herein in the present disclosure could be associated to the fourth aperiodic CSI resource set, or equivalently, the UE 116 could apply/use the first or second TCI state for the fourth aperiodic CSI resource set, according to one or more of the following.
In one example, the first TCI state(s) as specified herein in the present disclosure could be associated to the fourth aperiodic CSI resource set for the L1 measurements for the group based beam reporting for the MTRP operation. Or equivalently, the UE 116 could use/apply the first TCI state(s) as specified herein in the present disclosure for the fourth aperiodic CSI resource set.
In another example, the second TCI state(s) as specified herein in the present disclosure could be associated to the fourth aperiodic CSI resource set for the L1 measurements for the group based beam reporting for the MTRP operation. Or equivalently, the UE 116 could use/apply the second TCI state(s) as specified herein in the present disclosure for the fourth aperiodic CSI resource set.
In yet another example, an indicator could be associated to the fourth aperiodic CSI resource set as specified herein in the present disclosure (e.g., the indicator could be provided in CSI-ResourceConfig or nzp-CSI-RS-ResourceSet or CSI-SSB-ResourceSet or CSI-AssociatedReportConfigInfo of CSI-AperiodicTriggerState or CSI-ResourceConfig or CSI-ReportConfig that configures or is associated to the corresponding fourth aperiodic CSI resource set). When the indicator is a one-bit indicator and set to ‘0’ (or ‘1’), the UE 116 could use/apply the first TCI state(s) as specified herein in the present disclosure for the fourth aperiodic CSI resource set. When the indicator is a one-bit indicator and set to ‘1’ (or ‘0’), the UE 116 could use/apply the second TCI state(s) as specified herein in the present disclosure for the fourth aperiodic CSI resource set.
In yet another example, an entity ID could be associated to the fourth aperiodic CSI resource set as specified herein in the present disclosure (e.g., the entity ID could be provided in CSI-ResourceConfig or nzp-CSI-RS-ResourceSet or CSI-SSB-ResourceSet or CSI-AssociatedReportConfigInfo of CSI-AperiodicTriggerState or CSI-ResourceConfig or CSI-ReportConfig that configures or is associated to the corresponding fourth aperiodic CSI resource set). When the entity ID is associated to the first TCI state(s) as specified herein in the present disclosure, the UE 116 could use/apply the first TCI state(s) for the fourth aperiodic CSI resource set. When the entity ID is associated to the second TCI state(s) as specified herein in the present disclosure, the UE 116 could use/apply the second TCI state(s) for the fourth aperiodic CSI resource set. In the present disclosure, the entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
In yet another example, one or more CSI-RS resources configured/provided in the fourth aperiodic CSI resource set as specified herein in the present disclosure could be associated with an indicator or entity ID (e.g., by providing/indicating the indicator/entity ID in the higher layer parameter(s) that configures or is associated to the one or more CSI-RS resources—e.g., NZP-CSI-RS-Resource, CSI-AssociatedReportConfigInfo of CSI-AperiodicTriggerState or CSI-ResourceConfig or CSI-ReportConfig or etc.), wherein the indicator or the entity ID could indicate or could be associated to the first and/or second TCI state(s) as specified herein in the present disclosure. For instance, when the indicator or the entity ID indicates or is associated to the first TCI state (e.g., by setting the indicator to ‘0’ (or ‘1’)), the UE 116 could use/apply the first TCI state for receiving the one or more CSI-RS resources in the fourth aperiodic CSI resource set. When the indicator or the entity ID indicates or is associated to the second TCI state (e.g., by setting the indicator to ‘1’ (or ‘0’)), the UE 116 could use/apply the second TCI state for receiving the one or more CSI-RS resources in the fourth aperiodic CSI resource set.
   In one example, for the fourth aperiodic CSI resource set that comprises/provides/configures Ncsi≥1 CSI-RS resources, a bitmap of length Ncsi could be provided/indicated/configured in the higher layer parameter(s) that configures or is associated to the fourth aperiodic CSI resource set, with each entry/bit position of the bitmap corresponding to a CSI-RS resource in the fourth aperiodic CSI resource set in an descending (or ascending) order in terms of the positions of the CSI-RS resources in the fourth aperiodic CSI resource set and/or the positions of the entries/bit positions in the bitmap and/or the resource IDs of the CSI-RS resources in the fourth aperiodic CSI resource set. When an entry/bit position of the bitmap is set to ‘0’ (or ‘1’), the UE 116 could use/apply the first TCI state for receiving the CSI-RS resource—in the fourth aperiodic CSI resource set—that is associated to the entry/bit position. When an entry/bit position of the bitmap is set to ‘1’ (or ‘0’), the UE 116 could use/apply the second TCI state for receiving the CSI-RS resource—in the fourth aperiodic CSI resource set—that is associated to the entry/bit position.
   In another example, for the fourth aperiodic CSI resource set that comprises/provides/configures Ncsi≥1 CSI-RS resources, a set of Ncsi entity IDs could be provided/indicated/configured in the higher layer parameter(s) that configures or is associated to the fourth aperiodic CSI resource set, with each entity ID in the set corresponding to a CSI-RS resource in the fourth aperiodic CSI resource set in an descending (or ascending) order in terms of the positions of the CSI-RS resources in the fourth aperiodic CSI resource set and/or the positions of the entity IDs in the set and/or the values of the entity IDs in the set and/or the resource IDs of the CSI-RS resources in the fourth aperiodic CSI resource set. When an entity ID is associated to the first TCI state(s) as specified herein in the present disclosure, the UE 116 could use/apply the first TCI state(s) for receiving the CSI-RS resource—in the fourth aperiodic CSI resource set—that is associated to the entity ID. When an entity ID in the set is associated to the second TCI state(s) as specified herein in the present disclosure, the UE 116 could use/apply the second TCI state(s) for receiving the CSI-RS resource—in the fourth aperiodic CSI resource set—that is associated to the entity ID. In the present disclosure, an entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
   In yet another example, an indicator could be provided/indicated/configured in the higher layer parameter(s) that configures or is associated to a/each CSI-RS resource configured/provided in the fourth aperiodic CSI resource set. When an indicator configured/associated to a CSI-RS resource in the fourth aperiodic CSI resource set is set to ‘0’ (or ‘1’), the UE 116 could use/apply the first TCI state for receiving the CSI-RS resource—in the fourth aperiodic CSI resource set—that is configured/associated with the indicator. When an indicator configured/associated to a CSI-RS resource in the fourth aperiodic CSI resource set is set to ‘1’ (or ‘0’), the UE 116 could use/apply the second TCI state for receiving the CSI-RS resource—in the fourth aperiodic CSI resource set—that is configured/associated with the indicator.
   In yet another example, an entity ID could be provided/indicated/configured in the higher layer parameter(s) that configures or is associated to a/each CSI-RS resource configured/provided in the fourth aperiodic CSI resource set. When an entity ID configured/associated to a CSI-RS resource in the fourth aperiodic CSI resource set is associated to the first TCI state(s), the UE 116 could use/apply the first TCI state(s) for receiving the CSI-RS resource—in the fourth aperiodic CSI resource set—that is configured/associated with the entity ID. When an entity ID configured/associated to a CSI-RS resource in the fourth aperiodic CSI resource set is associated to the second TCI state(s), the UE 116 could use/apply the second TCI state(s) for receiving the CSI-RS resource—in the fourth aperiodic CSI resource set—that is configured/associated with the entity ID. In the present disclosure, an entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.

The indicator(s) and/or entity ID(s) associated to each of the CSI-RS resources in the fourth aperiodic CSI resource set as specified herein in the present disclosure could be the same or identical such that the UE 116 could use/apply the same TCI state(s)—e.g., the first or second TCI state(s)—to receive all the CSI-RS resources in the fourth aperiodic CSI resource set. Optionally, the value(s) of the indicator(s) and/or entity ID(s) associated to each of the CSI-RS resources in the fourth aperiodic CSI resource set as specified herein in the present disclosure could be different from each other such that the UE 116 could use/apply different TCI states—e.g., the first and/or second TCI state(s)—to receive different CSI-RS resources in the fourth aperiodic CSI resource set.

Throughout the present disclosure, the first (or second) TCI state or TCI state(s) could correspond to a joint DL and UL TCI state provided by DLorJointTCI-State, a separate DL TCI state provided by DLorJointTCI-State, a separate UL TCI state provided by UL-TCIState, or a pair of separate DL and UL TCI states.

According to one or more examples specified herein in the present disclosure, a UE could be triggered/configured/activated/indicated/provided by the network 130, one or more of the first, second, third and fourth aperiodic CSI resource sets, for channel and/or interference measurement for at least one of the TRPs, NCJT CSI measurement and/or reporting, group based beam measurement and/or reporting etc.
In one example, the fourth aperiodic CSI resource set as specified herein in the present disclosure could be triggered for the channel and/or interference measurement for at least one of the TRPs.
In another example, the fourth aperiodic CSI resource set as specified herein in the present disclosure could be triggered for the channel and/or interference measurement for at least one of the TRPs and/or the NCJT CSI measurement/reporting; furthermore, the first and/or second aperiodic CSI resource sets as specified herein in the present disclosure could be triggered for the group based beam measurement/reporting. For this design example, the UE 116 could determine the third aperiodic CSI resource set as specified herein in the present disclosure for the NCJT CSI measurement/reporting according to/based on the fourth aperiodic CSI resource set.
In yet another example, the fourth aperiodic CSI resource set as specified herein in the present disclosure could be triggered for the channel and/or interference measurement for at least one of the TRPs and/or the group based beam measurement/reporting; furthermore, the third aperiodic CSI resource set as specified herein in the present disclosure could be triggered for the NCJT CSI measurement/reporting. For this design example, the UE 116 could determine the first and/or second aperiodic CSI resource sets as specified herein in the present disclosure for the group based beam measurement/reporting according to/based on the fourth aperiodic CSI resource set.
In yet another example, the fourth aperiodic CSI resource set as specified herein in the present disclosure could be triggered for the channel and/or interference measurement for at least one of the TRPs, the NCJT CSI measurement/reporting and/or the group based beam measurement/reporting. For this design example, the UE 116 could determine the first and/or second aperiodic CSI resource sets as specified herein in the present disclosure for the group based beam measurement/reporting according to/based on the fourth aperiodic CSI resource set. Optionally, the UE 116 could determine the third aperiodic CSI resource set as specified herein in the present disclosure for the NCJT CSI measurement/reporting according to/based on the fourth aperiodic CSI resource set.
In yet another example, the first and/or second aperiodic CSI resource sets as specified herein in the present disclosure could be triggered for the group based beam measurement/reporting.
In yet another example, the first and/or second aperiodic CSI resource sets as specified herein in the present disclosure could be triggered for the channel and/or interference measurement for at least one of the TRPs and/or the group based beam measurement/reporting; furthermore, the third aperiodic CSI resource set as specified herein in the present disclosure could be triggered for the NCJT CSI measurement/reporting. For this design example, the UE 116 could determine the fourth aperiodic CSI resource set as specified herein in the present disclosure for the channel and/or interference measurement for at least one of the TRPs according to/based on the first and/or second aperiodic CSI resource sets.
In yet another example, the first and/or second aperiodic CSI resource sets as specified herein in the present disclosure could be triggered for the NCJT CSI measurement/reporting and/or the group based beam measurement/reporting; furthermore, the fourth aperiodic CSI resource set as specified herein in the present disclosure could be triggered for the channel and/or interference measurement for at least one of the TRPs. For this design example, the UE 116 could determine the third aperiodic CSI resource set as specified herein in the present disclosure for the NCJT CSI measurement/reporting according to/based on the first and/or second aperiodic CSI resource sets.
In yet another example, the first and/or second aperiodic CSI resource sets as specified herein in the present disclosure could be triggered for the channel and/or interference measurement for at least one of the TRPs, the NCJT CSI measurement/reporting and/or the group based beam measurement/reporting. For this design example, the UE 116 could determine the third aperiodic CSI resource set as specified herein in the present disclosure for the NCJT CSI measurement/reporting according to/based on the first and/or second aperiodic CSI resource sets. Optionally, the UE 116 could determine the fourth aperiodic CSI resource set as specified herein in the present disclosure for the channel and/or interference measurement for at least one of the TRPs according to/based on the first and/or second aperiodic CSI resource sets.
In yet another example, the third aperiodic CSI resource set as specified herein in the present disclosure could be triggered for the NCJT CSI measurement/reporting.
In yet another example, the third aperiodic CSI resource set as specified herein in the present disclosure could be triggered for the channel and/or interference measurement for at least one of the TRPs and/or the NCJT CSI measurement/reporting; furthermore, the first and/or second aperiodic CSI resource sets as specified herein in the present disclosure could be triggered for the group based beam measurement/reporting. For this design example, the UE 116 could determine the fourth aperiodic CSI resource set as specified herein in the present disclosure for the channel and/or interference measurement for at least one of the TRPs according to/based on the third aperiodic CSI resource set.
In yet another example, the third aperiodic CSI resource set as specified herein in the present disclosure could be triggered for the NCJT CSI measurement/reporting and/or the group based beam measurement/reporting; furthermore, the fourth aperiodic CSI resource set as specified herein in the present disclosure could be triggered for the channel and/or interference measurement for at least one of the TRPs. For this design example, the UE 116 could determine the first and/or second aperiodic CSI resource sets as specified herein in the present disclosure for the group based beam measurement/reporting according to/based on the third aperiodic CSI resource set.
In yet another example, the third aperiodic CSI resource set as specified herein in the present disclosure could be triggered for the channel and/or interference measurement for at least one of the TRPs, the NCJT CSI measurement/reporting and/or the group based beam measurement/reporting. For this design example, the UE 116 could determine the first and/or second aperiodic CSI resource sets as specified herein in the present disclosure for the group based beam measurement/reporting according to/based on the third aperiodic CSI resource set. Optionally, the UE 116 could determine the fourth aperiodic CSI resource set as specified herein in the present disclosure for the channel and/or interference measurement for at least one of the TRPs according to/based on the third aperiodic CSI resource set.
In yet another example, the first and/or second aperiodic CSI resource sets as specified herein in the present disclosure could be triggered for the group based beam measurement/reporting; furthermore, the third aperiodic CSI resource set as specified herein in the present disclosure could be triggered for the NCJT CSI measurement/reporting. Additionally, the fourth aperiodic CSI resource set as specified herein in the present disclosure could also be triggered for the channel and/or interference measurement for at least one of the TRPs.

In one example, a UE could be triggered/activated/configured/indicated/provided by the network 130 the first and/or second aperiodic CSI resource sets as specified herein in the present disclosure for the group based beam measurement/reporting (e.g., following one or more examples described herein). For this case, the UE 116 could determine the third aperiodic CSI resource set for the NCJT CSI measurement/reporting according to/based on the first and/or second aperiodic CSI resource set(s) following one or more of the following.
For example, the UE 116 could use/apply the first aperiodic CSI resource set as the third aperiodic CSI resource set. Alternatively, the UE 116 could determine that the third aperiodic CSI resource set could correspond to Ka≥1 resources in the first aperiodic CSI resource set. In one example, the value of Ka could be fixed in the system specifications—for instance, the Ka resources could correspond to the first/last 8 resources in the first aperiodic CSI resource set. In another example, the UE 116 could be indicated/configured/provided by the network 130, e.g., via higher layer RRC signaling/parameter and/or MAC CE command and/or dynamic DCI based L1 signaling, the value of Ka, and/or their positions/orderings in the first aperiodic CSI resource set.
For another example, the UE 116 could use/apply the second aperiodic CSI resource set as the third aperiodic CSI resource set. Alternatively, the UE 116 could determine that the third aperiodic CSI resource set could correspond to Kb≥1 resources in the second aperiodic CSI resource set. In one example, the value of Kb could be fixed in the system specifications—for instance, the Kb resources could correspond to the first/last 8 resources in the second aperiodic CSI resource set. In another example, the UE 116 could be indicated/configured/provided by the network 130, e.g., via higher layer RRC signaling/parameter and/or MAC CE command and/or dynamic DCI based L1 signaling, the value of Kb, and/or their positions/orderings in the second aperiodic CSI resource set.
Yet for another example, the UE 116 could be configured/provided/indicated by the network 130, e.g., via higher layer RRC signaling and/or MAC CE command and/or dynamic DCI based L1 signaling, which of the first and/or second aperiodic CSI resource set(s) to use/apply as the third aperiodic CSI resource set. For instance, the UE 116 could receive from the network 130, e.g., via higher layer RRC signaling/parameter and/or MAC CE command and/or dynamic DCI based L1 signaling, a one-bit indicator with value ‘0’ (or ‘1’) indicating that the first aperiodic CSI resource set could be used/applied as the third aperiodic CSI resource set, and value ‘1’ (or ‘0’) indicating that the second aperiodic CSI resource set could be used/applied as the third aperiodic CSI resource set.
Yet for another example, the UE 116 could determine that the third aperiodic CSI resource set could include Ka≥0 resources in the first aperiodic CSI resource set and Kb≥0 resources in the second aperiodic CSI resource set. In one example, the value(s) of Ka and/or Kb could be fixed in the system specifications—for instance, the Ka resources could correspond to the last 4 resources in the first aperiodic CSI resource set and the Kb resources could correspond to the first 4 resources in the second aperiodic CSI resource set. In another example, the UE 116 could be indicated/configured/provided by the network 130, e.g., via higher layer RRC signaling/parameter and/or MAC CE command and/or dynamic DCI based L1 signaling, the value(s) of Ka and/or Kb, and/or their positions/orderings in their respective (first and/or second) aperiodic CSI resource set(s).
Yet for another example, the UE 116 could determine that the third aperiodic CSI resource set could include all of resources in the first aperiodic CSI resource set and all of resources in the second aperiodic CSI resource set. The UE 116 could be indicated/configured/provided by the network 130, e.g., via higher layer RRC signaling/parameter and/or MAC CE command and/or dynamic DCI based L1 signaling, that the third aperiodic CSI resource set could include all of resources in the first aperiodic CSI resource set and all of resources in the second aperiodic CSI resource set.
Yet for another example, when the resources provided/configured/indicated in the first and second aperiodic CSI resource sets are identical/same/common, the UE 116 could determine that the third aperiodic CSI resource set could correspond to the first aperiodic CSI resource set and/or the second aperiodic CSI resource set, e.g., according to network's configuration/indication via higher layer RRC signaling/parameter and/or MAC CE command and/or dynamic DCI based L1 signaling, or autonomously determined by the UE 116 and/or reported to the network 130 by the UE 116.
Yet for another example, an indicator—denoted by a first (or second) indicator—could be associated to the first (or second) aperiodic CSI resource set as specified herein in the present disclosure (e.g., the indicator could be provided in nzp-CSI-RS-ResourceSet or CSI-SSB-ResourceSet that configures or is associated to the corresponding aperiodic CSI resource set). When the indicator, e.g., the first (or second) indicator, is a two-bit indicator and set to ‘00’ (‘01’, ‘10’, ‘11’ or ‘none’), the UE 116 could use/apply the first TCI state(s) as specified herein in the present disclosure for the aperiodic CSI resource set, e.g., the first (or second) aperiodic CSI resource set, that is associated to the indicator. When the indicator, e.g., the first (or second) indicator, is a two-bit indicator and set to ‘01’ (‘00’, ‘10’, ‘11’ or ‘none’), the UE 116 could use/apply the second TCI state(s) as specified herein in the present disclosure for the aperiodic CSI resource set, e.g., the first (or second) aperiodic CSI resource set, that is associated to the indicator. When the indicator, e.g., the first (or second) indicator, is a two-bit indicator and set to ‘10’ or ‘11’ (‘00’, ‘01’ or ‘none’)—e.g., indicating that both of the first and second TCI states could be used/applied for at least CSI-RS reception(s), the UE 116 could determine that the third aperiodic CSI resource set for the NCJT CSI measurement/reporting could include one or more resources of the first (or second) aperiodic CSI resource set that is associated to the indicator, according to one or more of the design examples specified herein in the present disclosure. Optionally, when the indicator, e.g., the first (or second) indicator, explicitly indicates that one or more resources in the first (or second) aperiodic CSI resource set could be used/applied for the NCJT CSI measurement/reporting (same as the third aperiodic CSI resource set specified herein in the present disclosure), or explicitly indicates that both of the first and second TCI states could be used/applied for at least CSI-RS reception(s), the UE 116 could determine that the third aperiodic CSI resource set for the NCJT CSI measurement/reporting could include one or more resources of the first (or second) aperiodic CSI resource set that is associated to the indicator, according to one or more of the design examples specified herein in the present disclosure.
Yet for another example, an entity ID—denoted by a first (or second) entity ID—could be associated to the first (or second) aperiodic CSI resource set as specified herein in the present disclosure (e.g., the entity ID could be provided in nzp-CSI-RS-ResourceSet or CSI-SSB-ResourceSet that configures or is associated to the corresponding aperiodic CSI resource set). When the entity ID, e.g., the first (or second) entity ID, is associated to the first TCI state(s) as specified herein in the present disclosure, the UE 116 could use/apply the first TCI state(s) for the aperiodic CSI resource set, e.g., the first (or second) aperiodic CSI resource set, that is associated to the entity ID. When the entity ID, e.g., the first (or second) entity ID, is associated to the second TCI state(s) as specified herein in the present disclosure, the UE 116 could use/apply the second TCI state(s) for the aperiodic CSI resource set, e.g., the first (or second) aperiodic CSI resource set, that is associated to the entity ID. When the entity ID, e.g., the first (or second) entity ID, is associated to both of the first and second TCI states as specified herein in the present disclosure, the UE 116 could determine that the third aperiodic CSI resource set for the NCJT CSI measurement/reporting could include one or more resources of the first (or second) aperiodic CSI resource set that is associated to the entity ID, according to one or more of the design examples specified herein in the present disclosure. In the present disclosure, the entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
Yet for another example, a set including two indicators—denoted by first and second indicators—could be provided/configured/indicated in CSI-ResourceConfig that configures or is associated to the first and second aperiodic CSI resource sets as specified herein in the present disclosure, wherein the first indicator could be associated to the first aperiodic CSI resource set and the second indicator could be associated to the second aperiodic CSI resource set (or the first indicator could be provided/indicated in the higher layer parameter that configures or is associated to the first aperiodic CSI resource set configured by/associated to CSI-ResourceConfig, and the second indicator could be provided/indicated in the higher layer parameter that configures or is associated to the second aperiodic CSI resource set configured by/associated to CSI-ResourceConfig). When the first indicator is set to ‘00’ (‘01’, ‘10’, ‘11’ or ‘none’), the UE 116 could use/apply the first TCI state(s) as specified herein in the present disclosure for the first aperiodic CSI resource set, when the first indicator is set to ‘01’ (‘00’, ‘10’, ‘11’ or ‘none’), the UE 116 could use/apply the second TCI state(s) as specified herein in the present disclosure for the first aperiodic CSI resource set, and when the first indicator is set to ‘10’ or ‘11’ (‘00’, ‘01’ or ‘none’)—e.g., indicating that both of the first and second TCI states could be used/applied for at least CSI-RS reception(s), the UE 116 could determine that the third aperiodic CSI resource set for the NCJT CSI measurement/reporting could include one or more resources of the first aperiodic CSI resource set according to one or more of the design examples specified herein in the present disclosure; optionally, when the first indicator explicitly indicates that one or more resources in the first aperiodic CSI resource set could be used/applied for the NCJT CSI measurement/reporting (same as the third aperiodic CSI resource set specified herein in the present disclosure), or explicitly indicates that both of the first and second TCI states could be used/applied for at least CSI-RS reception(s), the UE 116 could determine that the third aperiodic CSI resource set for the NCJT CSI measurement/reporting could include one or more resources of the first aperiodic CSI resource set according to one or more of the design examples specified herein in the present disclosure. When the second indicator is set to ‘00’ (‘01’, ‘10’, ‘11’ or ‘none’), the UE 116 could use/apply the first TCI state(s) as specified herein in the present disclosure for the second aperiodic CSI resource set, when the second indicator is set to ‘01’ (‘00’, ‘10’, ‘11’ or ‘none’), the UE 116 could use/apply the second TCI state(s) as specified herein in the present disclosure for the second aperiodic CSI resource set, and when the second indicator is set to ‘10’ or ‘11’ (‘00’, ‘01’ or ‘none’)
e.g., indicating that both of the first and second TCI states could be used/applied for at least CSI-RS reception(s), the UE 116 could determine that the third aperiodic CSI resource set for the NCJT CSI measurement/reporting could include one or more resources of the second aperiodic CSI resource set according to one or more of the design examples specified herein in the present disclosure; optionally, when the second indicator explicitly indicates that one or more resources in the second aperiodic CSI resource set could be used/applied for the NCJT CSI measurement/reporting (same as the third aperiodic CSI resource set specified herein in the present disclosure), or explicitly indicates that both of the first and second TCI states could be used/applied for at least CSI-RS reception(s), the UE 116 could determine that the third aperiodic CSI resource set for the NCJT CSI measurement/reporting could include one or more resources of the second aperiodic CSI resource set according to one or more of the design examples specified herein in the present disclosure.
Yet for another example, a set including two entity IDs—denoted by first and second entity IDs—could be provided/configured/indicated in CSI-ResourceConfig that configures or is associated to the first and second aperiodic CSI resource sets as specified herein in the present disclosure, wherein the first entity ID could be associated to the first aperiodic CSI resource set and the second entity ID could be associated to the second aperiodic CSI resource set (or the first entity ID could be provided/indicated in the higher layer parameter that configures or is associated to the first aperiodic CSI resource set configured by/associated to CSI-ResourceConfig, and the second entity ID could be provided/indicated in the higher layer parameter that configures or is associated to the second aperiodic CSI resource set configured by/associated to CSI-ResourceConfig). When the first entity ID is associated to the first TCI state(s) as specified herein in the present disclosure, the UE 116 could use/apply the first TCI state(s) for the first aperiodic CSI resource set, when the first entity ID is associated to the second TCI state(s) as specified herein in the present disclosure, the UE 116 could use/apply the second TCI state(s) for the first aperiodic CSI resource set. When the first entity ID is associated to both of the first and second TCI states as specified herein in the present disclosure, the UE 116 could determine that the third aperiodic CSI resource set for the NCJT CSI measurement/reporting could include one or more resources of the first aperiodic CSI resource set according to one or more of the design examples specified herein in the present disclosure. When the second entity ID is associated to the first TCI state(s) as specified herein in the present disclosure, the UE 116 could use/apply the first TCI state(s) for the second aperiodic CSI resource set. When the second entity ID is associated to the second TCI state(s) as specified herein in the present disclosure, the UE 116 could use/apply the second TCI state(s) for the second aperiodic CSI resource set, and when the second entity ID is associated to both of the first and second TCI states as specified herein in the present disclosure, the UE 116 could determine that the third aperiodic CSI resource set for the NCJT CSI measurement/reporting could include one or more resources of the second aperiodic CSI resource set according to one or more of the design examples specified herein in the present disclosure. In the present disclosure, the first (or second) entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.
Yet for another example, a set including two indicators—denoted by first and second indicators—could be provided/configured/indicated in CSI-AssociatedReportConfigInfo of CSI-AperiodicTriggerState that configures or is associated to the first and second aperiodic CSI resource sets as specified herein in the present disclosure, wherein the first indicator could be associated to the first aperiodic CSI resource set and the second indicator could be associated to the second aperiodic CSI resource set (or the first indicator could be provided/indicated in the higher layer parameter that configures or is associated to the first aperiodic CSI resource set configured by/associated to CSI-AssociatedReportConfigInfo, and the second indicator could be provided/indicated in the higher layer parameter that configures or is associated to the second aperiodic CSI resource set configured by/associated to CSI-AssociatedReportConfigInfo). When the first indicator is set to ‘00’ (‘01’, ‘10’, ‘11’ or ‘none’), the UE 116 could use/apply the first TCI state(s) as specified herein in the present disclosure for the first aperiodic CSI resource set, when the first indicator is set to ‘01’ (‘00’, ‘10’, ‘11’ or ‘none’), the UE 116 could use/apply the second TCI state(s) as specified herein in the present disclosure for the first aperiodic CSI resource set. When the first indicator is set to ‘10’ or ‘11’ (‘00’, ‘01’ or ‘none’)—e.g., indicating that both of the first and second TCI states could be used/applied for at least CSI-RS reception(s), the UE 116 could determine that the third aperiodic CSI resource set for the NCJT CSI measurement/reporting could include one or more resources of the first aperiodic CSI resource set according to one or more of the design examples specified herein in the present disclosure; optionally, when the first indicator explicitly indicates that one or more resources in the first aperiodic CSI resource set could be used/applied for the NCJT CSI measurement/reporting (same as the third aperiodic CSI resource set specified herein in the present disclosure), or explicitly indicates that both of the first and second TCI states could be used/applied for at least CSI-RS reception(s), the UE 116 could determine that the third aperiodic CSI resource set for the NCJT CSI measurement/reporting could include one or more resources of the first aperiodic CSI resource set according to one or more of the design examples specified herein in the present disclosure. When the second indicator is set to ‘00’ (‘01’, ‘10’, ‘11’ or ‘none’), the UE 116 could use/apply the first TCI state(s) as specified herein in the present disclosure for the second aperiodic CSI resource set, when the second indicator is set to ‘01’ (‘00’, ‘10’, ‘11’ or ‘none’), the UE 116 could use/apply the second TCI state(s) as specified herein in the present disclosure for the second aperiodic CSI resource set. When the second indicator is set to ‘10’ or ‘11’ (‘00’, ‘01’ or ‘none’)
e.g., indicating that both of the first and second TCI states could be used/applied for at least CSI-RS reception(s), the UE 116 could determine that the third aperiodic CSI resource set for the NCJT CSI measurement/reporting could include one or more resources of the second aperiodic CSI resource set according to one or more of the design examples specified herein in the present disclosure; optionally, when the second indicator explicitly indicates that one or more resources in the second aperiodic CSI resource set could be used/applied for the NCJT CSI measurement/reporting (same as the third aperiodic CSI resource set specified herein in the present disclosure), or explicitly indicates that both of the first and second TCI states could be used/applied for at least CSI-RS reception(s), the UE 116 could determine that the third aperiodic CSI resource set for the NCJT CSI measurement/reporting could include one or more resources of the second aperiodic CSI resource set according to one or more of the design examples specified herein in the present disclosure.
Yet for another example, a set including two entity IDs—denoted by first and second entity IDs—could be provided/configured/indicated in CSI-AssociatedReportConfigInfo of CSI-AperiodicTriggerState that configures or is associated to the first and second aperiodic CSI resource sets as specified herein in the present disclosure, wherein the first entity ID could be associated to the first aperiodic CSI resource set and the second entity ID could be associated to the second aperiodic CSI resource set (or the first entity ID could be provided/indicated in the higher layer parameter that configures or is associated to the first aperiodic CSI resource set configured by/associated to CSI-AssociatedReportConfigInfo, and the second entity ID could be provided/indicated in the higher layer parameter that configures or is associated to the second aperiodic CSI resource set configured by/associated to CSI-AssociatedReportConfigInfo). When the first entity ID is associated to the first TCI state(s) as specified herein in the present disclosure, the UE 116 could use/apply the first TCI state(s) for the first aperiodic CSI resource set. When the first entity ID is associated to the second TCI state(s) as specified herein in the present disclosure, the UE 116 could use/apply the second TCI state(s) for the first aperiodic CSI resource set, and when the first entity ID is associated to both of the first and second TCI states as specified herein in the present disclosure, the UE 116 could determine that the third aperiodic CSI resource set for the NCJT CSI measurement/reporting could include one or more resources of the first aperiodic CSI resource set according to one or more of the design examples specified herein in the present disclosure. When the second entity ID is associated to the first TCI state(s) as specified herein in the present disclosure, the UE 116 could use/apply the first TCI state(s) for the second aperiodic CSI resource set, when the second entity ID is associated to the second TCI state(s) as specified herein in the present disclosure, the UE 116 could use/apply the second TCI state(s) for the second aperiodic CSI resource set. When the second entity ID is associated to both of the first and second TCI states as specified herein in the present disclosure, the UE 116 could determine that the third aperiodic CSI resource set for the NCJT CSI measurement/reporting could include one or more resources of the second aperiodic CSI resource set according to one or more of the design examples specified herein in the present disclosure. In the present disclosure, the first (or second) entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.

For the design examples discussed herein in the present disclosure, the first and/or second aperiodic CSI resource set(s) may or may not be associated/configured with the indicator(s) and/or the entity ID(s) and/or the bitmap(s) as specified herein in the present disclosure (e.g., one or more examples described herein), or equivalently, the indicator(s) and/or the entity ID(s) and/or the bitmap(s) as specified herein in the present disclosure (e.g., according to one or more examples described herein) may or may not be present/absent in the (higher layer) signaling(s)/parameter(s) that configure(s)/trigger(s)/provide(s)/indicate(s) the first and/or second aperiodic CSI resource set(s). Optionally, for the design examples discussed herein in the present disclosure, the indicator(s) and/or the entity ID(s) and/or the bitmap(s) as specified herein in the present disclosure (e.g., one or more examples described herein) that is associated/configured with the first and second aperiodic CSI resource sets, e.g., provided/configured in the (higher layer) signaling(s)/parameter(s) that configure(s)/trigger(s)/provide(s)/indicate(s) the first and second aperiodic CSI resource sets, could be identical/same/common. After the UE 116 has determined the third aperiodic CSI resource set according to the first and/or second aperiodic CSI resource set(s) following one or more of the design examples specified herein in the present disclosure, the UE 116 could apply/use the first and/or second TCI state(s) for the first and/or second aperiodic CSI resource groups in the third aperiodic CSI resource set, according to one or more of the design examples (e.g., according to one or more examples described herein) in the present disclosure.

As specified herein in the present disclosure, when the group based beam reporting is enabled, the UE 116 could use/apply the first TCI state as specified herein in the present disclosure for the first aperiodic CSI resource set, and the second TCI state as specified herein in the present disclosure for the second aperiodic CSI resource set, wherein the first and second aperiodic CSI resource sets are for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the first and second aperiodic CSI resource sets. For this case, when the third aperiodic CSI resource set for the NCJT CSI measurement/reporting as specified herein in the present disclosure corresponds to the first aperiodic CSI resource set according to one or more examples specified herein in the present disclosure:
When the UE 116 uses/applies the first TCI state as specified herein in the present disclosure for the first aperiodic CSI resource group in the third aperiodic CSI resource set, and the second TCI state as specified herein in the present disclosure for the second aperiodic CSI resource group in the third aperiodic CSI resource set, the first aperiodic CSI resource group in the third aperiodic CSI resource set (or equivalently, the first aperiodic CSI resource set here) and the second aperiodic CSI resource set could be used for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the first aperiodic CSI resource group in the third aperiodic CSI resource set (or equivalently, the first aperiodic CSI resource set here) and the second aperiodic CSI resource set.
When the UE 116 uses/applies the first TCI state as specified herein in the present disclosure for the second aperiodic CSI resource group in the third aperiodic CSI resource set, and the second TCI state as specified herein in the present disclosure for the first aperiodic CSI resource group in the third aperiodic CSI resource set, the second aperiodic CSI resource group in the third aperiodic CSI resource set (or equivalently, the first aperiodic CSI resource set here) and the second aperiodic CSI resource set could be used for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the second aperiodic CSI resource group in the third aperiodic CSI resource set (or equivalently, the first aperiodic CSI resource set here) and the second aperiodic CSI resource set.

Alternatively, when the third aperiodic CSI resource set for the NCJT CSI measurement/reporting as specified herein in the present disclosure corresponds to the second aperiodic CSI resource set according to one or more examples specified herein in the present disclosure:
When the UE 116 uses/applies the first TCI state as specified herein in the present disclosure for the first aperiodic CSI resource group in the third aperiodic CSI resource set, and the second TCI state as specified herein in the present disclosure for the second aperiodic CSI resource group in the third aperiodic CSI resource set, the second aperiodic CSI resource group in the third aperiodic CSI resource set (or equivalently, the second aperiodic CSI resource set here) and the first aperiodic CSI resource set could be used for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the second aperiodic CSI resource group in the third aperiodic CSI resource set (or equivalently, the second aperiodic CSI resource set here) and the first aperiodic CSI resource set.
When the UE 116 uses/applies the first TCI state as specified herein in the present disclosure for the second aperiodic CSI resource group in the third aperiodic CSI resource set, and the second TCI state as specified herein in the present disclosure for the first aperiodic CSI resource group in the third aperiodic CSI resource set, the first aperiodic CSI resource group in the third aperiodic CSI resource set (or equivalently, the second aperiodic CSI resource set here) and the first aperiodic CSI resource set could be used for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the first aperiodic CSI resource group in the third aperiodic CSI resource set (or equivalently, the second aperiodic CSI resource set here) and the first aperiodic CSI resource set.

As specified herein in the present disclosure, when the group based beam reporting is enabled, the UE 116 could use/apply the first TCI state as specified herein in the present disclosure for the second aperiodic CSI resource set, and the second TCI state as specified herein in the present disclosure for the first aperiodic CSI resource set, wherein the first and second aperiodic CSI resource sets are for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the first and second aperiodic CSI resource sets. For this case, when the third aperiodic CSI resource set for the NCJT CSI measurement/reporting as specified herein in the present disclosure corresponds to the first aperiodic CSI resource set according to one or more examples specified herein in the present disclosure:
When the UE 116 uses/applies the first TCI state as specified herein in the present disclosure for the first aperiodic CSI resource group in the third aperiodic CSI resource set, and the second TCI state as specified herein in the present disclosure for the second aperiodic CSI resource group in the third aperiodic CSI resource set, the second aperiodic CSI resource group in the third aperiodic CSI resource set (or equivalently, the first aperiodic CSI resource set here) and the second aperiodic CSI resource set could be used for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the second aperiodic CSI resource group in the third aperiodic CSI resource set (or equivalently, the first aperiodic CSI resource set here) and the second aperiodic CSI resource set.
When the UE 116 uses/applies the first TCI state as specified herein in the present disclosure for the second aperiodic CSI resource group in the third aperiodic CSI resource set, and the second TCI state as specified herein in the present disclosure for the first aperiodic CSI resource group in the third aperiodic CSI resource set, the first aperiodic CSI resource group in the third aperiodic CSI resource set (or equivalently, the first aperiodic CSI resource set here) and the second aperiodic CSI resource set could be used for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the first aperiodic CSI resource group in the third aperiodic CSI resource set (or equivalently, the first aperiodic CSI resource set here) and the second aperiodic CSI resource set.

Alternatively, when the third aperiodic CSI resource set for the NCJT CSI measurement/reporting as specified herein in the present disclosure corresponds to the second aperiodic CSI resource set according to those specified herein in the present disclosure:
When the UE 116 uses/applies the first TCI state as specified herein in the present disclosure for the first aperiodic CSI resource group in the third aperiodic CSI resource set, and the second TCI state as specified herein in the present disclosure for the second aperiodic CSI resource group in the third aperiodic CSI resource set, the first aperiodic CSI resource group in the third aperiodic CSI resource set (or equivalently, the second aperiodic CSI resource set here) and the first aperiodic CSI resource set could be used for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the first aperiodic CSI resource group in the third aperiodic CSI resource set (or equivalently, the second aperiodic CSI resource set here) and the first aperiodic CSI resource set.
When the UE 116 uses/applies the first TCI state as specified herein in the present disclosure for the second aperiodic CSI resource group in the third aperiodic CSI resource set, and the second TCI state as specified herein in the present disclosure for the first aperiodic CSI resource group in the third aperiodic CSI resource set, the second aperiodic CSI resource group in the third aperiodic CSI resource set (or equivalently, the second aperiodic CSI resource set here) and the first aperiodic CSI resource set could be used for the group based beam measurement/reporting for the MTRP operation such that the UE 116 could report, in a single CSI reporting instance/CSI report, one or more groups of resource indicators including SSBRIs and/or CRIs (and therefore, the corresponding beam metrics including L1-RSRPs and/or L1-SINRs), wherein the resource indicators reported in each group could be respectively from the second aperiodic CSI resource group in the third aperiodic CSI resource set (or equivalently, the second aperiodic CSI resource set here) and the first aperiodic CSI resource set.

In one example, a UE could be triggered/activated/configured/indicated/provided by the network 130 the fourth aperiodic CSI resource set as specified herein in the present disclosure for the channel and/or interference measurement for at least one of the TRPs (e.g., following one or more examples described herein). For this case, the UE 116 could determine the third aperiodic CSI resource set for the NCJT CSI measurement/reporting according to/based on the fourth aperiodic CSI resource set following one or more of the following.
For example, the UE 116 could use/apply the fourth aperiodic CSI resource set as the third aperiodic CSI resource set. Alternatively, the UE 116 could determine that the third aperiodic CSI resource set could correspond to Kc≥1 resources in the fourth aperiodic CSI resource set. In one example, the value of Kc could be fixed in the system specifications—for instance, the Kc resources could correspond to the first/last 8 resources in the fourth aperiodic CSI resource set. In another example, the UE 116 could be indicated/configured/provided by the network 130, e.g., via higher layer RRC signaling/parameter and/or MAC CE command and/or dynamic DCI based L1 signaling, the value of Kc, and/or their positions/orderings in the fourth aperiodic CSI resource set.
For another example, an indicator could be associated to the fourth aperiodic CSI resource set as specified herein in the present disclosure (e.g., the indicator could be provided in nzp-CSI-RS-ResourceSet or CSI-SSB-ResourceSet that configures or is associated to the corresponding fourth aperiodic CSI resource set). When the indicator is set to ‘00’ (‘01’, ‘10’, ‘11’ or ‘none’), the UE 116 could use/apply the first TCI state(s) as specified herein in the present disclosure for the fourth aperiodic CSI resource set. When the indicator is set to ‘01’ (‘00’, ‘10’, ‘11’ or ‘none’), the UE 116 could use/apply the second TCI state(s) as specified herein in the present disclosure for the fourth aperiodic CSI resource set. When the indicator is set to ‘10’ or ‘11’ (‘00’, ‘01’ or ‘none’)—e.g., indicating that both of the first and second TCI states could be used/applied for at least CSI-RS reception(s), the UE 116 could determine that the third aperiodic CSI resource set for the NCJT CSI measurement/reporting could include one or more resources of the fourth aperiodic CSI resource set, according to one or more of the design examples specified herein in the present disclosure. Optionally, when the indicator explicitly indicates that one or more resources in the fourth aperiodic CSI resource set could be used/applied for the NCJT CSI measurement/reporting (same as the third aperiodic CSI resource set specified herein in the present disclosure), or explicitly indicates that both of the first and second TCI states could be used/applied for at least CSI-RS reception(s), the UE 116 could determine that the third aperiodic CSI resource set for the NCJT CSI measurement/reporting could include one or more resources of the fourth aperiodic CSI resource set according to one or more of the design examples specified herein in the present disclosure.
Yet for another example, an entity ID could be associated to the fourth aperiodic CSI resource set as specified herein in the present disclosure (e.g., the entity ID could be provided in CSI-ResourceConfig or nzp-CSI-RS-ResourceSet or CSI-SSB-ResourceSet or CSI-AssociatedReportConfigInfo of CSI-AperiodicTriggerState that configures or is associated to the corresponding fourth aperiodic CSI resource set). When the entity ID is associated to the first TCI state(s) as specified herein in the present disclosure, the UE 116 could use/apply the first TCI state(s) for the fourth aperiodic CSI resource set. When the entity ID is associated to the second TCI state(s) as specified herein in the present disclosure, the UE 116 could use/apply the second TCI state(s) for the fourth aperiodic CSI resource set. When the entity ID is associated to both of the first and second TCI states as specified herein in the present disclosure, the UE 116 could determine that the third aperiodic CSI resource set for the NCJT CSI measurement/reporting could include one or more resources of the fourth aperiodic CSI resource set, according to one or more of the design examples specified herein in the present disclosure. In the present disclosure, the entity ID could correspond to one or more of: a value (0 or 1) of CORESETPoolIndex, a value (0 or 1) of CORESETGroupIndex, a value (0 or 1) of a one-bit flag indicator, a CORESET ID, a resource/resource set/resource setting ID, a PCI, a PCI index pointing to an entry/PCI in a higher layer configured list of PCIs, a TRP-specific ID, a TRP-specific higher layer signaling index, etc.

For the design example(s) discussed specified herein in the present disclosure, the fourth aperiodic CSI resource set may or may not be associated/configured with the indicator(s) and/or the entity ID(s) and/or the bitmap(s) as specified herein in the present disclosure (e.g., one or more examples described herein), or equivalently, the indicator(s) and/or the entity ID(s) and/or the bitmap(s) as specified herein in the present disclosure (e.g., one or more examples described herein) may or may not be present/absent in the (higher layer) signaling(s)/parameter(s) that configure(s)/trigger(s)/provide(s)/indicate(s) the fourth aperiodic CSI resource set. After the UE 116 has determined the third aperiodic CSI resource set according to the fourth aperiodic CSI resource set following one or more of the design examples specified herein in the present disclosure, the UE 116 could apply/use the first and/or second TCI state(s) for the first and/or second aperiodic CSI resource groups in the third aperiodic CSI resource set, according to one or more of the design examples in the present disclosure.

The UE 116 could be further configured/indicated/provided by the network 130, e.g., via higher layer RRC signaling/parameter and/or MAC CE command and/or dynamic DCI based L1 signaling, which one or more of the design methods/examples specified herein in the present disclosure to use/apply for determining the association(s) between the (indicated) TCI state(s) and the CSI-RS resource(s)/CSI resource set(s)/CSI resource setting(s) for the NCJT CSI measurement/reporting and/or the group based beam measurement/reporting for the MTRP operation and/or the channel and/or interference measurement for at least one of the TRPs as specified herein in the present disclosure.

In one embodiment, for periodic and semi-persistent CSI resource settings, when the UE 116 is configured with groupBasedBeamReporting-r17, the number of CSI resource sets configured is S=2, otherwise the number of CSI resource sets configured is limited to S=1. For aperiodic CSI, and for periodic and semi-persistent CSI resource settings, each trigger state configured using the higher layer parameter CSI-AperiodicTriggerState is associated with one or multiple CSI-ReportConfig where the CSI-ReportConfig configured with groupBasedBeamReporting-r17 is linked to periodic or semi-persistent, setting(s): when one resource setting is configured, the resource setting is given/provided by resourcesForChannelMeasurement for L1-RSRP measurement. In such as case, the number of configured CSI resource sets in the resource setting is S=2. For aperiodic CSI, and for aperiodic CSI resource settings, each trigger state configured using the higher layer parameter CSI-AperiodicTriggerState is associated with one or multiple CSI-ReportConfig where the CSI-ReportConfig configured with groupBasedBeamReporting-r17 is associated with resourcesForChannel and resourcesForChannel2, which correspond to the first and second resource sets, respectively, for L1-RSRP measurement.

In one example, if the UE 116 is configured with the higher layer parameter groupBasedBeamReporting-r17, the UE 116 could report in a single reporting instance/CSI report nrofReportedGroups, if configured, group(s) of two CRIs or SSBRIs selecting one CSI-RS or SSB from each of the two CSI resource sets for the report setting, where CSI-RS and/or SSB resources of each group can be received simultaneously by the UE 116.

In one example, if the UE 116 is configured with the higher layer parameter groupBasedBeamReporting-r17, the UE 116 could report in a single reporting instance/CSI report up to nrofReportedGroups, if configured, e.g., Ng group(s) of two CRIs or SSBRIs selecting one CSI-RS or SSB from each of the two CSI resource sets for the report setting, where CSI-RS and/or SSB resources of each group can be received simultaneously by the UE 116, and 0≤Ng≤nrofReportedGroups or Ng∈{0, 1, . . . , nrofReportedGroups}. The UE 116 could autonomously determine the value(s) of Ng, and report to the network 130 the value(s)/information of Ng, e.g., in part of the CSI/beam report as specified herein in the present disclosure. More specifically, for a two-part uplink control information (UCI) design/report/reporting setting/report structure/report format, the UE 116 could report the value(s)/information of Ng in part 1 of the two-part UCI report. For Ng=0 or Ng=nrofReportedGroups, i.e., when/if the UE 116 determines that Ng=0 or Ng=nrofReportedGroups, the UE 116 may not need to report to the network 130 the value(s)/information of Ng, e.g., in part of the CSI/beam report as specified herein in the present disclosure. That is, when/if 1≤Ng<nrofReportedGroups (or Ng∈{1, . . . , nrofReportedGroups}), or equivalently, when/if the UE 116 determines that 1≤Ng<nrofReportedGroups (or Ng∈{1, . . . nrofReportedGroups}), the UE 116 could report to the network 130 the value(s)/information of Ng, e.g., in part of the CSI/beam report as specified herein in the present disclosure.
For Ng=0, the UE 116 may not report, e.g., in a single reporting instance/CSI report, any resource indicator(s) such as SSBRI(s)/CRI(s) and/or beam metric(s) such as L1-RSRP(s)/L1-SINR(s). The UE 116 could still report, e.g., in the reporting instance/CSI report, the 1-bit resource set indicator, wherein the 1-bit resource set indicator could be set to a fixed value such as 0 or 1. For this case, setting the value of the 1-bit resource set indicator as ‘0’ (or ‘1’) would mean/indicate that there is no resource indicator(s) such as SSBRI(s)/CRI(s) and/or beam metric(s) such as L1-RSRP(s)/L1-SINR(s) reported in the reporting instance/CSI report. Optionally, the UE 116 could indicate to the network 130, e.g., by/via incorporating an indicator in the CSI/beam report, that no resource indicator(s) and/or beam metric(s) as specified herein in the present disclosure is reported in the CSI/beam report—e.g., when/if the 1-bit resource indicator is not reported/present in the CSI/beam report.
For 1≤Ng<nrofReportedGroups (or Ng∈{1, . . . , nrofReportedGroups}), the UE 116 could report in a single reporting instance/CSI report, Ng group(s) of two CRIs or SSBRIs (and therefore, their corresponding beam metrics such as L1-RSRPs and/or L1-SINRs) selecting one CSI-RS or SSB from each of the two CSI resource sets for the report setting, where CSI-RS and/or SSB resources of each group can be received simultaneously by the UE 116. For this case, the UE 116 could determine the CSI report (and therefore, its contents/payloads) following those provided in TABLE 1 and TABLE 2 in the present disclosure.

TABLE 1

| Field | Bitwidth |
|---|---|
| CRI | ┌log₂ Kₛ^{CSI-RS}┐ |
| SSBRI | ┌log₂ Kₛ^{SSB}┐ |
| RSRP | 7 |
| Differential | 4 |
| RSRP | |

With reference to TABLE 1, CRI, SSBRI, SINR and CapabilityIndex is shown. Kₛ^{CSI-RS} is the number of CSI-RS resources in the corresponding resource set, and Kₛ^{SSB} is the configured number of synchronization signal/physical broadcast channel (SS/PBCH) blocks in the corresponding resource set for reporting ‘ssb-Index-RSRP’.

TABLE 2

| | Resource set indicator |
|---|---|
| CSI | CRI or SSBRI #1 of 1st resource group as in TABLE 1, if reported |
| report | CRI or SSBRI #2 of 1st resource group as in TABLE 1, if reported |
| #n | CRI or SSBRI #1 of 2nd resource group as in TABLE 1, if reported |
| | CRI or SSBRI #2 of 2nd resource group as in TABLE 1, if reported |
| | CRI or SSBRI #1 of 3rd resource group as in TABLE 1, if reported |
| | CRI or SSBRI #2 of 3rd resource group as in TABLE 1, if reported |
| | CRI or SSBRI #1 of 4th resource group as in TABLE 1, if reported |
| | CRI or SSBRI #2 of 4th resource group as in TABLE 1, if reported |
| | RSRP of CRI or SSBRI #1 of 1st resource group as in TABLE 1 |
| | Differential RSRP of CRI or SSBRI #2 of 1st resource group as in |
| | TABLE 1 |
| | Differential RSRP of CRI or SSBRI #1 of 2nd resource group as in |
| | TABLE 1, if reported |
| | Differential RSRP of CRI or SSBRI #2 of 2nd resource group as in |
| | TABLE 1, if reported |
| | Differential RSRP of CRI or SSBRI #1 of 3rd resource group as in |
| | TABLE 1, if reported |
| | Differential RSRP of CRI or SSBRI #2 of 3rd resource group as in |
| | TABLE 1, if reported |
| | Differential RSRP of CRI or SSBRI #1 of 4th resource group as in |
| | TABLE 1, if reported |
| | Differential RSRP of CRI or SSBRI #2 of 4th resource group as in |

TABLE 1, if reported

With reference to TABLE 2, mapping order of CSI fields of one report for group-based CRI/RSRP or SSBRI/RSRP reporting is shown.

In one example, if the UE 116 is configured with the higher layer parameter groupBasedBeamReporting-r17, the UE 116 could report in a single reporting instance/CSI report nrofReportedRS, if higher layer configured, different CRI(s) or SSBRI(s)—and their corresponding L1-RSRP(s) or L1-SINR(s)—for each report setting. Optionally, the UE 116 could indicate to the network 130, e.g., via/by sending/incorporating an indicator in part of the CSI/beam report, that the resource indicator(s) such as SSBRI(s)/CRI(s) and the corresponding beam metric(s) such as L1-RSRP(s)/L1-SINR(s) reported in the reporting instance/CSI report is not for the configured group based beam reporting (or equivalently, that the resource indicator(s) and the corresponding beam metric(s) reported in the reporting instance/CSI report are for non-group based beam reporting, e.g., for single-TRP (STRP) operation).

In one example, if the UE 116 is configured with the higher layer parameter groupBasedBeamReporting-r17, the UE 116 could report in a single reporting instance/CSI report two different CRI(s) or SSBRI(s)—and their corresponding L1-RSRP(s) or L1-SINR(s)—for each report setting, where CSI-RS and/or SSB resources can be received simultaneously by the UE 116 either with a single spatial domain receive filter, or with multiple simultaneous spatial domain receive filters. Optionally, the UE 116 could indicate to the network 130, e.g., via/by sending/incorporating an indicator in part of the CSI/beam report, that the resource indicator(s) such as SSBRI(s)/CRI(s) and the corresponding beam metric(s) such as L1-RSRP(s)/L1-SINR(s) reported in the reporting instance/CSI report is not for the configured group based beam reporting specified in Rel-17 (or equivalently, that the resource indicator(s) and the corresponding beam metric(s) reported in the reporting instance/CSI report are for group based beam reporting specified in Rel-15/Rel-16).

A UE could send to the network 130 a capability signaling, e.g., denoted by twoDefaultTCI-States, to indicate to the network 130 that the UE 116 is capable of using/applying two or more (default) joint/DL TCI states—and therefore, the corresponding two or more (default) QCL assumptions—to simultaneously receive one or more channels/signals, or the UE 116 could send to the network 130 a capability signaling, e.g., denoted by oneDefaultTCI-State, to indicate to the network 130 that the UE 116 is capable of using/applying only one (default) joint/DL TCI state—and therefore, the corresponding one (default) QCL assumption—to receive the channel(s)/signal(s). The UE 116 could be configured by the network 130, e.g., via a higher layer RRC signaling/parameter denoted by enableTwoDefaultTCI-States, to use/apply two or more (default) joint/DL TCI states—and therefore, the corresponding two or more (default) QCL assumptions—to simultaneously receive one or more channels/signals; optionally, the UE 116 could be configured by the network 130, e.g., via a higher layer RRC signaling/parameter denoted by enableOneDefaultTCI-State, to use/apply only one (default) joint/DL TCI state—and therefore, the corresponding one (default) QCL assumption—to receive the channel(s)/signal(s).

In one embodiment, as specified herein in the present disclosure, when/if the Rel-17 group based beam reporting is enabled/configured for MTRP operation, a UE could be provided/configured by the network 130, e.g., via/in higher layer RRC signaling(s)/parameter(s)—e.g., via/in CSI-ResourceConfig and/or CSI-AssociatedReportConfigInfo of CSI-AperiodicTrigger—two CSI resource sets (e.g., denoted by a first CSI resource set and a second CSI resource set) each for a TRP. Furthermore, as specified herein in the present disclosure, the UE 116 could be provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures a CSI resource set for a TRP, an (one-bit) indicator to indicate which of the indicated/applied joint/DL TCI states (e.g., the first TCI state(s) and/or the second TCI state(s) as specified herein in the present disclosure) to use for receiving the CSI-RS resource(s) in a CSI resource set configured for a TRP. For instance, when/if the (one-bit) indicator associated/corresponding to a CSI resource set (e.g., the first or the second CSI resource set) is set to ‘0’ (or ‘1’ or ‘first’), the UE 116 could use/apply the first indicated joint/DL TCI state(s) as specified herein in the present disclosure to receive the CSI-RS resource(s) in the CSI resource set; when/if the (one-bit) indicator associated/corresponding to a CSI resource set (e.g., the first or the second CSI resource set) is set to ‘1’ (or ‘0’ or ‘second’), the UE 116 could use/apply the second indicated joint/DL TCI state(s) as specified herein in the present disclosure to receive the CSI-RS resource(s) in the CSI resource set. Optionally, when/if the Rel-17 group based beam reporting is enabled/configured for MTRP operation and the two CSI resource sets (e.g., the first and the second CSI resource sets) are provided/configured/triggered, e.g., via/in higher layer RRC signaling(s)/parameter(s)—e.g., via/in CSI-ResourceConfig and/or CSI-AssociatedReportConfigInfo of CSI-AperiodicTrigger—and/or via/by an aperiodic CSI trigger state, the (one-bit) indicator associated/corresponding to the first CSI resource set could be set to ‘0’ (or ‘1’ or ‘first’) indicating that the first TCI state(s) could be used/applied for receiving the (aperiodic) CSI-RS(s) in the first CSI resource set, and the (one-bit) indicator associated/corresponding to the second CSI resource set could be set to ‘1’ (or ‘0’ or ‘second’) indicating that the second TCI state(s) could be used/applied for receiving the (aperiodic) CSI-RS(s) in the second CSI resource set.

When/if the scheduling offset between the last symbol of the PDCCH carrying the triggering DCI and the first symbol of the aperiodic CSI-RS resource(s) in a CSI resource set (e.g., the first or the second CSI resource set as specified herein in the present disclosure), e.g., a NZP-CSI-RS-ResourceSet configured without higher layer parameter trs-Info, is smaller than the UE 116 reported threshold beamSwitchTiming, when the reported value is one of the values of {14, 28, 48}·2^{max(0,μ}^{_{CSIRS}}⁻³⁾ and enableBeamSwitchTiming is not provided, or is smaller than 48·2^{max(0,μ}^{_{CSIRS}}⁻³⁾ when the UE 116 provides beamSwitchTiming-r16, enableBeamSwitchTiming is provided and the NZP-CSI-RS-ResourceSet is configured with the higher layer parameter repetition set to ‘off’ or configured without the higher layer parameter repetition, or is smaller than the UE 116 reported threshold beamSwitchTiming-r16. When eanbleBeamSwitchTiming is provided and the NZP-CSI-RS-ResourceSet is configured with the higher layer parameter repetition set to ‘on’, the UE 116 could determine which of the indicated joint/DL TCI states (e.g., the first TCI state(s) and/or the second TCI state(s) as specified herein in the present disclosure) to use for receiving the aperiodic CSI-RS resource(s) in the CSI resource set according to one or more of the following.
In one example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, the UE 116 could use/apply the QCL parameter(s) of the RS(s) provided/indicated in the first TCI state(s) to receive the aperiodic CSI-RS resource(s) in the CSI resource set when/if one or more of the following conditions are achieved/satisfied.
   The (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource(s) in the CSI resource set is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the CSI resource set.
   The UE 116 could be indicated/configured/provided by the network 130, e.g., via higher layer RRC signaling(s)/parameter(s) and/or MAC CE command(s) and/or dynamic DCI based L1 signaling(s), or the UE 116 could follow fixed rule(s) provided in system specification(s), to use/apply the first TCI state(s) to receive the aperiodic CSI-RS resource(s) in the CSI resource set.
   The (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the first TCI state(s) could be used/applied to receive the aperiodic CSI-RS resource(s) in the CSI resource set (e.g., by setting the indicator to ‘0’ or ‘1’ or ‘first’ as specified herein in the present disclosure).
   There is no other DL channel(s)/signal(s) with indicated TCI state(s) in the same symbols as the aperiodic CSI-RS resource(s) in the CSI resource set; here, the other DL channel(s)/signal(s) could refer to PDSCH scheduled with offset larger than or equal to a threshold, e.g., timeDurationForQCL, reported by the UE 116 via/in their capability signaling and/or configured by the network 130, periodic CSI-RS, semi-persistent CSI-RS, aperiodic CSI-RS in a NZP-CSI-RS-ResourceSet scheduled with offset larger than or equal to a UE reported threshold, e.g., beamSwitchTiming, when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info. Aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided, aperiodic CSI-RS in a NZP-CSI-RS-ResourceSet configured with the higher layer parameter repetition set to ‘on’ scheduled with offset larger than or equal to a UE reported threshold, e.g., beamSwitchTiming-r16, and enableBeamSwitchTiming is provided.
   There is other DL channel(s)/signal(s) with indicated TCI state(s) in the same symbols as the aperiodic CSI-RS resource(s) in the CSI resource set. Here, the other DL channel(s)/signal(s) could refer to PDSCH(s) scheduled with offset larger than or equal to a threshold, e.g., timeDurationForQCL, reported by the UE 116 via/in their capability signaling and/or configured by the network 130; in this case, the UE 116 could use only the first TCI state(s), e.g., when/if the second indicator or the TCI selection field in DCI format 1_1/1_2 (that schedules the PDSCH(s)) as specified herein in the present disclosure is set to ‘00’. For this case, the first TCI state(s) used to receive the aperiodic CSI-RS resource(s) in the CSI resource set could correspond to the first TCI state(s) used to receive the above PDSCH(s), or both of the first and second TCI states, e.g., when/if the second indicator or the TCI selection field in DCI format 1_1/1_2 (that schedules the PDSCH(s)) as specified herein in the present disclosure is set to ‘10’, to receive the PDSCH(s)—when/if the UE 116 applies/uses both of the first and second TCI states to receive the above PDSCH(s) according to those specified herein in the present disclosure, (1) the first TCI state(s) used to receive the aperiodic CSI-RS resource(s) in the CSI resource set could correspond to the first TCI state(s) used to receive the above PDSCH(s), and/or (2) the (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the first TCI state(s) used to receive the PDSCH(s) could be used/applied to receive the aperiodic CSI-RS resource(s) in the CSI resource set (e.g., by setting the indicator to ‘0’ or ‘1’ or ‘first’ as specified herein in the present disclosure). Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to a UE reported threshold, e.g., beamSwitchTiming, when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}_{CSIRS}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to a UE reported threshold, e.g., beamSwitchTiming-r16, and enableBeamSwitchTiming is provided; in this case, the UE 116 could use only the first TCI state(s) to receive the target periodic/semi-persistent/aperiodic CSI-RS(s); in particular, for the target aperiodic CSI-RS(s), the (one-bit) indicator(s) associated/corresponding to the target aperiodic CSI-RS resource(s) and/or the target CSI resource set NZP-CSI-RS-ResourceSet that provides/indicates the target aperiodic CSI-RS(s) could indicate that the first TCI state(s) could be used/applied to receive the target aperiodic CSI-RS(s) in the target CSI resource set (e.g., by setting the indicator to ‘0’ or ‘1’ or ‘first’ as specified herein in the present disclosure).
   The CSI resource set that provides/indicates/configures the aperiodic CSI-RS resource(s) could correspond to the first CSI resource set as specified herein in the present disclosure—the first and the second CSI resource sets could be configured for the Rel-17 group based beam reporting.
In another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, the UE 116 could use/apply the QCL parameter(s) of the RS(s) provided/indicated in the second TCI state(s) to receive the aperiodic CSI-RS resource(s) in the CSI resource set when/if one or more of the following conditions are achieved/satisfied.
   The (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource(s) in the CSI resource set is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the CSI resource set.
   The UE 116 could be indicated/configured/provided by the network 130, e.g., via higher layer RRC signaling(s)/parameter(s) and/or MAC CE command(s) and/or dynamic DCI based L1 signaling(s), or the UE 116 could follow fixed rule(s) provided in system specification(s), to use/apply the second TCI state(s) to receive the aperiodic CSI-RS resource(s) in the CSI resource set.
   The (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the second TCI state(s) could be used/applied to receive the aperiodic CSI-RS resource(s) in the CSI resource set (e.g., by setting the indicator to ‘1’ or ‘0’ or ‘second’ as specified herein in the present disclosure).
   There is no other DL channel(s)/signal(s) with indicated TCI state(s) in the same symbols as the aperiodic CSI-RS resource(s) in the CSI resource set; here, the other DL channel(s)/signal(s) could refer to PDSCH scheduled with offset larger than or equal to a threshold, e.g., timeDurationForQCL, reported by the UE 116 in/via their capability signaling and/or configured by the network 130, periodic CSI-RS, semi-persistent CSI-RS, aperiodic CSI-RS in a NZP-CSI-RS-ResourceSet scheduled with offset larger than or equal to a UE reported threshold, e.g., beamSwitchTiming, when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info. Aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Aperiodic CSI-RS in a NZP-CSI-RS-ResourceSet configured with the higher layer parameter repetition set to ‘on’ scheduled with offset larger than or equal to a UE reported threshold, e.g., beamSwitchTiming-r16, and enableBeamSwitchTiming is provided.
   There is other DL channel(s)/signal(s) with indicated TCI state(s) in the same symbols as the aperiodic CSI-RS resource(s) in the CSI resource set. Here, the other DL channel(s)/signal(s) could refer to PDSCH(s) scheduled with offset larger than or equal to the threshold timeDurationForQCL; in this case, the UE 116 could use only the second TCI state(s), e.g., when/if the second indicator or the TCI selection field in DCI format 1_1/1_2 (that schedules the PDSCH(s)) as specified herein in the present disclosure is set to ‘01’—for this case, the second TCI state(s) used to receive the aperiodic CSI-RS resource(s) in the CSI resource set could correspond to the second TCI state(s) used to receive the above PDSCH(s), or both of the first and second TCI states, e.g., when/if the second indicator or the TCI selection field in DCI format 1_1/1_2 (that schedules the PDSCH(s)) as specified herein in the present disclosure is set to ‘10’, to receive the PDSCH(s). When/if the UE 116 applies/uses both of the first and second TCI states to receive the above PDSCH(s) according to those specified herein in the present disclosure, (1) the second TCI state(s) used to receive the aperiodic CSI-RS resource(s) in the CSI resource set could correspond to the second TCI state(s) used to receive the above PDSCH(s), and/or (2) the (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the second TCI state(s) used to receive the PDSCH(s) could be used/applied to receive the aperiodic CSI-RS resource(s) in the CSI resource set (e.g., by setting the indicator to ‘1’ or ‘0’ or ‘second’ as specified herein in the present disclosure). Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to a UE reported threshold, e.g., beamSwitchTiming, when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided, target aperiodic CSI-RS(s) in a target NZP-CSI-RS-ResourceSet configured with the higher layer parameter repetition set to ‘on’ scheduled with offset larger than or equal to a UE reported threshold, e.g., beamSwitchTiming-r16, and enableBeamSwitchTiming is provided; in this case, the UE 116 could use only the second TCI state(s) to receive the target periodic/semi-persistent/aperiodic CSI-RS(s); in particular, for the target aperiodic CSI-RS(s), the (one-bit) indicator(s) associated/corresponding to the target aperiodic CSI-RS resource(s) and/or the target CSI resource set NZP-CSI-RS-ResourceSet that provides/indicates the target aperiodic CSI-RS(s) could indicate that the second TCI state(s) could be used/applied to receive the target aperiodic CSI-RS(s) in the target CSI resource set (e.g., by setting the indicator to ‘1’ or ‘0’ or ‘second’ as specified herein in the present disclosure).
   The CSI resource set that provides/indicates/configures the aperiodic CSI-RS resource(s) could correspond to the second CSI resource set as specified herein in the present disclosure—the first and the second CSI resource sets could be configured for the Rel-17 group based beam reporting.
In yet another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, and/or when/if one or more of the conditions specified herein in the present disclosure are achieved/satisfied, the UE 116 could follow the (one-bit) indicator—for or associated/corresponding to the CSI resource set—provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, to determine/identify which of the indicated TCI states (e.g., the first or the second TCI state(s)) to use/apply for receiving the aperiodic CSI-RS(s). For instance, when/if the (one-bit) indicator associated/corresponding to the CSI resource set is set to ‘0’ (or ‘1’ or ‘first’), the LE 116 could use/apply the first indicated joint/DL TCI state(s) as specified herein in the present disclosure to receive the aperiodic CSI-RS resource(s) in the CSI resource set; when/if the (one-bit) indicator associated/corresponding to a CSI resource set is set to ‘1’ (or ‘0’ or ‘second’), the UE 116 could use/apply the second indicated joint/DL TCI state(s) as specified herein in the present disclosure to receive the aperiodic CSI-RS resource(s) in the CSI resource set.
In yet another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, and/or when/if there is other DL channel(s)/signal(s) with indicated TCI state(s) in the same symbols as the aperiodic CSI-RS resource(s) in the CSI resource set, and/or when/if one or more of the conditions specified herein in the present disclosure are achieved/satisfied, the UE 116 could apply the QCL assumption of the other DL channel(s)/signal(s) also when receiving the aperiodic CSI-RS(s) in the CSI resource set. Here, the other DL channel(s)/signal(s) could refer to PDSCH(s) scheduled with offset larger than or equal to a threshold, e.g., timeDurationForQCL, reported by the UE 116 via/in their capability signaling and/or configured by the network 130; in this case, e.g., when/if the second indicator or the TCI selection field in DCI format 1_1/1_2 that schedules the PDSCH(s) as specified herein in the present disclosure is set to ‘00’, the UE 116 could use/apply the QCL parameter(s) of the RS(s) provided/indicated in the first TCI state(s) to receive the aperiodic CSI-RS(s) in the CSI resource set, when/if the second indicator or the TCI selection field in DCI format 1_1/1_2 that schedules the PDSCH(s) as specified herein in the present disclosure is set to ‘01’, the UE 116 could use/apply the QCL parameter(s) of the RS(s) provided/indicated in the second TCI state(s) to receive the aperiodic CSI-RS(s) in the CSI resource set, and/or when/if the second indicator or the TCI selection field in DCI format 1_1/1_2 that schedules the PDSCH(s) as specified herein in the present disclosure is set to ‘10’, the UE 116 could use/apply the QCL parameter(s) of the RS(s) provided/indicated in the first (or the second) TCI state(s) to receive the aperiodic CSI-RS(s) in the CSI resource set. Optionally, when/if the second indicator or the TCI selection field in DCI format 1_1/1_2 that schedules the PDSCH(s) as specified herein in the present disclosure is set to ‘10’ (or ‘11’) indicating/providing that both of the first TCI state(s) and the second TCI state(s) could be used/applied for receiving the above PDSCH(s), and/or when/if the (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, indicating the first TCI state(s) (e.g., by setting the indicator to ‘0’ or ‘1’ or ‘first’ as specified herein in the present disclosure), the UE 116 could use/apply the first TCI state(s) used to receive the PDSCH(s) to receive the aperiodic CSI-RS resource(s) in the CSI resource set, and/or when/if the (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, indicating the second TCI state(s) (e.g., by setting the indicator to ‘1’ or ‘0’ or ‘second’ as specified herein in the present disclosure), the UE 116 could use/apply the second TCI state(s) used to receive the PDSCH(s) to receive the aperiodic CSI-RS resource(s) in the CSI resource set. Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to a UE reported threshold, beamSwitchTiming, when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to a UE reported threshold, beamSwitchTiming-r16, and enableBeamSwitchTiming is provided; in particular, when/if the (one-bit) indicator(s) associated/corresponding to the target aperiodic CSI-RS resource(s) and/or the target CSI resource set NZP-CSI-RS-ResourceSet that provides/configures/indicates the target aperiodic CSI-RS(s) is set to ‘0’ (or ‘1’ or ‘first’), the UE 116 could use/apply the first indicated joint/DL TCI state(s) as specified herein in the present disclosure to receive the aperiodic CSI-RS(s) in the CSI resource set; when/if the (one-bit) indicator(s) associated/corresponding to target aperiodic CSI-RS resource(s) and/or the target CSI resource set NZP-CSI-RS-ResourceSet that provides/indicates/configures the target aperiodic CSI-RS(s) is set to ‘1’ (or ‘0’ or ‘second’), the UE 116 could use/apply the second indicated joint/DL TCI state(s) as specified herein in the present disclosure to receive the aperiodic CSI-RS(s) in the CSI resource set.

In one embodiment, as specified herein in the present disclosure, the UE 116 could be provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures a CSI resource set for a TRP, one or more (one-bit) indicators each associated/corresponding to a (aperiodic) CSI-RS in a CSI resource set for a TRP and indicating which of the indicated/applied joint/DL TCI states (e.g., the first TCI state(s) and/or the second TCI state(s) as specified herein in the present disclosure) to use for receiving the (aperiodic) CSI-RS in the CSI resource set—i.e., a (aperiodic) CSI-RS in a CSI resource set is associated/corresponding to a (one-bit) indicator provided/indicated/configured therein. For instance, when/if the (one-bit) indicator associated/corresponding to a (aperiodic) CSI-RS resource in a CSI resource set (e.g., in the first or the second CSI resource set as specified herein in the present disclosure) is set to ‘0’ (or ‘1’ or ‘first’), the UE 116 could use/apply the first indicated joint/DL TCI state(s) as specified herein in the present disclosure to receive the (aperiodic) CSI-RS resource in the CSI resource set; when/if the (one-bit) indicator associated/corresponding to a (aperiodic) CSI-RS resource in a CSI resource set (e.g., the first or the second CSI resource set as specified herein in the present disclosure) is set to ‘1’ (or ‘0’ or ‘second’), the UE 116 could use/apply the second indicated joint/DL TCI state(s) as specified herein in the present disclosure to receive the (aperiodic) CSI-RS resource in the CSI resource set. Optionally, when/if the Rel-17 group based beam reporting is enabled/configured for MTRP operation and the two CSI resource sets (e.g., the first and the second CSI resource sets) are provided/configured/triggered, e.g., via/in higher layer RRC signaling(s)/parameter(s)—e.g., via/in CSI-ResourceConfig and/or CSI-AssociatedReportConfigInfo of CSI-AperiodicTrigger—and/or via/by an aperiodic CSI trigger state, the (one-bit) indicator associated/corresponding to a (aperiodic) CSI-RS resource in the first CSI resource set could be set to ‘0’ (or ‘1’ or ‘first’) indicating that the first TCI state(s) could be used/applied for receiving the (aperiodic) CSI-RS, and the (one-bit) indicator associated/corresponding to a (aperiodic) CSI-RS resource in the second CSI resource set could be set to ‘1’ (or ‘0’ or ‘second’) indicating that the second TCI state(s) could be used/applied for receiving the (aperiodic) CSI-RS. Alternatively, when/if the Rel-17 NCJT CSI measurement/reporting is enabled/configured and the two CSI resource groups (e.g., the first and the second CSI resource groups) are provided/indicated/configured in a CSI resource set provided/configured/triggered, e.g., via/in higher layer RRC signaling(s)/parameter(s)—e.g., via/in CSI-ResourceConfig and/or CSI-AssociatedReportConfigInfo of CSI-AperiodicTrigger—and/or via/by an aperiodic CSI trigger state, the (one-bit) indicator associated/corresponding to a (aperiodic) CSI-RS resource in the first CSI resource group could be set to ‘0’ (or ‘1’ or ‘first’) indicating that the first TCI state(s) could be used/applied for receiving the (aperiodic) CSI-RS, and the (one-bit) indicator associated/corresponding to a (aperiodic) CSI-RS resource in the second CSI resource group could be set to ‘1’ (or ‘0’ or ‘second’) indicating that the second TCI state(s) could be used/applied for receiving the (aperiodic) CSI-RS. In addition, when/if the Rel-17 NCJT CSI measurement/reporting is enabled/configured and the two CSI resource groups (e.g., the first and the second CSI resource groups) are provided/indicated/configured in a CSI resource set provided/configured/triggered, e.g., via/in higher layer RRC signaling(s)/parameter(s)—e.g., via/in CSI-ResourceConfig and/or CSI-AssociatedReportConfigInfo of CSI-AperiodicTrigger—and/or via/by an aperiodic CSI trigger state, the (one-bit) indicator associated/corresponding to a (aperiodic) CSI-RS resource corresponding to the first CSI-RS resource in a resource pair as specified herein in the present disclosure could be set to ‘0’ (or ‘1’ or ‘first’) indicating that the first TCI state(s) could be used/applied for receiving the (aperiodic) CSI-RS, and the (one-bit) indicator associated/corresponding to a (aperiodic) CSI-RS resource corresponding to the second CSI-RS resource in a resource pair as specified herein in the present disclosure could be set to ‘1’ (or ‘0’ or ‘second’) indicating that the second TCI state(s) could be used/applied for receiving the (aperiodic) CSI-RS, wherein the first and the second CSI-RS resources in a resource pair could be respectively from the first and the second CSI resource groups in a CSI resource set configured/enabled for the NCJT CSI.

When/if the scheduling offset between the last symbol of the PDCCH carrying the triggering DCI and the first symbol of an aperiodic CSI-RS resource in a CSI resource set (e.g., the first or the second CSI resource set as specified herein in the present disclosure), e.g., a NZP-CSI-RS-ResourceSet configured without higher layer parameter trs-Info, is smaller than the UE 116 reported threshold beamSwitchTiming, when the reported value is one of the values of {14, 28, 48}2^{max(0,μ}^{_{CSIRS}}⁻³⁾ and enableBeamSwitchTiming is not provided, or is smaller than 48·2^{max(0,μ}^{_{CSIRS}}⁻³⁾ when the UE 116 provides beamSwitchTiming-r16, enableBeamSwitchTiming is provided and the NZP-CSI-RS-ResourceSet is configured with the higher layer parameter repetition set to ‘off’ or configured without the higher layer parameter repetition, or is smaller than the UE 116 reported threshold beamSwitchTiming-r16, when eanbleBeamSwitchTiming is provided and the NZP-CSI-RS-ResourceSet is configured with the higher layer parameter repetition set to ‘on’, the UE 116 could determine which of the indicated joint/DL TCI states (e.g., the first TCI state(s) and/or the second TCI state(s) as specified herein in the present disclosure) to use for receiving the aperiodic CSI-RS resource in the CSI resource set according to one or more of the following.
In one example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, the UE 116 could use/apply the QCL parameter(s) of the RS(s) provided/indicated in the first TCI state(s) to receive the aperiodic CSI-RS resource in the CSI resource set when/if one or more of the following conditions are achieved/satisfied.
   The (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource in the CSI resource set is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the (aperiodic) CSI-RS resource.
   The UE 116 could be indicated/configured/provided by the network 130, e.g., via higher layer RRC signaling(s)/parameter(s) and/or MAC CE command(s) and/or dynamic DCI based L1 signaling(s), or the UE 116 could follow fixed rule(s) provided in system specification(s), to use/apply the first TCI state(s) to receive the aperiodic CSI-RS resource.
   The (one-bit) indicator provided/configured/indicated by the network 130 for the (aperiodic) CSI-RS resource, e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the first TCI state(s) could be used/applied to receive the aperiodic CSI-RS resource (e.g., by setting the indicator to ‘0’ or ‘1’ or ‘first’ as specified herein in the present disclosure).
   There is no other DL channel(s)/signal(s) with indicated TCI state(s) in the same symbols as the aperiodic CSI-RS resource in the CSI resource set; here, the other DL channel(s)/signal(s) could refer to PDSCH scheduled with offset larger than or equal to the threshold timeDurationForQCL, periodic CSI-RS, semi-persistent CSI-RS, aperiodic CSI-RS in a NZP-CSI-RS-ResourceSet scheduled with offset larger than or equal to the UE 116 reported threshold beamSwitchTiming when the reported value is one of the values {14, 28, 48}2^{max(0,μ}^{_{CSIRS}}⁻³⁾ and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Aperiodic CSI-RS in a NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided.
   There is other DL channel(s)/signal(s) with indicated TCI state(s) in the same symbols as the aperiodic CSI-RS resource in the CSI resource set. Here, the other DL channel(s)/signal(s) could refer to PDSCH(s) scheduled with offset larger than or equal to the threshold timeDurationForQCL; in this case, the UE 116 could use only the first TCI state(s), e.g., when/if the second indicator or the TCI selection field in DCI format 1_1/1_2 (that schedules the PDSCH(s)) as specified herein in the present disclosure is set to ‘00’, or both of the first and second TCI states, e.g., when/if the second indicator or the TCI selection field in DCI format 1_1/1_2 (that schedules the PDSCH(s)) as specified herein in the present disclosure is set to ‘10’, to receive the PDSCH(s). Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided; in this case, the UE 116 could use only the first TCI state(s) to receive the target periodic/semi-persistent/aperiodic CSI-RS(s); in particular, the (one-bit) indicator(s) associated/corresponding to the target aperiodic CSI-RS resource(s) and/or the target CSI resource set NZP-CSI-RS-ResourceSet that provides/indicates the target aperiodic CSI-RS(s) could indicate that the first TCI state(s) could be used/applied to receive the target aperiodic CSI-RS(s) in the target CSI resource set (e.g., by setting the indicator to ‘0’ or ‘1’ or ‘first’ as specified herein in the present disclosure).
   The aperiodic CSI-RS resource could be provided/indicated/configured in/by the first CSI resource set as specified herein in the present disclosure—the first and the second CSI resource sets could be configured for the Rel-17 group based beam reporting.
   The aperiodic CSI-RS resource could be provided/indicated/configured in/by the first CSI resource group in a CSI resource set as specified herein in the present disclosure—the first and the second CSI resource groups could be configured in a CSI resource set for the Rel-17 NCJT CSI.
   The aperiodic CSI-RS resource could correspond to the first (aperiodic) CSI-RS resource in a pair of two (aperiodic) CSI-RS resources as specified herein in the present disclosure—one or more pairs of (aperiodic) CSI-RS resources with each pair comprising the first and the second (aperiodic) CSI-RS resources could be configured/provided/indicated for the Rel-17 NCJT CSI.
In another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, the UE 116 could use/apply the QCL parameter(s) of the RS(s) provided/indicated in the second TCI state(s) to receive the aperiodic CSI-RS resource in the CSI resource set when/if one or more of the following conditions are achieved/satisfied.
   The (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource in the CSI resource set is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the (aperiodic) CSI-RS resource.
   The UE 116 could be indicated/configured/provided by the network 130, e.g., via higher layer RRC signaling(s)/parameter(s) and/or MAC CE command(s) and/or dynamic DCI based L1 signaling(s), or the UE 116 could follow fixed rule(s) provided in system specification(s), to use/apply the second TCI state(s) to receive the aperiodic CSI-RS resource.
   The (one-bit) indicator provided/configured/indicated by the network 130 for the (aperiodic) CSI-RS resource, e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the second TCI state(s) could be used/applied to receive the aperiodic CSI-RS resource (e.g., by setting the indicator to ‘1’ or ‘0’ or ‘second’ as specified herein in the present disclosure).
   There is no other DL channel(s)/signal(s) with indicated TCI state(s) in the same symbols as the aperiodic CSI-RS resource in the CSI resource set; here, the other DL channel(s)/signal(s) could refer to PDSCH scheduled with offset larger than or equal to the threshold timeDurationForQCL, periodic CSI-RS, semi-persistent CSI-RS, aperiodic CSI-RS in a NZP-CSI-RS-ResourceSet scheduled with offset larger than or equal to the UE 116 reported threshold beamSwitchTiming when the reported value is one of the values {14, 28, 48}2^{max(0,μ}^{_{CSIRS}}⁻³⁾ and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided, aperiodic CSI-RS in a NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided.
   There is other DL channel(s)/signal(s) with indicated TCI state(s) in the same symbols as the aperiodic CSI-RS resource in the CSI resource set. Here, the other DL channel(s)/signal(s) could refer to PDSCH(s) scheduled with offset larger than or equal to the threshold timeDurationForQCL; in this case, the UE 116 could use only the second TCI state(s), e.g., when/if the second indicator or the TCI selection field in DCI format 1_1/1_2 (that schedules the PDSCH(s)) as specified herein in the present disclosure is set to ‘01’, or both of the first and second TCI states, e.g., when/if the second indicator or the TCI selection field in DCI format 1_1/1_2 (that schedules the PDSCH(s)) as specified herein in the present disclosure is set to ‘10’, to receive the PDSCH(s). Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided, target aperiodic CSI-RS(s) in a target NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided; in this case, the UE 116 could use only the second TCI state(s) to receive the target periodic/semi-persistent/aperiodic CSI-RS(s); in particular, the (one-bit) indicator(s) associated/corresponding to the target aperiodic CSI-RS resource(s) and/or the target CSI resource set NZP-CSI-RS-ResourceSet that provides/indicates the target aperiodic CSI-RS(s) could indicate that the second TCI state(s) could be used/applied to receive the target aperiodic CSI-RS(s) in the target CSI resource set (e.g., by setting the indicator to ‘1’ or ‘0’ or ‘second’ as specified herein in the present disclosure).
   The aperiodic CSI-RS resource could be provided/indicated/configured in/by the second CSI resource set as specified herein in the present disclosure—the first and the second CSI resource sets could be configured for the Rel-17 group based beam reporting.
   The aperiodic CSI-RS resource could be provided/indicated/configured in/by the second CSI resource group in a CSI resource set as specified herein in the present disclosure—the first and the second CSI resource groups could be configured in a CSI resource set for the Rel-17 NCJT CSI.
   The aperiodic CSI-RS resource could correspond to the second (aperiodic) CSI-RS resource in a pair of two (aperiodic) CSI-RS resources as specified herein in the present disclosure—one or more pairs of (aperiodic) CSI-RS resources with each pair comprising the first and the second (aperiodic) CSI-RS resources could be configured/provided/indicated for the Rel-17 NCJT CSI.
In yet another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, and/or when/if one or more of the conditions specified herein in the present disclosure are achieved/satisfied, the UE 116 could follow the (one-bit) indicator—for or associated/corresponding to the aperiodic CSI-RS resource—provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, to determine/identify which of the indicated TCI states (e.g., the first or the second TCI state(s)) to use/apply for receiving the aperiodic CSI-RS. For instance, when/if the (one-bit) indicator associated/corresponding to the aperiodic CSI resource is set to ‘0’ (or ‘1’ or ‘first’), the UE 116 could use/apply the first indicated joint/DL TCI state(s) as specified herein in the present disclosure to receive the aperiodic CSI-RS resource; when/if the (one-bit) indicator associated/corresponding to the aperiodic CSI-RS resource is set to ‘1’ (or ‘0’ or ‘second’), the UE 116 could use/apply the second indicated joint/DL TCI state(s) as specified herein in the present disclosure to receive the aperiodic CSI-RS resource.
In yet another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, and/or when/if there is other DL channel(s)/signal(s) with indicated TCI state(s) in the same symbols as the aperiodic CSI-RS resource in the CSI resource set, and/or when/if one or more of the conditions specified herein in the present disclosure are achieved/satisfied, the UE 116 could apply the QCL assumption of the other DL channel(s)/signal(s) also when receiving the aperiodic CSI-RS in the CSI resource set. Here, the other DL channel(s)/signal(s) could refer to PDSCH(s) scheduled with offset larger than or equal to the threshold timeDurationForQCL; in this case, e.g., when/if the second indicator or the TCI selection field in DCI format 1_1/1_2 that schedules the PDSCH(s) as specified herein in the present disclosure is set to ‘00’, the UE 116 could use/apply the QCL parameter(s) of the RS(s) provided/indicated in the first TCI state(s) to receive the aperiodic CSI-RS, when/if the second indicator or the TCI selection field in DCI format 1_1/1_2 that schedules the PDSCH(s) as specified herein in the present disclosure is set to ‘01’, the UE 116 could use/apply the QCL parameter(s) of the RS(s) provided/indicated in the second TCI state(s) to receive the aperiodic CSI-RS, and/or when/if the second indicator or the TCI selection field in DCI format 1_1/1_2 that schedules the PDSCH(s) as specified herein in the present disclosure is set to ‘10’, the UE 116 could use/apply the QCL parameter(s) of the RS(s) provided/indicated in the first (or the second) TCI state(s) to receive the aperiodic CSI-RS. Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided; in particular, when/if the (one-bit) indicator(s) associated/corresponding to the target aperiodic CSI-RS resource(s) and/or the target CSI resource set NZP-CSI-RS-ResourceSet that provides/configures/indicates the target aperiodic CSI-RS(s) is set to ‘0’ (or ‘1’ or ‘first’), the UE 116 could use/apply the first indicated joint/DL TCI state(s) as specified herein in the present disclosure to receive the aperiodic CSI-RS; when/if the (one-bit) indicator(s) associated/corresponding to the target aperiodic CSI-RS resource(s) and/or the target CSI resource set NZP-CSI-RS-ResourceSet that provides/indicates/configures the target aperiodic CSI-RS(s) is set to ‘1’ (or ‘0’ or ‘second’), the UE 116 could use/apply the second indicated joint/DL TCI state(s) as specified herein in the present disclosure to receive the aperiodic CSI-RS.

In one embodiment, as specified herein in the present disclosure, the UE 116 could be provided/indicated/configured by the network 130 two CSI resource groups—denoted by a/the first CSI resource group and a/the second CSI resource group—in a CSI resource set for the NCJT CSI measurement/reporting, wherein the CSI resource set could be provided/configured/triggered, e.g., via/in higher layer RRC signaling(s)/parameter(s)—e.g., via/in CSI-ResourceConfig and/or CSI-AssociatedReportConfigInfo of CSI-AperiodicTrigger—and/or via/by an aperiodic CSI trigger state. In this case, for a (aperiodic) CSI-RS from/in the first or the second CSI resource group as specified herein in the present disclosure, e.g., when/if the (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set providing/indicating the (aperiodic) CSI-RS resource, for the (aperiodic) CSI-RS resource, the UE 116 could use/apply the first TCI state(s) or the QCL parameter(s) of the RS(s) provided/indicated in the first TCI state(s) to receive the aperiodic CSI-RS when/if the aperiodic CSI-RS resource is in/from the first CSI resource group, and the UE 116 could use/apply the second TCI state(s) or the QCL parameter(s) of the RS(s) provided/indicated in the second TCI state(s) to receive the aperiodic CSI-RS when/if the aperiodic CSI-RS resource is in/from the second CSI resource group. That is, the first TCI state(s) could be associated/mapped to the first CSI resource group (and therefore, the CSI-RS resource(s) provided/indicated/configured therein), and the second TCI state(s) could be associated/mapped to the second CSI resource group (and therefore, the CSI-RS resource(s) provided/indicated/configured therein).

When/if the scheduling offset between the last symbol of the PDCCH carrying the triggering DCI and the first symbol of the aperiodic CSI-RS resource(s) in a CSI resource group (e.g., the first or the second CSI resource group in a CSI resource set as specified herein in the present disclosure) of a CSI resource set, e.g., a NZP-CSI-RS-ResourceSet configured without higher layer parameter trs-Info, is smaller than the UE 116 reported threshold beamSwitchTiming, when the reported value is one of the values of {14, 28, 48}·2^{max(0,μ}^{_{CSIRS}}⁻³⁾ and enableBeamSwitchTiming is not provided, or is smaller than 48·2^{max(0,μ}^{_{CSIRS}}⁻³⁾ when the UE 116 provides beamSwitchTiming-r16, enableBeamSwitchTiming is provided and the NZP-CSI-RS-ResourceSet is configured with the higher layer parameter repetition set to ‘off’ or configured without the higher layer parameter repetition, or is smaller than the UE 116 reported threshold beamSwitchTiming-r16, when eanbleBeamSwitchTiming is provided and the NZP-CSI-RS-ResourceSet is configured with the higher layer parameter repetition set to ‘on’, the UE 116 could determine which of the indicated joint/DL TCI states (e.g., the first TCI state(s) and/or the second TCI state(s) as specified herein in the present disclosure) to use for receiving the aperiodic CSI-RS resource(s) in the CSI resource group (of the CSI resource set) according to one or more of the following.
In one example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, the UE 116 could use/apply the QCL parameter(s) of the RS(s) provided/indicated in the first TCI state(s) to receive the aperiodic CSI-RS resource(s) in the CSI resource group (of the CSI resource set) when/if one or more of the following conditions are achieved/satisfied.
   For an aperiodic CSI-RS resource in the CSI resource group (of the CSI resource set), the (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the (aperiodic) CSI-RS resource.
   The (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource(s) in the CSI resource set is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the CSI resource set.
   The UE 116 could be indicated/configured/provided by the network 130, e.g., via higher layer RRC signaling(s)/parameter(s) and/or MAC CE command(s) and/or dynamic DCI based L1 signaling(s), or the UE 116 could follow fixed rule(s) provided in system specification(s), to use/apply the first TCI state(s) to receive the aperiodic CSI-RS resource(s) in the CSI resource group (of the CSI resource set).
   The (one-bit) indicator(s) provided/configured/indicated by the network 130 for the (aperiodic) CSI-RS resource(s), e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the first TCI state(s) could be used/applied to receive the aperiodic CSI-RS resource(s) in the CSI resource group of the CSI resource set (e.g., by setting the indicator to ‘0’ or ‘1’ or ‘first’ as specified herein in the present disclosure).
   The (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, that comprises/provides the CSI resource group could indicate that the first TCI state(s) could be used/applied to receive the aperiodic CSI-RS resource(s) in the CSI resource group of the CSI resource set (e.g., by setting the indicator to ‘0’ or ‘1’ or ‘first’ as specified herein in the present disclosure).
   There is no other DL channel(s)/signal(s) with indicated TCI state(s) in the same symbols as the aperiodic CSI-RS resource(s) in the CSI resource group (of the CSI resource set); here, the other DL channel(s)/signal(s) could refer to PDSCH scheduled with offset larger than or equal to the threshold timeDurationForQCL, periodic CSI-RS, semi-persistent CSI-RS, aperiodic CSI-RS in a NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided, aperiodic CSI-RS in a NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided.
   There are other DL channel(s)/signal(s) with indicated TCI state(s) in the same symbols as the aperiodic CSI-RS resource(s) in the CSI resource group (of the CSI resource set). Here, the other DL channel(s)/signal(s) could refer to PDSCH(s) scheduled with offset larger than or equal to the threshold timeDurationForQCL; in this case, the UE 116 could use only the first TCI state(s), e.g., when/if the second indicator or the TCI selection field in DCI format 1_1/1_2 (that schedules the PDSCH(s)) as specified herein in the present disclosure is set to ‘00’, or both of the first and second TCI states, e.g., when/if the second indicator or the TCI selection field in DCI format 1_1/1_2 (that schedules the PDSCH(s)) as specified herein in the present disclosure is set to ‘10’, to receive the PDSCH(s). Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided; in this case, the UE 116 could use only the first TCI state(s) to receive the target periodic/semi-persistent/aperiodic CSI-RS(s); in particular, the (one-bit) indicator(s) associated/corresponding to the target aperiodic CSI-RS resource(s) and/or the target CSI resource set NZP-CSI-RS-ResourceSet that provides/indicates the target aperiodic CSI-RS(s) could indicate that the first TCI state(s) could be used/applied to receive the target aperiodic CSI-RS(s) in the target CSI resource set (e.g., by setting the indicator to ‘0’ or ‘1’ or ‘first’ as specified herein in the present disclosure).
   The CSI resource set that provides/indicates/configures/comprises the CSI resource group (and therefore, the aperiodic CSI-RS resource(s)) could correspond to the first CSI resource set as specified herein in the present disclosure—the first and the second CSI resource sets could be configured for the Rel-17 group based beam reporting.
   the CSI resource group that provides/indicates/configures/comprises the (aperiodic) CSI-RS resource(s) could correspond to the first CSI resource group as specified herein in the present disclosure—the first and the second CSI resource groups could be configured in a CSI resource set for the Rel-17 NCJT CSI.
   The aperiodic CSI-RS resource(s) could correspond to the first (aperiodic) CSI-RS resource(s) in a pair of two (aperiodic) CSI-RS resources as specified herein in the present disclosure—one or more pairs of (aperiodic) CSI-RS resources with each pair comprising the first and the second (aperiodic) CSI-RS resources could be configured/provided/indicated for the Rel-17 NCJT CSI.
In another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, the UE 116 could use/apply the QCL parameter(s) of the RS(s) provided/indicated in the second TCI state(s) to receive the aperiodic CSI-RS resource(s) in the CSI resource group (of the CSI resource set) when/if one or more of the following conditions are achieved/satisfied.
   For an aperiodic CSI-RS resource in the CSI resource group (of the CSI resource set), the (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the (aperiodic) CSI-RS resource.
   The (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource(s) in the CSI resource set is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the CSI resource set.
   The UE 116 could be indicated/configured/provided by the network 130, e.g., via higher layer RRC signaling(s)/parameter(s) and/or MAC CE command(s) and/or dynamic DCI based L1 signaling(s), or the UE 116 could follow fixed rule(s) provided in system specification(s), to use/apply the second TCI state(s) to receive the aperiodic CSI-RS resource(s) in the CSI resource group (of the CSI resource set).
   The (one-bit) indicator(s) provided/configured/indicated by the network 130 for the (aperiodic) CSI-RS resource(s), e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the second TCI state(s) could be used/applied to receive the aperiodic CSI-RS resource(s) in the CSI resource group of the CSI resource set (e.g., by setting the indicator to ‘1’ or ‘0’ or ‘second’ as specified herein in the present disclosure).
   The (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, that comprises/provides the CSI resource group could indicate that the second TCI state(s) could be used/applied to receive the aperiodic CSI-RS resource(s) in the CSI resource group of the CSI resource set (e.g., by setting the indicator to ‘1’ or ‘0’ or ‘second’ as specified herein in the present disclosure).
   There is no other DL channel(s)/signal(s) with indicated TCI state(s) in the same symbols as the aperiodic CSI-RS resource(s) in the CSI resource group (of the CSI resource set); here, the other DL channel(s)/signal(s) could refer to PDSCH scheduled with offset larger than or equal to the threshold timeDurationForQCL, periodic CSI-RS, semi-persistent CSI-RS, aperiodic CSI-RS in a NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Aperiodic CSI-RS in a NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided.
   There is other DL channel(s)/signal(s) with indicated TCI state(s) in the same symbols as the aperiodic CSI-RS resource(s) in the CSI resource group (of the CSI resource set). Here, the other DL channel(s)/signal(s) could refer to PDSCH(s) scheduled with offset larger than or equal to the threshold timeDurationForQCL; in this case, the UE 116 could use only the second TCI state(s), e.g., when/if the second indicator or the TCI selection field in DCI format 1_1/1_2 (that schedules the PDSCH(s)) as specified herein in the present disclosure is set to ‘01’, or both of the first and second TCI states, e.g., when/if the second indicator or the TCI selection field in DCI format 1_1/1_2 (that schedules the PDSCH(s)) as specified herein in the present disclosure is set to ‘10’, to receive the PDSCH(s). Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided; in this case, the UE 116 could use only the second TCI state(s) to receive the target periodic/semi-persistent/aperiodic CSI-RS(s); in particular, the (one-bit) indicator(s) associated/corresponding to the target aperiodic CSI-RS resource(s) and/or the target CSI resource set NZP-CSI-RS-ResourceSet that provides/indicates the target aperiodic CSI-RS(s) could indicate that the second TCI state(s) could be used/applied to receive the target aperiodic CSI-RS(s) in the target CSI resource set (e.g., by setting the indicator to ‘1’ or ‘0’ or ‘second’ as specified herein in the present disclosure).
   The CSI resource set that provides/indicates/configures/comprises the CSI resource group (and therefore, the aperiodic CSI-RS resource(s)) could correspond to the second CSI resource set as specified herein in the present disclosure—the first and the second CSI resource sets could be configured for the Rel-17 group based beam reporting.
   the CSI resource group that provides/indicates/configures/comprises the (aperiodic) CSI-RS resource(s) could correspond to the second CSI resource group as specified herein in the present disclosure—the first and the second CSI resource groups could be configured in a CSI resource set for the Rel-17 NCJT CSI.
   The aperiodic CSI-RS resource(s) could correspond to the second (aperiodic) CSI-RS resource(s) in a pair of two (aperiodic) CSI-RS resources as specified herein in the present disclosure—one or more pairs of (aperiodic) CSI-RS resources with each pair comprising the first and the second (aperiodic) CSI-RS resources could be configured/provided/indicated for the Rel-17 NCJT CSI.
In yet another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, and/or when/if there is other DL channel(s)/signal(s) with indicated TCI state(s) in the same symbols as the aperiodic CSI-RS resource(s) in the CSI resource group (of the CSI resource set), and/or when/if one or more of the conditions specified herein in the present disclosure are achieved/satisfied, the UE 116 could apply the QCL assumption of the other DL channel(s)/signal(s) also when receiving the aperiodic CSI-RS(s) in the CSI resource group (of the CSI resource set). Here, the other DL channel(s)/signal(s) could refer to PDSCH(s) scheduled with offset larger than or equal to the threshold timeDurationForQCL; in this case, e.g., when/if the second indicator or the TCI selection field in DCI format 1_1/1_2 that schedules the PDSCH(s) as specified herein in the present disclosure is set to ‘00’, the UE 116 could use/apply the QCL parameter(s) of the RS(s) provided/indicated in the first TCI state(s) to receive the aperiodic CSI-RS(s) in the CSI resource group of the CSI resource set. When/if the second indicator or the TCI selection field in DCI format 1_1/1_2 that schedules the PDSCH(s) as specified herein in the present disclosure is set to ‘01’, the UE 116 could use/apply the QCL parameter(s) of the RS(s) provided/indicated in the second TCI state(s) to receive the aperiodic CSI-RS(s) in the CSI resource group of the CSI resource set. When/if the second indicator or the TCI selection field in DCI format 1_1/1_2 that schedules the PDSCH(s) as specified herein in the present disclosure is set to ‘10’, the UE 116 could use/apply the QCL parameter(s) of the RS(s) provided/indicated in the first (or the second) TCI state(s) to receive the aperiodic CSI-RS(s) in the CSI resource group of the CSI resource set. Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided; in particular, when/if the (one-bit) indicator(s) associated/corresponding to the target aperiodic CSI-RS resource(s) and/or the target CSI resource set NZP-CSI-RS-ResourceSet that provides/configures/indicates the target aperiodic CSI-RS(s) is set to ‘0’ (or ‘1’ or ‘first’), the UE 116 could use/apply the first indicated joint/DL TCI state(s) as specified herein in the present disclosure to receive the aperiodic CSI-RS(s) in the CSI resource group of the CSI resource set; when/if the (one-bit) indicator(s) associated/corresponding to the target aperiodic CSI-RS resource(s) and/or the target CSI resource set NZP-CSI-RS-ResourceSet that provides/indicates/configures the target aperiodic CSI-RS(s) is set to ‘1’ (or ‘0’ or ‘second’), the UE 116 could use/apply the second indicated joint/DL TCI state(s) as specified herein in the present disclosure to receive the aperiodic CSI-RS(s) in the CSI resource group of the CSI resource set.

In one embodiment, as specified herein in the present disclosure, the UE 116 could be provided/indicated/configured by the network 130 two CSI resource groups—denoted by a/the first CSI resource group and a/the second CSI resource group—in a CSI resource set for the NCJT CSI measurement/reporting, wherein the CSI resource set could be provided/configured/triggered, e.g., via/in higher layer RRC signaling(s)/parameter(s)—e.g., via/in CSI-ResourceConfig and/or CSI-AssociatedReportConfigInfo of CSI-AperiodicTrigger—and/or via/by an aperiodic CSI trigger state. Furthermore, the UE 116 could be provided/indicated/configured by the network 130 one or more pairs of CSI-RS resources with each pair comprising a/the first CSI-RS resource and a/the second CSI-RS resource respectively from the first and the second CSI resource groups as specified herein in the present disclosure. In this case, for a (aperiodic) CSI-RS from/in a resource pair as specified herein in the present disclosure, e.g., when/if the (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set providing/indicating the (aperiodic) CSI-RS resource, for the (aperiodic) CSI-RS resource, the UE 116 could use/apply the first TCI state(s) or the QCL parameter(s) of the RS(s) provided/indicated in the first TCI state(s) to receive the aperiodic CSI-RS when/if the aperiodic CSI-RS resource is the first CSI-RS resource in the resource pair, and the UE 116 could use/apply the second TCI state(s) or the QCL parameter(s) of the RS(s) provided/indicated in the second TCI state(s) to receive the aperiodic CSI-RS when/if the aperiodic CSI-RS resource is the second CSI-RS resource in the resource pair. That is, the first TCI state(s) could be associated/mapped to the first CSI-RS resource in a resource pair, and the second TCI state(s) could be associated/mapped to the second CSI-RS resource in a resource pair.

When/if the scheduling offset between the last symbol of the PDCCH carrying the triggering DCI and the first symbol of the aperiodic CSI-RS resource in a resource pair of a CSI resource set, e.g., a NZP-CSI-RS-ResourceSet configured without higher layer parameter trs-Info, is smaller than the UE 116 reported threshold beamSwitchTiming, when the reported value is one of the values of {14, 28, 48}·2^{max(0,μ}^{_{CSIRS}}⁻³⁾ and enableBeamSwitchTiming is not provided, or is smaller than 48·2^{max(0,μ}^{_{CSIRS}}⁻³⁾ when the UE 116 provides beamSwitchTiming-r16, enableBeamSwitchTiming is provided and the NZP-CSI-RS-ResourceSet is configured with the higher layer parameter repetition set to ‘off’ or configured without the higher layer parameter repetition, or is smaller than the UE 116 reported threshold beamSwitchTiming-r16, when eanbleBeamSwitchTiming is provided and the NZP-CSI-RS-ResourceSet is configured with the higher layer parameter repetition set to ‘on’, the UE 116 could determine which of the indicated joint/DL TCI states (e.g., the first TCI state(s) and/or the second TCI state(s) as specified herein in the present disclosure) to use for receiving the aperiodic CSI-RS resource in the resource pair (of the CSI resource set) according to one or more of the following.
In one example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, the UE 116 could use/apply the QCL parameter(s) of the RS(s) provided/indicated in the first TCI state(s) to receive the aperiodic CSI-RS resource in the resource pair (of the CSI resource set) when/if one or more of the following conditions are achieved/satisfied.
   For an aperiodic CSI-RS resource in the resource pair (of the CSI resource set), the (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the (aperiodic) CSI-RS resource.
   The (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource(s) in the CSI resource set is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the CSI resource set.
   The UE 116 could be indicated/configured/provided by the network 130, e.g., via higher layer RRC signaling(s)/parameter(s) and/or MAC CE command(s) and/or dynamic DCI based L1 signaling(s), or the UE 116 could follow fixed rule(s) provided in system specification(s), to use/apply the first TCI state(s) to receive the aperiodic CSI-RS resource in the resource pair (of the CSI resource set).
   The (one-bit) indicator(s) provided/configured/indicated by the network 130 for the (aperiodic) CSI-RS resource, e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the first TCI state(s) could be used/applied to receive the aperiodic CSI-RS resource in the resource pair of the CSI resource set (e.g., by setting the indicator to ‘0’ or ‘1’ or ‘first’ as specified herein in the present disclosure).
   The (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, that comprises/provides the resource pair could indicate that the first TCI state(s) could be used/applied to receive the aperiodic CSI-RS resource in the resource pair of the CSI resource set (e.g., by setting the indicator to ‘0’ or ‘1’ or ‘first’ as specified herein in the present disclosure).
   There is no other DL channel(s)/signal(s) with indicated TCI state(s) in the same symbols as the aperiodic CSI-RS resource in the resource pair (of the CSI resource set); here, the other DL channel(s)/signal(s) could refer to PDSCH scheduled with offset larger than or equal to the threshold timeDurationForQCL, periodic CSI-RS, semi-persistent CSI-RS, aperiodic CSI-RS in a NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Aperiodic CSI-RS in a NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided.
   There is other DL channel(s)/signal(s) with indicated TCI state(s) in the same symbols as the aperiodic CSI-RS resource in the resource pair (of the CSI resource set). Here, the other DL channel(s)/signal(s) could refer to PDSCH(s) scheduled with offset larger than or equal to the threshold timeDurationForQCL; in this case, the UE 116 could use only the first TCI state(s), e.g., when/if the second indicator or the TCI selection field in DCI format 1_1/1_2 (that schedules the PDSCH(s)) as specified herein in the present disclosure is set to ‘00’, or both of the first and second TCI states, e.g., when/if the second indicator or the TCI selection field in DCI format 1_1/1_2 (that schedules the PDSCH(s)) as specified herein in the present disclosure is set to ‘10’, to receive the PDSCH(s). Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided; in this case, the UE 116 could use only the first TCI state(s) to receive the target periodic/semi-persistent/aperiodic CSI-RS(s); in particular, the (one-bit) indicator(s) associated/corresponding to the target aperiodic CSI-RS resource(s) and/or the target CSI resource set NZP-CSI-RS-ResourceSet that provides/indicates the target aperiodic CSI-RS(s) could indicate that the first TCI state(s) could be used/applied to receive the target aperiodic CSI-RS(s) in the target CSI resource set (e.g., by setting the indicator to ‘0’ or ‘1’ or ‘first’ as specified herein in the present disclosure).
   The aperiodic CSI-RS resource could be provided/indicated/configured in/by the first CSI resource set as specified herein in the present disclosure—the first and the second CSI resource sets could be configured for the Rel-17 group based beam reporting.
   The aperiodic CSI-RS resource could be provided/indicated/configured in/by the first CSI resource group in the CSI resource set as specified herein in the present disclosure—the first and the second CSI resource groups could be configured in a CSI resource set for the Rel-17 NCJT CSI.
The aperiodic CSI-RS resource could correspond to the first (aperiodic) CSI-RS resource in the pair of two (aperiodic) CSI-RS resources as specified herein in the present disclosure—one or more pairs of (aperiodic) CSI-RS resources with each pair comprising the first and the second (aperiodic) CSI-RS resources could be configured/provided/indicated for the Rel-17 NCJT CSI.
In another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, the UE 116 could use/apply the QCL parameter(s) of the RS(s) provided/indicated in the second TCI state(s) to receive the aperiodic CSI-RS resource in the resource pair (of the CSI resource set) when/if one or more of the following conditions are achieved/satisfied.
   For an aperiodic CSI-RS resource in the resource pair (of the CSI resource set), the (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the (aperiodic) CSI-RS resource.
   The (one-bit) indicator to indicate which of the indicated/applied joint/DL TCI states (e.g., the first TCI state(s) and/or the second TCI state(s) as specified herein in the present disclosure) to use for receiving the (aperiodic) CSI-RS resource(s) in the CSI resource set is not provided/configured/indicated by the network 130, e.g., via/in higher layer RRC signaling(s)/parameter(s) provided via/in CSI-ResourceConfig and/or CSI-AssociatedReportConfigInfo of CSI-AperiodicTrigger that configures the CSI resource set, for the CSI resource set.
   The UE 116 could be indicated/configured/provided by the network 130, e.g., via higher layer RRC signaling(s)/parameter(s) and/or MAC CE command(s) and/or dynamic DCI based L1 signaling(s), or the UE 116 could follow fixed rule(s) provided in system specification(s), to use/apply the second TCI state(s) to receive the aperiodic CSI-RS resource in the resource pair (of the CSI resource set).
   The (one-bit) indicator(s) provided/configured/indicated by the network 130 for the (aperiodic) CSI-RS resource, e.g., via/in higher layer RRC signaling(s)/parameter(s) provided via/in CSI-ResourceConfig and/or CSI-AssociatedReportConfigInfo of CSI-AperiodicTrigger that configures the CSI resource set, could indicate that the second TCI state(s) could be used/applied to receive the aperiodic CSI-RS resource in the resource pair of the CSI resource set (e.g., by setting the indicator to ‘1’ or ‘0’ or ‘second’ as specified herein in the present disclosure).
   The (one-bit) indicator provided/configured/indicated by the network 130 for the CSI resource set NZP-CSI-RS-ResourceSet, e.g., via/in higher layer RRC signaling(s)/parameter(s) provided via/in CSI-ResourceConfig and/or CSI-AssociatedReportConfigInfo of CSI-AperiodicTrigger that configures the CSI resource set, that comprises/provides the resource pair could indicate that the second TCI state(s) could be used/applied to receive the aperiodic CSI-RS resource in the resource pair of the CSI resource set (e.g., by setting the indicator to ‘1’ or ‘0’ or ‘second’ as specified herein in the present disclosure).
   There is no other DL channel(s)/signal(s) with indicated TCI state(s) in the same symbols as the aperiodic CSI-RS resource in the resource pair (of the CSI resource set); here, the other DL channel(s)/signal(s) could refer to PDSCH scheduled with offset larger than or equal to the threshold timeDurationForQCL, periodic CSI-RS, semi-persistent CSI-RS, aperiodic CSI-RS in a NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Aperiodic CSI-RS in a NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided.
   There is other DL channel(s)/signal(s) with indicated TCI state(s) in the same symbols as the aperiodic CSI-RS resource in the resource pair (of the CSI resource set). Here, the other DL channel(s)/signal(s) could refer to PDSCH(s) scheduled with offset larger than or equal to the threshold timeDurationForQCL; in this case, the UE 116 could use only the second TCI state(s), e.g., when/if the second indicator or the TCI selection field in DCI format 1_1/1_2 (that schedules the PDSCH(s)) as specified herein in the present disclosure is set to ‘01’, or both of the first and second TCI states, e.g., when/if the second indicator or the TCI selection field in DCI format 1_1/1_2 (that schedules the PDSCH(s)) as specified herein in the present disclosure is set to ‘10’, to receive the PDSCH(s). Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided; in this case, the UE 116 could use only the second TCI state(s) to receive the target periodic/semi-persistent/aperiodic CSI-RS(s); in particular, the (one-bit) indicator(s) associated/corresponding to the target aperiodic CSI-RS resource(s) and/or the target CSI resource set NZP-CSI-RS-ResourceSet that provides/indicates the target aperiodic CSI-RS(s) could indicate that the second TCI state(s) could be used/applied to receive the target aperiodic CSI-RS(s) in the target CSI resource set (e.g., by setting the indicator to ‘1’ or ‘0’ or ‘second’ as specified herein in the present disclosure).
   The aperiodic CSI-RS resource could be provided/indicated/configured in/by the second CSI resource set as specified herein in the present disclosure—the first and the second CSI resource sets could be configured for the Rel-17 group based beam reporting.
   The aperiodic CSI-RS resource could be provided/indicated/configured in/by the second CSI resource group in the CSI resource set as specified herein in the present disclosure—the first and the second CSI resource groups could be configured in a CSI resource set for the Rel-17 NCJT CSI.
   The aperiodic CSI-RS resource could correspond to the second (aperiodic) CSI-RS resource in the pair of two (aperiodic) CSI-RS resources as specified herein in the present disclosure—one or more pairs of (aperiodic) CSI-RS resources with each pair comprising the first and the second (aperiodic) CSI-RS resources could be configured/provided/indicated for the Rel-17 NCJT CSI.
In yet another example, when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, and/or when/if there is other DL channel(s)/signal(s) with indicated TCI state(s) in the same symbols as the aperiodic CSI-RS resource(s) in the CSI resource group (of the CSI resource set), and/or when/if one or more of the conditions specified herein in the present disclosure are achieved/satisfied, the UE 116 could apply the QCL assumption of the other DL channel(s)/signal(s) also when receiving the aperiodic CSI-RS in the resource pair (of the CSI resource set). Here, the other DL channel(s)/signal(s) could refer to PDSCH(s) scheduled with offset larger than or equal to the threshold timeDurationForQCL; in this case, e.g., when/if the second indicator or the TCI selection field in DCI format 1_1/1_2 that schedules the PDSCH(s) as specified herein in the present disclosure is set to ‘00’, the UE 116 could use/apply the QCL parameter(s) of the RS(s) provided/indicated in the first TCI state(s) to receive the aperiodic CSI-RS in the resource pair of the CSI resource set. When/if the second indicator or the TCI selection field in DCI format 1_1/1_2 that schedules the PDSCH(s) as specified herein in the present disclosure is set to ‘01’, the UE 116 could use/apply the QCL parameter(s) of the RS(s) provided/indicated in the second TCI state(s) to receive the aperiodic CSI-RS in the resource pair of the CSI resource set. When/if the second indicator or the TCI selection field in DCI format 1_1/1_2 that schedules the PDSCH(s) as specified herein in the present disclosure is set to ‘10’, the UE 116 could use/apply the QCL parameter(s) of the RS(s) provided/indicated in the first (or the second) TCI state(s) to receive the aperiodic CSI-RS in the resource pair of the CSI resource set. Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet scheduled with offset larger than or equal to the UE 116 reported threshold beamSwitchTiming when the reported value is one of the values {14, 28, 48}2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ scheduled with offset larger than or equal to the UE 116 reported threshold beamSwitchTiming-r16 and enableBeamSwitchTiming is provided; in particular, when/if the (one-bit) indicator(s) associated/corresponding to the target aperiodic CSI-RS resource(s) and/or the target CSI resource set NZP-CSI-RS-ResourceSet that provides/configures/indicates the target aperiodic CSI-RS(s) is set to ‘0’ (or ‘1’ or ‘first’), the UE 116 could use/apply the first indicated joint/DL TCI state(s) as specified herein in the present disclosure to receive the aperiodic CSI-RS in the resource pair of the CSI resource set; when/if the (one-bit) indicator(s) associated/corresponding to the target aperiodic CSI-RS resource(s) and/or the target CSI resource set NZP-CSI-RS-ResourceSet that provides/indicates/configures the target aperiodic CSI-RS(s) is set to ‘1’ (or ‘0’ or ‘second’), the UE 116 could use/apply the second indicated joint/DL TCI state(s) as specified herein in the present disclosure to receive the aperiodic CSI-RS in the resource pair of the CSI resource set.

The specified/described design examples herein and the corresponding conditions for the SDCI based MTRP operation could be applied/extended to the MDCI based MTRP operation, wherein in a MDCI based MTRP system, a UE could be provided/indicated/configure by the network 130 in PDCCH-Config, two values (0 and 1) of coresetPoolIndex; furthermore, each CORESET could be configured/associated with a value of coresetPoolIndex (0 or 1). Throughout the present disclosure or in the specified/described design examples herein and the corresponding conditions:
The first TCI state(s) could be specific to a value of coresetPoolIndex (e.g., 0) such that the beam indication DCI that provides/indicates the first TCI state(s) could be received in CORESET(s) configured/associated with the value of coresetPoolIndex (e.g., 0). Similarly, the second TCI state(s) could be specific to a value of coresetPoolIndex (e.g., 1) such that the beam indication DCI that provides/indicates the second TCI state(s) could be received in CORESET(s) configured/associated with the value of coresetPoolIndex (e.g., 1).
An aperiodic CSI resource set (and therefore, the aperiodic CSI-RS resource(s) and/or the (two) CSI resource groups and/or the one or more resource pairs provided/configured/indicated therein) could be specific to a value of coresetPoolIndex (e.g., 0 or 1) when/if the triggering DCI is received in CORESET(s) configured/associated with the same value of coresetPoolIndex (e.g., 0 or 1). For instance, the first aperiodic CSI resource set (and therefore, the aperiodic CSI-RS resource(s) and/or the (two) CSI resource groups and/or the one or more resource pairs provided/configured/indicated therein) could be specific to a value of coresetPoolIndex (e.g., 0) such that the triggering DCI could be received in CORESET(s) configured/associated with the value of coresetPoolIndex (e.g., 0); similarly, the second aperiodic CSI resource set (and therefore, the aperiodic CSI-RS resource(s) and/or the (two) CSI resource groups and/or the one or more resource pairs provided/configured/indicated therein) could be specific to a value of coresetPoolIndex (e.g., 1) such that the triggering DCI could be received in CORESET(s) configured/associated with the value of coresetPoolIndex (e.g., 1).
The first aperiodic CSI resource set (and therefore, the aperiodic CSI-RS resource(s) and/or the (two) CSI resource groups and/or the one or more resource pairs provided/configured/indicated therein) could be specific to a value of coresetPoolIndex (e.g., 0), and the second aperiodic CSI resource set (and therefore, the aperiodic CSI-RS resource(s) and/or the (two) CSI resource groups and/or the one or more resource pairs provided/configured/indicated therein) could be specific to the other value of coresetPoolIndex (e.g., 1).
The first aperiodic CSI resource group (and therefore, the aperiodic CSI-RS resource(s) provided/configured/indicated therein) in a CSI resource set could be specific to a value of coresetPoolIndex (e.g., 0), and the second aperiodic CSI resource group (and therefore, the aperiodic CSI-RS resource(s) provided/configured/indicated therein) in the same CSI resource set could be specific to the other value of coresetPoolIndex (e.g., 1).
The first aperiodic CSI-RS resource of a resource pair could be specific to a value of coresetPoolIndex (e.g., 0), and the second aperiodic CSI-RS resource of the resource pair (and therefore, the aperiodic CSI-RS resource(s) provided/configured/indicated therein) could be specific to the other value of coresetPoolIndex (e.g., 1).

When/if a UE is configured with enableDefaultTCI-StatePerCoresetPoolIndex and the UE 116 is configured by higher layer parameter PDCCH-Config that contains two different values of coresetPoolIndex in ControlResourceSet, and/or when/if the scheduling offset between the last symbol of the PDCCH carrying the triggering DCI and the first symbol of the aperiodic CSI-RS resource(s) in a CSI resource set, e.g., a NZP-CSI-RS-ResourceSet configured without higher layer parameter trs-Info, is smaller than the UE 116 reported threshold beamSwitchTiming, when the reported value is one of the values of {14, 28, 48}·2^{max(0,μ}^{_{CSIRS}}⁻³⁾ and enableBeamSwitchTiming is not provided, or is smaller than 48·2^{max(0,μ}^{_{CSIRS}}⁻³⁾ when the UE 116 provides beamSwitchTiming-r16, enableBeamSwitchTiming is provided and the NZP-CSI-RS-ResourceSet is configured with the higher layer parameter repetition set to ‘off’ or configured without the higher layer parameter repetition, or is smaller than the UE 116 reported threshold beamSwitchTiming-r16, when eanbleBeamSwitchTiming is provided and the NZP-CSI-RS-ResourceSet is configured with the higher layer parameter repetition set to ‘on’, and/or when/if the UE 116 reports to the network 130 the capability signaling oneDefaultTCI-State, or the UE 116 does not report to the network 130 the capability signaling twoDefaultTCI-States, or the UE 116 is not configured with enableTwoDefaultTCI-States, or the UE 116 is configured with enableOneDefaultTCI-State, or the UE 116 reports to the network 130 the capability signaling twoDefaultTCI-States, or the UE 116 is configured with enableTwoDefaultTCI-States as specified herein in the present disclosure, the UE 116 could use/apply the QCL parameter(s) of the RS(s) provided/indicated in the TCI state(s) specific to/for a value of coresetPoolIndex (e.g., 0 or 1) to receive the aperiodic CSI-RS resource(s) in the CSI resource set when/if one or more of the following conditions are achieved/satisfied.
The aperiodic CSI-RS resource(s) could be specific to/for the same value of coresetPoolIndex (0 or 1)—according to those specified herein in the present disclosure—as the TCI state(s).
There is no other DL channel(s)/signal(s) with indicated TCI state(s) in the same symbols as the aperiodic CSI-RS resource in the resource pair (of the CSI resource set); here, the other DL channel(s)/signal(s) could refer to PDSCH scheduled by a PDCCH associated with the same value of coresetPoolIndex as the PDCCH triggering the aperiodic CSI-RS resource(s) and scheduled with offset larger than or equal to the threshold timeDurationForQCL, periodic CSI-RS, semi-persistent CSI-RS, aperiodic CSI-RS in a NZP-CSI-RS-ResourceSet triggered by a PDCCH associated with the same value of coresetPoolIndex as the PDCCH triggering the aperiodic CSI-RS resource(s) and scheduled with offset larger than or equal to the UE 116 reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info triggered by a PDCCH associated with the same value of coresetPoolIndex as the PDCCH triggering the aperiodic CSI-RS resource(s) and scheduled with offset larger than or equal to 48·2^{max(0,μ}^{_{CSIRS}}⁻³⁾ when the UE 116 provides beamSwitchTiming-r16 and enableBeamSwitchTiming is provided. Aperiodic CSI-RS in a NZP-CSI-RS-ResourceSet configured with the higher layer parameter repetition set to ‘on’ triggered by a PDCCH associated with the same value of coresetPoolIndex as the PDCCH triggering the aperiodic CSI-RS resource(s) and scheduled with offset larger than or equal to the UE 116 reported threshold beamSwitchTiming-r16 and enableBeamSwitchTiming is provided.
There is other DL channel(s)/signal(s) with indicated TCI state(s) in the same symbols as the aperiodic CSI-RS resource(s), and the UE 116 could apply the QCL assumption of the other DL channel(s)/signal(s) also when receiving the aperiodic CSI-RS(s). Here, the other DL channel(s)/signal(s) could refer to PDSCH(s) scheduled by a PDCCH associated with the same value of coresetPoolIndex as the PDCCH triggering the aperiodic CSI-RS resource(s) and scheduled with offset larger than or equal to the threshold timeDurationForQCL. Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet triggered by a PDCCH associated with the same value of coresetPoolIndex as the PDCCH triggering the aperiodic CSI-RS resource(s) and scheduled with offset larger than or equal to the UE 116 reported threshold beamSwitchTiming when the reported value is one of the values {14, 28, 48}2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info triggered by a PDCCH associated with the same value of coresetPoolIndex as the PDCCH triggering the aperiodic CSI-RS resource(s) and scheduled with offset larger than or equal to 48·2^{max(0,μ}^{_{CSIRS}}⁻³⁾ when the UE 116 provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ triggered by a PDCCH associated with the same value of coresetPoolIndex as the PDCCH triggering the aperiodic CSI-RS resource(s) and scheduled with offset larger than or equal to the UE 116 reported threshold beamSwitchTiming-r16 and enableBeamSwitchTiming is provided.

The specified/described design examples herein and the corresponding conditions for the SDCI/MCI based MTRP operations could be applied/extended to inter-cell MTRP operation, wherein in an inter-cell multi-TRP system, a UE could be provided/indicated/configure by the network 130 one or more PCIs/PCI indexes including the serving cell PCI/PCI index and/or PCI(s)/PCI index(es) other than the serving cell PCI/PCI index; furthermore, active TCI states specific for a coresetPoolIndex according to those specified herein in the present disclosure could be associated to a PCI/PCI index (or a value of coresetPoolIndex could be associated to a PCI/PCI index). Throughout the present disclosure or in the specified/described design examples herein and the corresponding conditions.
The first TCI state(s) could be specific to a value of coresetPoolIndex (e.g., 0) and a PCI/PCI index (e.g., the serving cell PCI/PCI index) such that the beam indication DCI that provides/indicates the first TCI state(s) could be received in CORESET(s) configured/associated with the value of coresetPoolIndex (e.g., 0) which is associated/corresponding to the PCI/PCI index. Similarly, the second TCI state(s) could be specific to a value of coresetPoolIndex (e.g., 1) and a PCI/PCI index (e.g., a PCI/PCI index other than the serving cell PCI/PCI index) such that the beam indication DCI that provides/indicates the second TCI state(s) could be received in CORESET(s) configured/associated with the value of coresetPoolIndex (e.g., 1) which is associated/corresponding to the PCI/PCI index.
An aperiodic CSI resource set (and therefore, the aperiodic CSI-RS resource(s) and/or the (two) CSI resource groups and/or the one or more resource pairs provided/configured/indicated therein) could be specific to a value of coresetPoolIndex (e.g., 0 or 1) and a PCI/PCI index (e.g., the serving cell PCI/PCI index or a PCI/PCI index other than the serving cell PCI/PCI index) when/if the triggering DCI is received in CORESET(s) configured/associated with the same value of coresetPoolIndex (e.g., 0 or 1) which is associated/corresponding to the PCI/PCI index. For instance, the first aperiodic CSI resource set (and therefore, the aperiodic CSI-RS resource(s) and/or the (two) CSI resource groups and/or the one or more resource pairs provided/configured/indicated therein) could be specific to a value of coresetPoolIndex (e.g., 0) and a PCI/PCI index (e.g., the serving cell PCI/PCI index) such that the triggering DCI could be received in CORESET(s) configured/associated with the value of coresetPoolIndex (e.g., 0) which is associated/corresponding to the PCI/PCI index; similarly, the second aperiodic CSI resource set (and therefore, the aperiodic CSI-RS resource(s) and/or the (two) CSI resource groups and/or the one or more resource pairs provided/configured/indicated therein) could be specific to a value of coresetPoolIndex (e.g., 1) and a PCI/PCI index (e.g., a PCI/PCI index other than the serving cell PCI/PCI index) such that the triggering DCI could be received in CORESET(s) configured/associated with the value of coresetPoolIndex (e.g., 1) which is associated/corresponding to the PCI/PCI index.
The first aperiodic CSI resource set (and therefore, the aperiodic CSI-RS resource(s) and/or the (two) CSI resource groups and/or the one or more resource pairs provided/configured/indicated therein) could be specific to/for a first PCI/PCI index (e.g., the serving cell PCI/PCI index) and the second aperiodic CSI resource set (and therefore, the aperiodic CSI-RS resource(s) and/or the (two) CSI resource groups and/or the one or more resource pairs provided/configured/indicated therein) could be specific to/for a second PCI/PCI index (e.g., a PCI/PCI index other than the serving cell PCI/PCI index).
The first aperiodic CSI resource group (and therefore, the aperiodic CSI-RS resource(s) provided/configured/indicated therein) in a CSI resource set could be specific to/for a first PCI/PCI index (e.g., the serving cell PCI/PCI index), and the second aperiodic CSI resource group (and therefore, the aperiodic CSI-RS resource(s) provided/configured/indicated therein) in the same CSI resource set could be specific to/for a second PCI/PCI index (e.g., a PCI/PCI index other than the serving cell PCI/PCI index).
The first aperiodic CSI-RS resource of a resource pair could be specific to/for a first PCI/PCI index (e.g., the serving cell PCI/PCI index), and the second aperiodic CSI-RS resource of the resource pair (and therefore, the aperiodic CSI-RS resource(s) provided/configured/indicated therein) could be specific to/for a second PCI/PCI index (e.g., a PCI/PCI index other than the serving cell PCI/PCI index).
The first TCI state(s) could be specific to/for a first PCI/PCI index (e.g., the serving cell PCI/PCI index), and the second TCI state(s) could be specific to/for a second PCI/PCI index (e.g., a PCI/PCI index other than the serving cell PCI/PCI index).

As specified herein in the present disclosure, a UE could receive from the network 130 a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of component carriers (CCs)/DL BWPs, and/or a second (unified) TCI state(s) activation MAC control element (CE) command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the first/second MAC CE activation command maps TCI-State(s) and/or TCI-UL-State(s) to only one TCI codepoint, the UE 116 shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE 116 is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE 116 is configured by higher layer parameter PDCCH-Config that contains two different values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1)—denoted by a third (unified) TCI state(s) activation command. For this case, the TCI state(s)/TCI codepoint(s) activated by/in a third (unified) TCI state(s) activation command could be specific to the same coresetPoolIndex value (i.e., 0 or 1) provided/indicated therein.

When a UE is configured with dl-OrJointTCI-StateList, is configured by higher layer parameter PDCCH-Config that contains two different values of coresetPoolIndex in ControlResourceSet, if the offset between the last symbol of the PDCCH carrying the triggering DCI and the first symbol of the aperiodic CSI-RS resources in the aperiodic CSI-RS resource set is smaller than a threshold in frequency range 2, and/or if the UE 116 does not report its capability of supporting default beam per coresetPoolIndex for M-DCI based MTRP in frequency range 2 (e.g., if the UE 116 does not report its capability of supporting using two default beams each per coresetPoolIndex for M-DCI based MTRP for simultaneous reception), and/or if there is no DL signal in the same symbols as the aperiodic CSI-RS, the UE 116 could apply the indicated joint/DL TCI state specific to coresetPoolIndex value 0 to the aperiodic CSI-RS or the aperiodic CSI resource set. For this case, when the UE 116 is further configured with SSB-MTC-AdditionalPCI and/or regardless of configuration of follow UrifiedTCIstate and/or regardless of whether the higher layer parameter(s) applylndicatedTCIState provided to/for the corresponding aperiodic CSI-RS resource/aperiodic CSI resource set is set to ‘first’, ‘second’, ‘both’ or ‘none’,
In one example, when/if coresetPoolIndex value 0 is associated/corresponding to the serving cell PCI and/or active TCI state(s) of/for the CORESET associated/configured with coresetPoolIndex value 0 is associated/corresponding to the serving cell PCI (or the UE 116 could expect or assume that coresetPoolIndex value 0 is associated/corresponding to the serving cell PCI and/or active TCI state(s) of/for the CORESET associated/configured with coresetPoolIndex value 0 is associated/corresponding to the serving cell PCI), the indicated joint/DL TCI state could be associated with the PCI of the serving cell, and the UE 116 could apply the indicated joint/DL TCI state specific to coresetPoolIndex value 0 (and therefore, the serving cell PCI) to the aperiodic CSI-RS or the aperiodic CSI resource set.
In another example, when/if at least CORESET(s) with index 0 and CORESET(s)—other than CORESET(s) with index 0—associated at least with common search space (CSS) sets other than Type3-PDCCH CSS sets are associated/configured with coresetPoolIndex value 0 and/or the higher layer parameter applylndicatedTCIState (or the first indicator as specified herein in the present disclosure) provided to/for the CORESET(s) is set to ‘first’, ‘second’, ‘both’ or ‘none’ (or the UE 116 could expect or assume that at least CORESET(s) with index 0 and CORESET(s)—other than CORESET(s) with index 0—associated at least with CSS sets other than Type3-PDCCH CSS sets are associated/configured with coresetPoolIndex value 0 and/or the higher layer parameter applylndicatedTCIState (or the first indicator as specified herein in the present disclosure) provided to/for the CORESET(s) is set to ‘first’, ‘second’, ‘both’ or ‘none’), the UE 116 could apply the indicated joint/DL TCI state specific to coresetPoolIndex value 0 to the aperiodic CSI-RS or the aperiodic CSI resource set.
In another example, when/if coresetPoolIndex value 0 is associated/corresponding to a PCI different from/other than the serving cell PCI and/or active TCI state(s) of/for the CORESET associated/configured with coresetPoolIndex value 0 is associated/corresponding to a PCI different from/other than the serving cell PCI (or the UE 116 could expect or assume that coresetPoolIndex value 0 is associated/corresponding to a PCI different from/other than the serving cell PCI and/or active TCI state(s) of/for the CORESET associated/configured with coresetPoolIndex value 0 is associated/corresponding to a PCI different from/other than the serving cell PCI), the indicated joint/DL TCI state could be associated with the PCI different from/other than the PCI of the serving cell; for this case, the UE 116 may apply the QCL assumption(s) in a default (joint/DL) TCI state to receive the aperiodic CSI-RS or the aperiodic CSI resource set, wherein the default (joint/DL) TCI state could be one of:
   If at least one CORESET is configured for the BWP in which the aperiodic CSI-RS/aperiodic CSI resource set is received, the (joint/DL) TCI state (and therefore, the QCL parameter(s) provided/indicated therein) used for the CORESET associated with a monitored search space with the lowest controlResourceSetId in the latest slot in which one or more CORESETs within the active BWP of the serving cell are monitored by the UE 116;
   The indicated joint/DL TCI state specific to coresetPoolIndex value 0, or equivalently, the indicated joint/DL TCI state associated with/to the PCI different from/other than the PCI of the serving cell;
   The indicated joint/DL TCI state associated with/to the serving cell PCI;
   The indicated joint/DL TCI state specific to coresetPoolIndex value 1, wherein coresetPoolIndex value 1 is associated/corresponding to the serving cell PCI and/or active TCI state(s) of/for the CORESET associated/configured with coresetPoolIndex value 1 is associated/corresponding to the serving cell PCI (or the UE 116 could expect or assume that coresetPoolIndex value 1 is associated/corresponding to the serving cell PCI and/or active TCI state(s) of/for the CORESET associated/configured with coresetPoolIndex value 1 is associated/corresponding to the serving cell PCI); and/or
   The indicated joint/DL TCI state specific to coresetPoolIndex value 1, wherein at least CORESET(s) with index 0 and CORESET(s)—other than CORESET(s) with index 0—associated at least with CSS sets other than Type3-PDCCH CSS sets are associated/configured with coresetPoolIndex value 0 and/or the higher layer parameter applylndicatedTCIState (or the first indicator as specified herein in the present disclosure) provided to/for the CORESET(s) is set to ‘first’, ‘second’, ‘both’ or ‘none’ (or the UE 116 could expect or assume that at least CORESET(s) with index 0 and CORESET(s)—other than CORESET(s) with index 0—associated at least with CSS sets other than Type3-PDCCH CSS sets are associated/configured with coresetPoolIndex value 0 and/or the higher layer parameter applylndicatedTCIState (or the first indicator as specified herein in the present disclosure) provided to/for the CORESET(s) is set to ‘first’, ‘second’, ‘both’ or ‘none’).
In another example, when/if only CORESET(s) (other than CORESET(s) with index 0) associated only with UE-specific search space (USS) sets and/or Type-3 PDCCH CSS sets is associated/configured with coresetPoolIndex value 0 and/or the higher layer parameter applylndicatedTCIState (or the first indicator as specified herein in the present disclosure) provided to/for the CORESET(s) is set to ‘first’, ‘second’, ‘both’ or ‘none’ (or the UE 116 could expect or assume that only CORESET(s) (other than CORESET(s) with index 0) associated only with USS sets and/or Type-3 PDCCH CSS sets is associated/configured with coresetPoolIndex value 0 and/or the higher layer parameter applylndicatedTCIState (or the first indicator as specified herein in the present disclosure) provided to/for the CORESET(s) is set to ‘first’, ‘second’, ‘both’ or ‘none’), the UE 116 may apply the QCL assumption(s) in a default (joint/DL) TCI state to receive the aperiodic CSI-RS or the aperiodic CSI resource set, wherein the default (joint/DL) TCI state could be one of:
   If at least one CORESET is configured for the BWP in which the aperiodic CSI-RS/aperiodic CSI resource set is received, the (joint/DL) TCI state (and therefore, the QCL parameter(s) provided/indicated therein) used for the CORESET associated with a monitored search space with the lowest controlResourceSetId in the latest slot in which one or more CORESETs within the active BWP of the serving cell are monitored by the UE 116;
   The indicated joint/DL TCI state associated with/to a PCI different from/other than the PCI of the serving cell;
   The indicated joint/DL TCI state associated with/to the serving cell PCI;
   The indicated joint/DL TCI state specific to coresetPoolIndex value 1, wherein coresetPoolIndex value 1 is associated/corresponding to the serving cell PCI and/or active TCI state(s) of/for the CORESET associated/configured with coresetPoolIndex value 1 is associated/corresponding to the serving cell PCI (or the UE 116 could expect or assume that coresetPoolIndex value 1 is associated/corresponding to the serving cell PCI and/or active TCI state(s) of/for the CORESET associated/configured with coresetPoolIndex value 1 is associated/corresponding to the serving cell PCI); and/or
   The indicated joint/DL TCI state specific to coresetPoolIndex value 1, wherein at least CORESET(s) with index 0 and CORESET(s)—other than CORESET(s) with index 0—associated at least with CSS sets other than Type3-PDCCH CSS sets are associated/configured with coresetPoolIndex value 0 and/or the higher layer parameter applylndicatedTCIState (or the first indicator as specified herein in the present disclosure) provided to/for the CORESET(s) is set to ‘first’, ‘second’, ‘both’ or ‘none’ (or the UE 116 could expect or assume that at least CORESET(s) with index 0 and CORESET(s)—other than CORESET(s) with index 0—associated at least with CSS sets other than Type3-PDCCH CSS sets are associated/configured with coresetPoolIndex value 0 and/or the higher layer parameter applylndicatedTCIState (or the first indicator as specified herein in the present disclosure) provided to/for the CORESET(s) is set to ‘first’, ‘second’, ‘both’ or ‘none’).

In the carrier aggregation (CA) case, the UE 116 could be provided/configured with one or more first lists of CCs with each CC in a first list operating under STRP mode—e.g., the UE 116 could receive from the network 130 a first (unified) TCI state(s) activation MAC CE command as specified herein in the present disclosure in/on one or more CCs in the first list(s), and/or one or more second lists of CCs with each CC in a second list operating under S-DCI MTRP mode—e.g., the UE 116 could receive from the network 130 a second (unified) TCI state(s) activation MAC CE command as specified herein in the present disclosure in/on one or more CCs in the second list(s), and/or one or more third lists of CCs with each CC in a third list operating under M-DCI MTRP mode—e.g., the UE 116 could be provided/configured by the higher layer parameter PDCCH-Config two different values of coresetPoolIndex in ControlResourceSet, and/or could receive from the network 130 a third (unified) TCI state(s) activation MAC CE command as specified herein in the present disclosure in/on one or more CCs in the third list(s). Furthermore, the same set of activated/indicated TCI state IDs could be applied for all DL and/or UL BWPs in the first list(s) of CCs, and/or the same set of activated/indicated TCI state IDs could be applied for all DL and/or UL BWPs in the second list(s) of CCs, and/or the same set of activated/indicated TCI state IDs could be applied for all DL and/or UL BWPs in the third list(s) of CCs. If the ‘QCL-TypeD’ of the aperiodic CSI-RSs/aperiodic CSI resource sets from respective CCs (e.g., CC(s) in the first list(s) and/or CC(s) in the second list(s) and/or CC(s) in the third list(s)) in a band are different in a slot, the ‘QCL-TypeD’ assumption of the CSI-RS/CSI resource set
in the CC with lowest CC ID in the band, and/or
in the CC with lowest CC ID in the first list(s) in the band, and/or
in the CC with lowest CC ID in the second list(s) in the band, and/or
in the CC with lowest CC ID in the third list(s) in the band
   is applied to all the aperiodic CSI-RSs/aperiodic CSI resource sets in the CCs in the band, and/or all the aperiodic CSI-RSs/aperiodic CSI resource sets in the first list(s) of CCs in the band, and/or all the aperiodic CSI-RSs/aperiodic CSI resource sets in the second list(s) of CCs in the band, and/or all the aperiodic CSI-RSs/aperiodic CSI resource sets in the third list(s) of CCs in the band. For the described design examples herein, when/if the aperiodic CSI-RS/aperiodic CSI resource set with the qcl-Type set to ‘typeD’ is different from that of the PDCCH demodulation reference signal (DM-RS) with which they overlap in at least one symbol, the UE 116 could be expected to prioritize the reception of PDCCH associated with that CORESET—this could also apply to the intra-band CA case (e.g., when aperiodic CSI-RS/aperiodic CSI resource set and the CORESET are in different component carriers).

When a UE is configured with dl-OrJointTCJ-StateList, is configured by higher layer parameter PDCCH-Config that contains two different values of coresetPoolIndex in ControlResourceSet, if the UE 116 does not report its capability of supporting default beam per coresetPoolIndex for M-DCI based MTRP in frequency range 2 (e.g., if the UE 116 does not report its capability of supporting using two default beams each per coresetPoolIndex for M-DCI based MTRP for simultaneous reception) and/or if the UE 116 is configured with SSB-MTC-AdditionalPCI, regardless of configuration offollowUrifiedTCIstate and/or regardless of whether the higher layer parameter(s) applylndicatedTCIState provided to/for the corresponding aperiodic CSI-RS resource/aperiodic CSI resource set is set to ‘first’, ‘second’, ‘both’ or ‘none’ and/or regardless of whether there is DL signal(s) in the same symbols as the aperiodic CSI-RS, the UE 116 may not expect that the offset between the last symbol of the PDCCH carrying the triggering DCI and the first symbol of the aperiodic CSI-RS resources in the aperiodic CSI-RS resource set is smaller than a threshold in frequency range 2, or the UE 116 could expect or assume that the offset between the last symbol of the PDCCH carrying the triggering DCI and the first symbol of the aperiodic CSI-RS resources in the aperiodic CSI-RS resource set is greater than or equal to a threshold in frequency range 2, wherein,
In one example, coresetPoolIndex value(s) 0 and/or 1 could be associated/corresponding to the serving cell PCI and/or active TCI state(s) of/for the CORESET associated/configured with coresetPoolIndex value(s) 0 and/or 1 could be associated/corresponding to the serving cell PCI (or the UE 116 could expect or assume that coresetPoolIndex value(s) 0 and/or 1 is associated/corresponding to the serving cell PCI and/or active TCI state(s) of/for the CORESET associated/configured with coresetPoolIndex value(s) 0 and/or 1 is associated/corresponding to the serving cell PCI).
In another example, coresetPoolIndex value(s) 0 and/or 1 could be associated/corresponding to a PCI different from/other than the serving cell PCI and/or active TCI state(s) of/for the CORESET associated/configured with coresetPoolIndex value(s) 0 and/or 1 could be associated/corresponding to a PCI different from/other than the serving cell PCI (or the UE 116 could expect or assume that coresetPoolIndex value(s) 0 and/or 1 is associated/corresponding to a PCI different from/other than the serving cell PCI and/or active TCI state(s) of/for the CORESET associated/configured with coresetPoolIndex value(s) 0 and/or 1 is associated/corresponding to a PCI different from/other than the serving cell PCI).
In another example, at least CORESET(s) with index 0 and CORESET(s)—other than CORESET(s) with index 0—associated at least with CSS sets other than Type3-PDCCH CSS sets could be associated/configured with coresetPoolIndex value(s) 0 and/or 1 and/or the higher layer parameter applylndicatedTCIState (or the first indicator as specified herein in the present disclosure) provided to/for the CORESET(s) could be set to ‘first’, ‘second’, ‘both’ or ‘none’ (or the UE 116 could expect or assume that at least CORESET(s) with index 0 and CORESET(s)—other than CORESET(s) with index 0—associated at least with CSS sets other than Type3-PDCCH CSS sets are associated/configured with coresetPoolIndex value(s) 0 and/or 1 and/or the higher layer parameter applylndicatedTCIState (or the first indicator as specified herein in the present disclosure) provided to/for the CORESET(s) is set to ‘first’, ‘second’, ‘both’ or ‘none’).
In another example, only CORESET(s) (other than CORESET(s) with index 0) associated only with USS sets and/or Type-3 PDCCH CSS sets could be associated/configured with coresetPoolIndex value(s) 0 and/or 1 and/or the higher layer parameter applylndicatedTCIState (or the first indicator as specified herein in the present disclosure) provided to/for the CORESET(s) could be set to ‘first’, ‘second’, ‘both’ or ‘none’ (or the UE 116 could expect or assume that only CORESET(s) (other than CORESET(s) with index 0) associated only with USS sets and/or Type-3 PDCCH CSS sets is associated/configured with coresetPoolIndex value(s) 0 and/or 1 and/or the higher layer parameter applylndicatedTCIState (or the first indicator as specified herein in the present disclosure) provided to/for the CORESET(s) is set to ‘first’, ‘second’, ‘both’ or ‘none’).

When a UE is configured with dl-OrJointTCJ-StateList, is configured by higher layer parameter PDCCH-Config that contains two different values of coresetPoolIndex in ControlResourceSet, regardless of configuration of followUrufiedTCIstate and/or regardless of whether the higher layer parameter(s) applylndicatedTCIState provided to/for the corresponding aperiodic CSI-RS resource/aperiodic CSI resource set is set to ‘first’, ‘second’, ‘both’ or ‘none’, if the offset between the last symbol of the PDCCH carrying the triggering DCI and the first symbol of the aperiodic CSI-RS resources in the aperiodic CSI-RS resource set is smaller than a threshold in frequency range 2, and/or if there is no DL signal in the same symbols as the aperiodic CSI-RS,
if the UE 116 does not report its capability of supporting default beam per coresetPoolIndex for M-DCI based MTRP in frequency range 2 (e.g., if the UE 116 does not report its capability of supporting using two default beams each per coresetPoolIndex for M-DCI based MTRP for simultaneous reception), the UE 116 could apply the indicated joint/DL TCI state specific to coresetPoolIndex value 0 to the aperiodic CSI-RS or the aperiodic CSI resource set, and the UE 116 may not expect to be configured with SSB-MTC-AdditionalPCI, and/or,
if the UE 116 reports its capability of supporting default beam per coresetPoolIndex for M-DCI based MTRP in frequency range 2 (e.g., if the UE 116 reports its capability of supporting using two default beams each per coresetPoolIndex for M-DCI based MTRP for simultaneous reception), the UE 116 could expect to be configured with SSB-MTC-AdditionalPCI. In this case, the UE 116 could apply the first or the second indicated joint/DL TCI state to the aperiodic CSI-RS according to the higher layer configuration(s) provided to the aperiodic CSI-RS resource or aperiodic CSI-RS resource set, wherein:
   In one example, coresetPoolIndex value(s) 0 and/or 1 could be associated/corresponding to the serving cell PCI and/or active TCI state(s) of/for the CORESET associated/configured with coresetPoolIndex value(s) 0 and/or 1 could be associated/corresponding to the serving cell PCI (or the UE 116 could expect or assume that coresetPoolIndex value(s) 0 and/or 1 is associated/corresponding to the serving cell PCI and/or active TCI state(s) of/for the CORESET associated/configured with coresetPoolIndex value(s) 0 and/or 1 is associated/corresponding to the serving cell PCI).
   In another example, coresetPoolIndex value(s) 0 and/or 1 could be associated/corresponding to a PCI different from/other than the serving cell PCI and/or active TCI state(s) of/for the CORESET associated/configured with coresetPoolIndex value(s) 0 and/or 1 could be associated/corresponding to a PCI different from/other than the serving cell PCI (or the UE 116 could expect or assume that coresetPoolIndex value(s) 0 and/or 1 is associated/corresponding to a PCI different from/other than the serving cell PCI and/or active TCI state(s) of/for the CORESET associated/configured with coresetPoolIndex value(s) 0 and/or 1 is associated/corresponding to a PCI different from/other than the serving cell PCI).
   In another example, at least CORESET(s) with index 0 and CORESET(s)—other than CORESET(s) with index 0—associated at least with CSS sets other than Type3-PDCCH CSS sets could be associated/configured with coresetPoolIndex value(s) 0 and/or 1 and/or the higher layer parameter applylndicatedTCIState (or the first indicator as specified herein in the present disclosure) provided to/for the CORESET(s) could be set to ‘first’, ‘second’, ‘both’ or ‘none’ (or the UE 116 could expect or assume that at least CORESET(s) with index 0 and CORESET(s)—other than CORESET(s) with index 0—associated at least with CSS sets other than Type3-PDCCH CSS sets are associated/configured with coresetPoolIndex value(s) 0 and/or 1 and/or the higher layer parameter applylndicatedTCIState (or the first indicator as specified herein in the present disclosure) provided to/for the CORESET(s) is set to ‘first’, ‘second’, ‘both’ or ‘none’).
   In another example, only CORESET(s) (other than CORESET(s) with index 0) associated only with USS sets and/or Type-3 PDCCH CSS sets could be associated/configured with coresetPoolIndex value(s) 0 and/or 1 and/or the higher layer parameter applylndicatedTCIState (or the first indicator as specified herein in the present disclosure) provided to/for the CORESET(s) could be set to ‘first’, ‘second’, ‘both’ or ‘none’ (or the UE 116 could expect or assume that only CORESET(s) (other than CORESET(s) with index 0) associated only with USS sets and/or Type-3 PDCCH CSS sets is associated/configured with coresetPoolIndex value(s) 0 and/or 1 and/or the higher layer parameter applylndicatedTCIState (or the first indicator as specified herein in the present disclosure) provided to/for the CORESET(s) is set to ‘first’, ‘second’, ‘both’ or ‘none’).

When a UE is configured with dl-OrJointTCI-StateList and is having two indicated TCI states and if the offset between the last symbol of the PDCCH carrying the triggering DCI and the first symbol of the aperiodic CSI-RS resources in the aperiodic CSI-RS resource set is smaller than a threshold:
If there is no DL signal in the same symbols as the aperiodic CSI-RS:
   If the UE is in frequency range 1, or the UE reports its capability of supporting two default beams for S-DCI based MTRP in frequency range 2, the UE could apply the first or the second indicated joint/DL TCI state to the aperiodic CSI-RS according to the higher layer configuration(s) provided to the aperiodic CSI-RS resource or to the aperiodic CSI-RS resource set.
   Otherwise, the UE could apply the first indicated joint/DL TCI state to the aperiodic CSI-RS.
Else, if there is any other DL signal with an indicated TCI state in the same symbols as the CSI-RS, the UE applies the QCL assumption of the other DL signal also when receiving the aperiodic CSI-RS. The other DL signal refers to PDSCH scheduled with offset larger than or equal to the threshold timeDurationForQCL, as defined in [13, TS 38.306], periodic CSI-RS, semi-persistent CSI-RS, aperiodic CSI-RS in a NZP-CSI-RS-ResourceSet scheduled with offset larger than or equal to the UE reported threshold beamSwitchTiming when the reported value is one of the values {14,28,48}·2max(0,μCSIRS-3) and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2max(0,μCSIRS-3) when the UE provides beamSwitchTiming-r16 and enableBeamSwitchTiming is provided. Aperiodic CSI-RS in a NZP-CSI-RS-ResourceSet configured with the higher layer parameter repetition set to ‘on’ scheduled with offset larger than or equal to the UE reported threshold beamSwitchTiming-r16 and enableBeamSwitchTiming is provided. If there is a PDSCH applying two indicated joint/DL TCI states in the same symbols as the AP CSI-RS:
   If the UE is in frequency range 1, or the UE reports its capability of supporting two default beams for S-DCI based MTRP in frequency range 2, the UE could apply the first or the second indicated joint/DL TCI state to the aperiodic CSI-RS according to the higher layer configuration(s), e.g., the one-bit indicator(s) as specified herein in the present disclosure, provided to the aperiodic CSI-RS resource or to the aperiodic CSI-RS resource set.
   Otherwise, the UE could apply the first indicated joint/DL TCI state to the aperiodic CSI-RS; alternatively, or optionally, the UE could apply the second indicated joint/DL TCI state to the aperiodic CSI-RS.

In one embodiment, when a UE is configured with dl-OrJointTCI-StateList, is configured by higher layer parameter PDCCH-Config that contains two different values of coresetPoolIndex in different ControlResourceSets, is having two indicated TCI states where the first and the second indicated TCI states correspond to the indicated TCI states specific to coresetPoolIndex value 0 and value 1 and if the offset between the last symbol of the PDCCH carrying the triggering DCI and the first symbol of the aperiodic CSI-RS resources in the aperiodic CSI-RS resource set is smaller than a threshold:
If there is no other DL signal in the same symbols as the aperiodic CSI-RS:
   If the UE is in frequency range 1, or the UE reports its capability of supporting default beam per coresetPoolIndex for M-DCI based MTRP in frequency range 2, the UE could apply the first or the second indicated joint/DL TCI state to the aperiodic CSI-RS according to the higher layer configuration(s) provided to the aperiodic CSI-RS resource or aperiodic CSI-RS resource set.
   Otherwise, the UE could apply the indicated joint/DL TCI state specific to coresetPoolIndex value 0 to the aperiodic CSI-RS resource set.
Else if there is any other DL signal with an indicated TCI state in the same symbols as the aperiodic CSI-RS:
   If there are two other DL signals applying the first and the second indicated TCI states, respectively, in the same symbols as the aperiodic CSI-RS:
If the UE is in frequency range 1, or the UE reports its capability of supporting default beam per coresetPoolIndex for M-DCI based MTRP in frequency range 2, the UE could apply the first or the second indicated TCI state to the aperiodic CSI-RS according to the higher layer configuration(s) provided to the aperiodic CSI-RS resource or aperiodic CSI-RS resource set.
Otherwise, the UE could apply the first indicated TCI state to the aperiodic CSI-RS; alternatively, or optionally, the UE could apply the second indicated TCI state to the aperiodic CSI-RS.
   Otherwise, the UE applies the QCL assumption of the other DL signal also when receiving the aperiodic CSI-RS. The other DL signal refers to PDSCH scheduled with offset larger than or equal to the threshold timeDurationForQCL, as defined in [13, TS 38.306], periodic CSI-RS, semi-persistent CSI-RS, aperiodic CSI-RS in a NZP-CSI-RS-ResourceSet scheduled with offset larger than or equal to the UE reported threshold beamSwitchTiming when the reported value is one of the values {14,28,48}·2max(0,μCSIRS-3) and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2max(0,μCSIRS-3) when the UE provides beamSwitchTiming-r16 and enableBeamSwitchTiming is provided. Aperiodic CSI-RS in a NZP-CSI-RS-ResourceSet configured with the higher layer parameter repetition set to ‘on’ scheduled with offset larger than or equal to the UE reported threshold beamSwitch Timing-r16 and enableBeamSwitch Timing is provided.

In one embodiment, when a UE is configured with dl-OrJointTCI-StateList, is configured by higher layer parameter PDCCH-Config that contains two different values of coresetPoolIndex in different ControlResourceSets, is having two indicated TCI states where the first and the second indicated TCI states correspond to the indicated TCI states specific to coresetPoolIndex value 0 and value 1 and if the offset between the last symbol of the PDCCH carrying the triggering DCI and the first symbol of the aperiodic CSI-RS resources in the aperiodic CSI-RS resource set is smaller than a threshold:
If there is no other DL signal in the same symbols as the aperiodic CSI-RS:
   If the UE is in frequency range 1, or the UE reports its capability of supporting default beam per coresetPoolIndex for M-DCI based MTRP in frequency range 2, the UE could apply the first or the second indicated joint/DL TCI state to the aperiodic CSI-RS according to the higher layer configuration(s) provided to the aperiodic CSI-RS resource or aperiodic CSI-RS resource set.
   Otherwise, the UE could apply the indicated joint/DL TCI state specific to coresetPoolIndex value 0 to the aperiodic CSI-RS resource set.
Else, if there is any other DL signal with an indicated TCI state in the same symbols as the aperiodic CSI-RS:
   If there are two other DL signals applying the first and the second indicated TCI states, respectively, in the same symbols as the aperiodic CSI-RS:
If the UE is in frequency range 1, or the UE reports its capability of supporting default beam per coresetPoolIndex for M-DCI based MTRP in frequency range 2, the UE could apply the first or the second indicated TCI state to the aperiodic CSI-RS according to the higher layer configuration(s) provided to the aperiodic CSI-RS resource or aperiodic CSI-RS resource set.
Otherwise, the UE could apply the first indicated TCI state to the aperiodic CSI-RS; alternatively, or optionally, the UE could apply the second indicated TCI state to the aperiodic CSI-RS.
   Otherwise:
If the UE is in frequency range 1, or the UE reports its capability of supporting default beam per coresetPoolIndex for M-DCI based MTRP in frequency range 2, the UE could apply the QCL assumption of the other DL channel(s)/signal(s) also when receiving the aperiodic CSI-RS(s). Here, the other DL channel(s)/signal(s) could refer to PDSCH(s) scheduled by a PDCCH associated with the same value of coresetPoolIndex as the PDCCH triggering the aperiodic CSI-RS resource(s) and scheduled with offset larger than or equal to the threshold timeDurationForQCL. Furthermore, the other DL channel(s)/signal(s) could also refer to target periodic CSI-RS(s), target semi-persistent CSI-RS(s), target aperiodic CSI-RS(s) in a target NZP-CSI-RS-ResourceSet triggered by a PDCCH associated with the same value of coresetPoolIndex as the PDCCH triggering the aperiodic CSI-RS resource(s) and scheduled with offset larger than or equal to the UE reported threshold beamSwitchTiming when the reported value is one of the values {14, 28, 48}·2^{max(0,μ}^{_{CSIRS}}⁻³⁾ and when enableBeamSwitchTiming is not provided or the NZP-CSI-RS-ResourceSet is configured with the higher layer parameter trs-Info, target aperiodic CSI-RS(s) in a target NZP-CSI-RS-ResourceSet configured with the higher layer parameter repetition set to ‘off’ or configured without the higher layer parameters repetition and trs-Info triggered by a PDCCH associated with the same value of coresetPoolIndex as the PDCCH triggering the aperiodic CSI-RS resource(s) and scheduled with offset larger than or equal to 48·2^{max(0,μ}^{_{CSIRS}}⁻³⁾ when the UE provides beamSwitchTiming-r16 and enableBeamSwitchTiming is provided. Target aperiodic CSI-RS(s) in a target NZP-CSI-RS-ResourceSet configured with the higher layer parameter repetition set to ‘on’ triggered by a PDCCH associated with the same value of coresetPoolIndex as the PDCCH triggering the aperiodic CSI-RS resource(s) and scheduled with offset larger than or equal to the UE reported threshold beamSwitchTiming-r16 and enableBeamSwitchTiming is provided.
Otherwise, the UE applies the QCL assumption of the other DL signal also when receiving the aperiodic CSI-RS. The other DL signal refers to PDSCH scheduled with offset larger than or equal to the threshold timeDurationForQCL, as defined in [13, TS 38.306], periodic CSI-RS, semi-persistent CSI-RS, aperiodic CSI-RS in a NZP-CSI-RS-ResourceSet scheduled with offset larger than or equal to the UE reported threshold beamSwitchTiming when the reported value is one of the values {14,28,48}·2max(0,μCSIRS-3) and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2max(0,μCSIRS-3) when the UE provides beamSwitchTiming-r16 and enableBeamSwitchTiming is provided. Aperiodic CSI-RS in a NZP-CSI-RS-ResourceSet configured with the higher layer parameter repetition set to ‘on’ scheduled with offset larger than or equal to the UE reported threshold beamSwitchTiming-r16 and enableBeamSwitchTiming is provided.

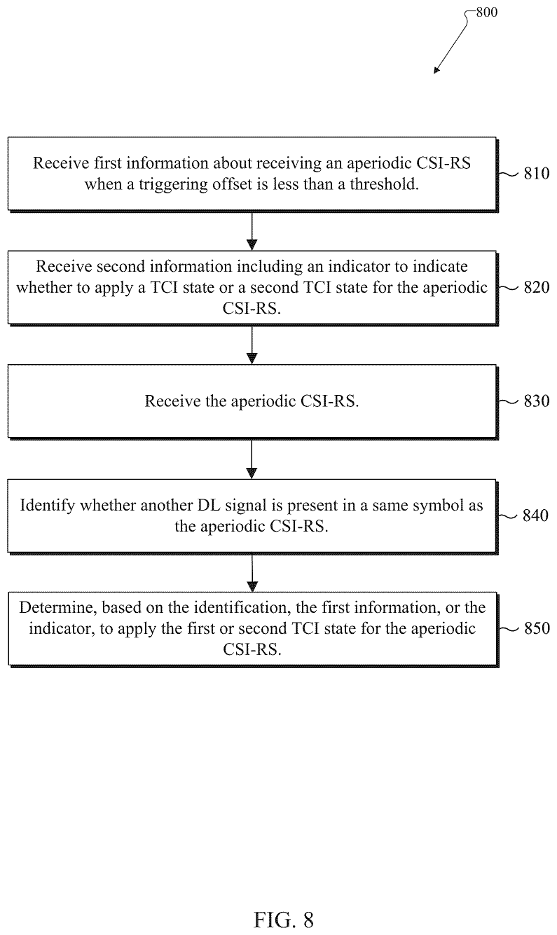

FIG. 8 illustrates an example method 800 performed by a UE in a wireless communication system according to embodiments of the present disclosure. The method 800 of FIG. 8 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 800 is for illustration only and other embodiments can be used without departing from the scope of the present disclosure.

The method 800 begins with the UE receiving first information about receiving an aperiodic CSI-RS when a triggering offset is less than a threshold (810). The UE then receives second information including an indicator to indicate whether to apply a TCI state or a second TCI state for the aperiodic CSI-RS (820). The UE then receives the aperiodic CSI-RS (830). The UE then identifies whether another DL signal is present in a same symbol as the aperiodic CSI-RS (840). The UE then determines, based on the identification, the first information, or the indicator, to apply the first or second TCI state for the aperiodic CSI-RS (850).

In various embodiments, the first information provides one of one TCI state to receive the aperiodic CSI-RS or two TCI states to receive the aperiodic CSI-RS. The first and second information is received via a RRC signaling. In various embodiments, the indicator is provided in one of a first higher layer parameter that configures an aperiodic CSI resource set that comprises a resource for the aperiodic CSI-RS or a second higher layer parameter that configures a resource for the aperiodic CSI-RS. In various embodiments, when the indicator is a first indicator, the first TCI state is applied for the aperiodic CSI-RS and, when the indicator is a second indicator, the second TCI state is applied for the aperiodic CSI-RS.

In various embodiments, the other DL signal is not present; when the first information provides two TCI states to receive the aperiodic CSI-RS; the US determines, based on the indicator, to apply the first or second TCI state for the aperiodic CSI-RS; and when the first information provides one TCI state to receive the aperiodic CSI-RS, the UE applies the first TCI state for the aperiodic CSI-RS.

In various embodiments, the other DL signal is present, the first information provides one TCI state to receive the aperiodic CSI-RS; when the first TCI state is applied for the other DL signal, the UE determines to apply the first TCI state for the aperiodic CSI-RS; when the second TCI state is applied for the other DL signal, the UE determines to apply the second TCI state for the aperiodic CSI-RS; and when the first and second TCI states are applied for the other DL signal, the UE determines to apply the first TCI state for the aperiodic CSI-RS.

In various embodiments, the other DL signal is present, the first information provides two TCI states to receive the aperiodic CSI-RS; when the first TCI state is applied for the other DL signal, the UE determines to apply the first TCI state for the aperiodic CSI-RS; when the second TCI state is applied for the other DL signal; the UE determines to apply the second TCI state for the aperiodic CSI-RS; and when the first and second TCI states are applied for the other DL signal, the UE determines, based on the indicator, to apply the first or the second TCI state for the aperiodic CSI-RS.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information about receiving an aperiodic channel state information reference signal (CSI-RS) when a triggering offset is less than a threshold;
receive second information including an indicator to indicate whether to apply a first transmission configuration (TCI) state or a second TCI state for the aperiodic CSI-RS; and
receive the aperiodic CSI-RS; and
a processor operably coupled with the transceiver, the processor configured to:
identify whether another downlink (DL) signal is present in a same symbol as the aperiodic CSI-RS; and
determine, based on the identification, the first information, or the indicator, to apply the first or second TCI state for the aperiodic CSI-RS.

2. The UE of claim 1, wherein:
the first information provides one of:
one TCI state to receive the aperiodic CSI-RS, or
two TCI states to receive the aperiodic CSI-RS, and
the first and second information is received via a radio resource control (RRC) signaling.

3. The UE of claim 1, wherein the indicator is provided in one of:
a first higher layer parameter that configures an aperiodic CSI resource set that comprises a resource for the aperiodic CSI-RS; or
a second higher layer parameter that configures a resource for the aperiodic CSI-RS.

4. The UE of claim 1, wherein:
when the indicator is a first indicator, the first TCI state is applied for the aperiodic CSI-RS, and
when the indicator is a second indicator, the second TCI state is applied for the aperiodic CSI-RS.

5. The UE of claim 1, wherein:
the other DL signal is not present,
when the first information provides two TCI states to receive the aperiodic CSI-RS, the processor is further configured to determine, based on the indicator, to apply the first or second TCI state for the aperiodic CSI-RS, and
when the first information provides one TCI state to receive the aperiodic CSI-RS, the processor is further configured to apply the first TCI state for the aperiodic CSI-RS.

6. The UE of claim 1, wherein:
the other DL signal is present,
the first information provides one TCI state to receive the aperiodic CSI-RS,
when the first TCI state is applied for the other DL signal, the processor is further configured to determine to apply the first TCI state for the aperiodic CSI-RS,
when the second TCI state is applied for the other DL signal, the processor is further configured to determine to apply the second TCI state for the aperiodic CSI-RS, and
when the first and second TCI states are applied for the other DL signal, the processor is further configured to determine to apply the first TCI state for the aperiodic CSI-RS.

7. The UE of claim 1, wherein:
the other DL signal is present,
the first information provides two TCI states to receive the aperiodic CSI-RS,
when the first TCI state is applied for the other DL signal, the processor is further configured to determine to apply the first TCI state for the aperiodic CSI-RS,
when the second TCI state is applied for the other DL signal, the processor is further configured to determine to apply the second TCI state for the aperiodic CSI-RS, and
when the first and second TCI states are applied for the other DL signal, the processor is further configured to determine, based on the indicator, to apply the first or the second TCI state for the aperiodic CSI-RS.

8. A base station (BS), comprising:
a transceiver configured to:
transmit first information about an aperiodic channel state information reference signal (CSI-RS) when a triggering offset is less than a threshold;
transmit second information including an indicator to indicate whether to apply a first transmission configuration (TCI) state or a second TCI state for the aperiodic CSI-RS; and
transmit the aperiodic CSI-RS; and
a processor operably coupled with the transceiver, the processor configured to:
identify whether another downlink (DL) signal is present in a same symbol as the aperiodic CSI-RS; and
determine, based on the identification, the first information, or the indicator, to apply the first or second TCI state for the aperiodic CSI-RS.

9. The BS of claim 8, wherein:
the first information provides one of:
one TCI state for the aperiodic CSI-RS, or
two TCI states for the aperiodic CSI-RS, and
the first and second information is transmitted via a radio resource control (RRC) signaling.

10. The BS of claim 8, wherein the indicator is provided in one of:
a first higher layer parameter that configures an aperiodic CSI resource set that comprises a resource for the aperiodic CSI-RS; or
a second higher layer parameter that configures a resource for the aperiodic CSI-RS.

11. The BS of claim 8, wherein:
when the indicator is a first indicator, the first TCI state is applied for the aperiodic CSI-RS, and
when the indicator is a second indicator, the second TCI state is applied for the aperiodic CSI-RS.

12. The BS of claim 8, wherein:
the other DL signal is not present,
when the first information provides two TCI states for the aperiodic CSI-RS, the processor is further configured to determine, based on the indicator, to apply the first or second TCI state for the aperiodic CSI-RS, and
when the first information provides one TCI state for the aperiodic CSI-RS, the processor is further configured to apply the first TCI state for the aperiodic CSI-RS.

13. The BS of claim 8, wherein:
the other DL signal is present,
the first information provides one TCI state for the aperiodic CSI-RS,
when the first TCI state is applied for the other DL signal, the processor is further configured to determine to apply the first TCI state for the aperiodic CSI-RS,
when the second TCI state is applied for the other DL signal, the processor is further configured to determine to apply the second TCI state for the aperiodic CSI-RS, and
when the first and second TCI states are applied for the other DL signal, the processor is further configured to determine to apply the first TCI state for the aperiodic CSI-RS.

14. The BS of claim 8, wherein:
the other DL signal is present,
the first information provides two TCI states for the aperiodic CSI-RS,
when the first TCI state is applied for the other DL signal, the processor is further configured to determine to apply the first TCI state for the aperiodic CSI-RS,
when the second TCI state is applied for the other DL signal, the processor is further configured to determine to apply the second TCI state for the aperiodic CSI-RS, and
when the first and second TCI states are applied for the other DL signal, the processor is further configured to determine, based on the indicator, to apply the first or the second TCI state for the aperiodic CSI-RS.

15. A method performed by a user equipment (UE), the method comprising:
receiving first information about receiving an aperiodic channel state information reference signal (CSI-RS) when a triggering offset is less than a threshold;
receiving second information including an indicator to indicate whether to apply a first transmission configuration (TCI) state or a second TCI state for the aperiodic CSI-RS;
receiving the aperiodic CSI-RS;
identifying whether another downlink (DL) signal is present in a same symbol as the aperiodic CSI-RS; and
determining, based on the identification, the first information, or the indicator, to apply the first or second TCI state for the aperiodic CSI-RS.

16. The method of claim 15, wherein:
the first information provides one of:
one TCI state to receive the aperiodic CSI-RS, or
two TCI states to receive the aperiodic CSI-RS, and
the first and second information is received via a radio resource control (RRC) signaling.

17. The method of claim 15, wherein the indicator is provided in one of:
a first higher layer parameter that configures an aperiodic CSI resource set that comprises a resource for the aperiodic CSI-RS; or
a second higher layer parameter that configures a resource for the aperiodic CSI-RS.

18. The method of claim 15, wherein:
when the indicator is a first indicator, the first TCI state is applied for the aperiodic CSI-RS, and
when the indicator is a second indicator, the second TCI state is applied for the aperiodic CSI-RS.

19. The method of claim 15, wherein:
the other DL signal is not present,
determining to apply the first or second TCI state for the aperiodic CSI-RS further comprises,
when the first information provides two TCI states to receive the aperiodic CSI-RS, determining, based on the indicator, to apply the first or second TCI state for the aperiodic CSI-RS, and
the method further comprises, when the first information provides one TCI state to receive the aperiodic CSI-RS, applying the first TCI state for the aperiodic CSI-RS.

20. The method of claim 15, wherein:
the other DL signal is present,
the first information provides one TCI state to receive the aperiodic CSI-RS,
determining to apply the first or second TCI state for the aperiodic CSI-RS further comprises:
when the first TCI state is applied for the other DL signal, determining to apply the first TCI state for the aperiodic CSI-RS,
when the second TCI state is applied for the other DL signal, determining to apply the second TCI state for the aperiodic CSI-RS, and
when the first and second TCI states are applied for the other DL signal, determining to apply the first TCI state for the aperiodic CSI-RS.
